(19) United States
(12) Patent Application Publication
(10) Pub. No.: US 2024/0163055 A1
(43) Pub. Date: May 16, 2024

(54) METHOD AND DEVICE FOR WIRELESS COMMUNICATION

(71) Applicants: Yu CHEN, Shanghai (CN); Xiaobo ZHANG, Shanghai (CN)

(72) Inventors: Yu CHEN, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/418,380

(22) Filed: Jan. 22, 2024

Related U.S. Application Data
(63) Continuation of application No. PCT/CN2022/106949, filed on Jul. 21, 2022.

(30) Foreign Application Priority Data
Jul. 22, 2021 (CN) 202110828885.4
Jul. 28, 2021 (CN) 202110854252.0
Aug. 2, 2021 (CN) 202110879457.4
Aug. 5, 2021 (CN) 202110894908.1
Aug. 5, 2021 (CN) 202110894919.X

(51) Int. Cl. H04L 5/00; H04L 43/0811; H04W 24/10; H04W 76/20

(52) U.S. Cl. CPC H04L 5/0051; H04L 43/0811; H04W 24/10; H04W 76/20

(57) ABSTRACT

The present application discloses a method and device for wireless communications, comprising receiving a first message, the first message being used to indicate a first reference signal index set and a second reference signal index set; the first reference signal index set and the second reference signal index set each at least comprise one reference signal index; any reference signal index in the first reference signal index set indicates a reference signal resource; any reference signal index in the second reference signal index set indicates a reference signal resource; at least partial reference signal indexes in the second reference signal index set belong to the first reference signal index set; the method proposed in the present application enables network optimization in the case of multiple transmission points.

### CROSS REFERENCE TO RELATED APPLICATIONS

This application is the continuation of the international patent application No. PCT/CN2022/106949, filed on Jul. 21, 2022, and claims the priority benefit of Chinese Patent Application No. 202110828885.4, filed on Jul. 22, 2021, and claims the priority benefit of Chinese Patent Application No. 202110854252.0, filed on Jul. 28, 2021, and claims the priority benefit of Chinese Patent Application No. 202110879457.4, filed on Aug. 2, 2021, and claims the priority benefit of Chinese Patent Application No. 202110894919.X, filed on Aug. 5, 2021, and claims the priority benefit of Chinese Patent Application No. 202110894908.1, filed on Aug. 5, 2021, the full disclosure of which is incorporated herein by reference.

### BACKGROUND

### Technical Field

The present application relates to transmission methods and devices in wireless communication systems, and in particular to a method and device related to network optimization, multiple TRP communications, as well as layer 1 and layer 2 mobility in wireless communications.

### Related Art

Application scenarios of future wireless communication systems are becoming increasingly diversified, and different application scenarios have different performance demands on systems. In order to meet different performance requirements of various application scenarios, 3rd Generation Partner Project (3GPP) Radio Access Network (RAN) #72 plenary decided to conduct the study of New Radio (NR), or what is called fifth Generation (5G). The work Item (WI) of NR was approved at 3GPP RAN #75 plenary to standardize NR.

In communications, whether Long Term Evolution (LTE) or 5G NR involves features of accurate reception of reliable information, optimized energy efficiency ratio, determination of information efficiency, flexible resource allocation, scalable system structure, efficient non-access layer information processing, low service interruption and dropping rate and support for low power consumption, which are of great significance to the maintenance of normal communications between a base station and a UE, reasonable scheduling of resources and balancing of system payload. Those features can be called the cornerstone of high throughout and are characterized in meeting communication requirements of various service, improving spectrum utilization and improving service quality, which are indispensable in enhanced Mobile BroadBand (eMBB), Ultra Reliable Low Latency Communications (URLLC) and enhanced Machine Type Communications (eMTC). Meanwhile, in the following communication modes, covering Industrial Internet of Things (IIoT), Vehicular to X (V2X), Device to Device communications, Unlicensed Spectrum communications, User communication quality monitoring, network planning optimization, Non-Territorial Networks (NTN), Territorial Networks (TN), and Dual connectivity system, there are extensive requirements in radio resource management and selection of multi-antenna codebooks as well as in signaling design, adjacent cell management, service management and beamforming. Transmission methods of information are divided into broadcast transmission and unicast transmission, both of which are essential for 5G system for that they are very helpful to meet the above requirements. The UE can be connected to the network directly or through a relay.

With the increase of scenarios and complexity of systems, higher requirements are raised for interruption rate and time delay reduction, reliability and system stability enhancement, service flexibility and power saving. At the same time, compatibility between different versions of different systems should be considered when designing the systems.

### SUMMARY

The use of multi-antenna is involved in multiple communication scenarios, such as transmitting information to a user through multiple transmission points (multi-TRP, mTRP, multiple transmission points or multiple transmission and reception points). Using mTRP may be helpful in different situations to improve throughput and increase coverage. To further improve performance, multiple TRPs comprised in mTRP may be from a same physical cell or may belong to different physical cells. A serving cell and a physical cell in 5G NR usually have an established relation, and it is generally considered that one serving cell only comprises one physical cell and one physical cell only belongs to one serving cell. Therefore, when providing TRPs from different physical cell to users through one cell, problems arise, and many aspects of the current 5G system are unable to support this feature. On the other hand, in current communication systems, if a user detects RLF, it will store the RLF information, e.g., saving RLF information through its own state variables, and reporting the saved RLF information to the network at the next access to the network, or at some other appropriate time, which is very helpful for network optimization. For the case of mTRP, a new radio link monitoring configuration method can be adopted, i.e., reference signals belonging to different physical cells or the reference signals of a TRP can be configured together as reference signals used for radio link monitoring, which is conducive to obtaining more real and accurate results, and at the same time, to effectively reducing the interruption of services, i.e., reducing the occurrence of RLF. But on the other hand, the network will lose RLF information reported by a single physical cell or a TRP of a single physical cell that triggers RLF, because there is no RLF and the UE may not generate a link failure report; even if the UE saves certain failure information, and if a radio link does occur immediately afterward, the saved failure information will be cleared, which will result in the loss of these information. This will result in the network not being able to grasp that coverage problems arise in single physical cell and will not optimize the network. This is unfair to users who support only one TRP, such as UEs with simple functionality, or previous versions of UEs, which then face coverage problems and communication quality may be difficult to improve for these users. Current 5G systems are not yet able to support the above requirements.

To address the above problem, the present application provides a solution.

It should be noted that if no conflict is incurred, embodiments in any node in the present application and the characteristics of the embodiments are also applicable to any other node, and vice versa. And the embodiments in the present application and the characteristics in the embodiments can be arbitrarily combined if there is no conflict.

The present application provides a method in a first node for wireless communications, comprising:
receiving a first message, the first message being used to indicate a first reference signal index set and a second reference signal index set; the first reference signal index set and the second reference signal index set each at least comprising one reference signal index; any reference signal index in the first reference signal index set indicating a reference signal resource; any reference signal index in the second reference signal index set indicating a reference signal resource; at least one reference signal index in the first reference signal index set being associated with a first Physical Cell Identifier (PCI), and at least one reference signal index in the first reference signal index set being associated with a second PCI; any reference signal index in the second reference signal index set being associated with the first PCI;
assessing first-type radio link quality according to the reference signal resources indicated by the first reference signal index set; whenever the evaluated first-type radio link quality is worse than a first threshold, a physical layer of the first node reporting a first-type indication to a higher layer of the first node; as a response to the higher layer of the first node continuously receiving Q1 first-type indication(s), starting the first timer, Q1 being a positive integer; as a response to the first timer being expired, detecting RLF;
assessing second-type radio link quality according to at least partial reference signal resources indicated by the second reference signal index; whenever the evaluated second-type radio link quality is worse than a second threshold, a physical layer of the first node reporting a second-type indication to a higher layer of the first node; and
as a response to all conditions in a first condition set being satisfied, executing a first operation;
herein, the first condition set comprises the higher layer of the first node continuously receiving Q2 second-type indication(s); the executing a first operation does not comprise detecting Radio Link Failure (RLF); the first operation comprises generating a link observation record, or the first operation comprises transmitting a link observation record.

In one embodiment, a problem to be solved in the present application comprises: in a serving cell that supports multiple PCIs, and in the absence of RLF, if link failure information for a cell identified by a single PCI is provided to the network.

In one embodiment, advantages of the above method comprise: the method proposed in the present application can provide the network with link failure information for a cell associated with a single PCI without an occurrence or triggering of RLF, and these information is not cleared by RLF that may occur thereafter, thus allowing the network to have a more comprehensive picture of the status of the link, which can be very helpful for network optimization and improvement of the quality of service.

Specifically, according to one aspect of the present application, at least partial reference signal indexes in the second reference signal index set belong to the first reference signal index set.

Specifically, according to one aspect of the present application, comprising:
transmitting a second message, the second message being used to indicate the link observation record.

Specifically, according to one aspect of the present application, the first condition set comprises an expiration of the second timer, and the higher layer of the first node continuously receiving the Q2 second-type indication(s) is used to trigger starting the second timer.

Specifically, according to one aspect of the present application, comprising: the first receiver, assessing third-type radio link quality according to at least partial reference signal resources indicated by the second reference signal index; whenever the evaluated third-type radio link quality is better than a third threshold, a physical layer of the first node reporting a third-type indication to a higher layer of the first node;
the meaning of the phrase of “continuously receiving Q2 the second-type indication(s)” is not receiving the third-type indication in the procedure of continuously receiving the Q2 second-type indication(s).

Specifically, according to one aspect of the present application, the behavior of transmitting a link observation record comprises transmitting a second message, and the second message is used to indicate the link observation record; whether a transmission of the second message and the second condition set being satisfied occur in a same RRC connection procedure is related to a configuration method of the second reference signal index set.

Specifically, according to one aspect of the present application, the behavior of transmitting a link observation record comprises transmitting a second message, and the second message indicates the link observation record through indicating a first identity;
herein, the first identity is associated with the first PCI.

Specifically, according to an aspect of the present application, the behavior of executing a first operation comprises storing the link observation record in a first link failure variable;
detecting RLF; storing information of the RLF in the first link failure variable;
the behavior of storing information of the RLF in the first link failure variable comprises: maintaining the link observation record stored in the first link failure variable; clearing information other than the link observation record stored in the first link failure variable;

Specifically, according to an aspect of the present application, the behavior of executing a first operation comprises storing the link observation record in a second link failure variable; the second link failure variable is different from a first link failure variable; the first link failure variable is used to store information about RLF;
the second link failure variable is used to generate a second message;
the behavior of transmitting a link observation record comprises transmitting the second message.

Specifically, according to one aspect of the present application, comprising:
transmitting a third message, the third message indicating having an available link observation record; and
receiving a fourth message, the fourth message indicating requesting a link observation record;
herein, the first node stores an available link observation record based on a state variable; the fourth message is used to trigger a second message; the third message is used to indicate a completion of a second operation; the behavior of transmitting a link observation record comprises transmitting a second message, and the second message is used to indicate the link observation record.

Specifically, according to one aspect of the present application, the first node is a UE.

Specifically, according to one aspect of the present application, the first node is an IoT terminal

Specifically, according to one aspect of the present application, the first node is a relay.

Specifically, according to one aspect of the present application, the first node is a vehicle terminal.

Specifically, according to one aspect of the present application, the first node is an aircraft.

A method in a second node for wireless communications, comprising:
transmitting a first message, the first message being used to indicate a first reference signal index set and a second reference signal index set; the first reference signal index set and the second reference signal index set each at least comprising one reference signal index; any reference signal index in the first reference signal index set indicating a reference signal resource; any reference signal index in the second reference signal index set indicating a reference signal resource; at least one reference signal index in the first reference signal index set being associated with a first PCI, and at least one reference signal index in the first reference signal index set being associated with a second PCI; any reference signal index in the second reference signal index set being associated with the first PCI;
a receiver of the first message, assessing first-type radio link quality according to at least partial reference signal resources indicated by the first reference signal index set; whenever the evaluated first-type radio link quality is worse than a first threshold, a physical layer of a receiver of the first message reports a first-type indication to a higher layer of a receiver of the first message; as a response to the higher layer of a receiver of the first message continuously receiving Q1 the first-type indications, starting a first timer, Q1 being a positive integer; as a response to the first timer being expired, detecting RLF;
a receiver of the first message, assessing second-type radio link quality according to at least partial reference signal resources indicated by the second reference signal index; whenever the evaluated second-type radio link quality is worse than a second threshold, a physical layer of a receiver of the first message reporting a second-type indication to a higher layer of a receiver of the first message;
a receiver of the first message, as a response to all conditions in a first condition set being satisfied, executing a first operation;
herein, the first condition set comprises the higher layer of the receiver of the first message continuously receiving Q2 second-type indication(s); the executing a first operation does not comprise detecting RLF; the first operation comprises generating a link observation record, or the first operation comprises transmitting a link observation record.

Specifically, according to one aspect of the present application, at least partial reference signal indexes in the second reference signal index set belong to the first reference signal index set.

Specifically, according to an aspect of the present application, the behavior of executing a first operation comprises storing the link observation record in a second link failure variable; the second link failure variable is different from a first link failure variable; the first link failure variable is used to store information about RLF;
the second link failure variable is used to generate a second message;
the behavior of transmitting a link observation record comprises transmitting the second message.

Specifically, according to one aspect of the present application, comprising:
receiving a second message, the second message being used to indicate the link observation record.

Specifically, according to one aspect of the present application, comprising:
receiving a third message, the third message indicating having an available link observation record; and
transmitting a fourth message, the fourth message indicating requesting a link observation record;
herein, a transmitter of the third message stores an available link observation record based on a state variable; the fourth message is used to trigger a second message; the third message is used to indicate a completion of a second operation; the behavior of transmitting a link observation record comprises transmitting a second message, and the second message is used to indicate the link observation record.

Specifically, according to one aspect of the present application, the second node is a UE.

Specifically, according to one aspect of the present application, the second node is an IoT terminal.

Specifically, according to one aspect of the present application, the second node is a relay.

Specifically, according to one aspect of the present application, the second node is a vehicle terminal.

Specifically, according to one aspect of the present application, the second node is an aircraft.

The present application provides a first node for wireless communications, comprising:
a first receiver, receiving a first message, the first message being used to indicate a first reference signal index set and a second reference signal index set; the first reference signal index set and the second reference signal index set each at least comprising one reference signal index; any reference signal index in the first reference signal index set indicating a reference signal resource; any reference signal index in the second reference signal index set indicating a reference signal resource; at least one reference signal index in the first reference signal index set being associated with a first PCI, and at least one reference signal index in the first reference signal index set being associated with a second PCI; any reference signal index in the second reference signal index set being associated with the first PCI;
the first receiver, assessing first-type radio link quality according to at least partial reference signal resources indicated by the first reference signal index set; whenever the evaluated first-type radio link quality is worse than a first threshold, a physical layer of the first node reporting a first-type indication to a higher layer of the first node; as a response to the higher layer of the first node continuously receiving Q1 first-type indication(s), starting the first timer, Q1 being a positive integer; as a response to the first timer being expired, detecting RLF;
the first receiver, assessing second-type radio link quality according to at least partial reference signal resources indicated by the second reference signal index; whenever the evaluated second-type radio link quality is worse than a second threshold, a physical layer of the first node reporting a second-type indication to a higher layer of the first node; and
as a response to all conditions in a first condition set being satisfied, executing a first operation;
herein, the first condition set comprises the higher layer of the first node continuously receiving Q2 second-type indication(s); the executing a first operation does not comprise detecting RLF; the first operation comprises generating a link observation record, or the first operation comprises transmitting a link observation record.

The present application provides a second node for wireless communications, comprising:
a second transmitter, transmitting a first message, the first message being used to indicate a first reference signal index set and a second reference signal index set; the first reference signal index set and the second reference signal index set each at least comprising one reference signal index; any reference signal index in the first reference signal index set indicating a reference signal resource; any reference signal index in the second reference signal index set indicating a reference signal resource; at least one reference signal index in the first reference signal index set being associated with a first PCI, and at least one reference signal index in the first reference signal index set being associated with a second PCI; any reference signal index in the second reference signal index set being associated with the first PCI;
a receiver of the first message, assessing first-type radio link quality according to at least partial reference signal resources indicated by the first reference signal index set; whenever the evaluated first-type radio link quality is worse than a first threshold, a physical layer of a receiver of the first message reports a first-type indication to a higher layer of a receiver of the first message; as a response to the higher layer of a receiver of the first message continuously receiving Q1 the first-type indications, starting a first timer, Q1 being a positive integer; as a response to the first timer being expired, detecting RLF;
a receiver of the first message, assessing second-type radio link quality according to at least partial reference signal resources indicated by the second reference signal index; whenever the evaluated second-type radio link quality is worse than a second threshold, a physical layer of a receiver of the first message reporting a second-type indication to a higher layer of a receiver of the first message; and
a receiver of the first message, as a response to all conditions in a first condition set being satisfied, executing a first operation;
herein, the first condition set comprises the higher layer of the receiver of the first message continuously receiving Q2 second-type indication(s); the executing a first operation does not comprise detecting RLF; the first operation comprises generating a link observation record, or the first operation comprises transmitting a link observation record.

In one embodiment, the present application has the following advantages over conventional schemes:
in the scenario where multiple PCIPCIs are configured for one serving cell, richer link quality information is provided, especially the link quality information when the link fails, which is conducive to network optimization in this scenario.
the base station can configure a TCI more reasonably based on the RLF report reported by the UE to avoid RLF for UEs that only support a single TRP or a single PCI.
the base station can configure reference signal resources associated with different PCIs for radio link monitoring, which helps to reduce the likelihood of RLF.

The base station can configure reference signal resources belonging to or associated with different physical cells for a same BWP of a serving cell to monitor/detect RLF, so as to reduce the trigger of RLF, improve the quality of service, and enhance the coverage of the cell.

The UE can report link failure for an individual BWP, which facilitates further network optimization.

The present application provides a method in a first node for wireless communications, comprising:
receiving a first message, the first message being used to indicate a first radio link monitoring configuration, the first radio link monitoring configuration being used to indicate at least one reference signal index, each reference signal index in the at least one reference signal index indicating a reference signal resource; measuring the reference signal resources indicated by at least partial reference signal indexes in the at least one reference signal index to determine RLF; and
transmitting a second message, the second message comprising a first RLF report;
herein, the first RLF report comprises a first bitmap and a first reference signal index measurement result set; the first reference signal index measurement result set comprises K1 reference signal index(es), K1 being a positive integer; the first bitmap indicates whether any of the K1 reference signal index(es) comprised in the first reference signal index measurement result set belongs to the first radio link monitoring configuration; any reference signal index comprised in the first reference signal index measurement result set is associated with a first PCI;
the first RLF report comprises a second bitmap and a second reference signal index measurement result set;
the second reference signal index measurement result set comprise K2 reference signal index(es), K2 being a positive integer; the second bitmap indicates whether any of the K2 reference signal index(es) comprised in the second reference signal index measurement result set belongs to the first radio link monitoring configuration; any reference signal index comprised in the second reference signal index measurement result set is associated with a second PCI.

Specifically, according to one aspect of the present application, comprising:
transmitting a third message, the third message indicating having available RLF information; and
receiving a fourth message, the fourth message indicating requesting an RLF report;
herein, the first node stores available RLF information based on a first radio link failure variable to determine that the third message indicates having available radio link failure information; the fourth message is used to trigger the second message; the third message is used to indicate a completion of a first operation.

Specifically, according to one aspect of the present application, the at least one reference signal index indicated by the first radio link monitoring configuration comprises a reference signal index associated with the first PCI and a reference signal index associated with the second PCI.

Specifically, according to one aspect of the present application, the first RLF report implicitly indicates the first PCI and explicitly comprises the second PCI.

Specifically, according to one aspect of the present application, the first RLF report comprises a first measurement result, and the first measurement result comprises a measurement result of a primary cell of the first node based on an available reference signal measurement result until the RLF is detected;
the first measurement result comprises the first bitmap and the first reference signal index measurement result set; the first measurement result comprises the second bitmap and the second reference signal index measurement result set.

Specifically, according to one aspect of the present application, the first RLF report comprises a first measurement result and a second measurement result, and the first measurement result comprises a measurement result of a primary cell of the first node based on an available reference signal measurement result until the RLF is detected; the second measurement result comprises an available measurement result of a measurement object configured by a cell other than a primary cell of the first node;
the first measurement result comprises the first bitmap and the first reference signal index measurement result set; the second measurement result comprises the second bitmap and the second reference signal index measurement result set.

Specifically, according to one aspect of the present application, measurement results of a cell other than a cell corresponding to the second PCI comprised in the second measurement result are ordered such that a highest measurement result is listed first in the second measurement result; locations of the second bitmap and the second reference signal index measurement result set in the second measurement result is unrelated to a size of a measurement result of a cell corresponding to the second PCI.

Specifically, according to one aspect of the present application, the first RLF report comprises a first measurement result and a second measurement result, and the first measurement result comprises a measurement result of a primary cell of the first node based on an available reference signal measurement result until the RLF is detected; the second measurement result comprises an available measurement result of a measurement object configured by a cell other than a primary cell of the first node;
the first measurement result comprises the first bitmap and the first reference signal index measurement result set; whether the second bitmap and the second reference signal index measurement result set are comprised by the first measurement result or are comprised by the second measurement result set is related to a type of a reference signal index comprised by the second reference signal index measurement result set; the type of the reference signal index is one of SSB-index or CSI-RS-index.

Specifically, according to one aspect of the present application, the first RLF report comprises a first measurement result, a second measurement result and a third measurement result, and the first measurement result comprises a measurement result of a primary cell of the first node based on an available reference signal measurement result until the RLF is detected; the second measurement result comprises an available measurement result of a measurement object configured by a cell other than a primary cell of the first node and a cell identified by the first PCI and a cell identified by the second PCI;
the first measurement result comprises the first bitmap and the first reference signal index measurement result set; the third measurement result comprises the second bitmap and the second reference signal index measurement result set.

Specifically, according to one aspect of the present application, the first RLF report comprises a third bitmap and a third reference signal index measurement result set; the third reference signal index measurement result set comprises K3 reference signal index(es), and the K3 is a positive integer; the third bitmap indicates whether any of the K3 reference signal index(es) comprised in the third reference signal index measurement result set belongs to the first radio link monitoring configuration; any reference signal index comprised in the third reference signal index measurement result set is associated with a second PCI.

Specifically, according to one aspect of the present application, the above first node used for wireless communications comprises:
as a response to the behavior of determining RLF, storing link failure information in a first radio link failure variable;
herein, the first RLF report comprises the link failure information stored in the first RLF variable.

Specifically, according to one aspect of the present application, the first node is a UE.

Specifically, according to one aspect of the present application, the first node is an IoT terminal.

Specifically, according to one aspect of the present application, the first node is a relay.

Specifically, according to one aspect of the present application, the first node is a vehicle terminal.

Specifically, according to one aspect of the present application, the first node is an aircraft.

A method in a second node for wireless communications, comprising:
transmitting a first message, the first message being used to indicate a first radio link monitoring configuration, the first radio link monitoring configuration being used to indicate at least one reference signal index, each reference signal index in the at least one reference signal index indicating a reference signal resource;
a receiver of the first message, measuring the reference signal resources indicated by at least partial reference signal indexes in the at least one reference signal index to determine RLF; and
receiving a second message, the second message comprising a first RLF report;
herein, the first RLF report comprises a first bitmap and a first reference signal index measurement result set; the first reference signal index measurement result set comprises K1 reference signal index(es), K1 being a positive integer; the first bitmap indicates whether any of the K1 reference signal index(es) comprised in the first reference signal index measurement result set belongs to the first radio link monitoring configuration; any reference signal index comprised in the first reference signal index measurement result set is associated with a first PCI;
the first RLF report comprises a second bitmap and a second reference signal index measurement result set;
the second reference signal index measurement result set comprise K2 reference signal index(es), K2 being a positive integer; the second bitmap indicates whether any of the K2 reference signal index(es) comprised in the second reference signal index measurement result set belongs to the first radio link monitoring configuration; any reference signal index comprised in the second reference signal index measurement result set is associated with a second PCI.

Specifically, according to one aspect of the present application, comprising:
receiving a third message, the third message indicating having available RLF information; and
transmitting a fourth message, the fourth message indicating requesting an RLF report;
herein, a transmitter of the third message determines that the third message indicates having available RLF information based on a storage of available RLF information in a first RLF variable; the fourth message is used to trigger the second message; the third message is used to indicate a completion of a first operation.

Specifically, according to one aspect of the present application, the at least one reference signal index indicated by the first radio link monitoring configuration comprises a reference signal index associated with the first PCI and a reference signal index associated with the second PCI.

Specifically, according to one aspect of the present application, the first RLF report implicitly indicates the first PCI and explicitly comprises the second PCI.

Specifically, according to one aspect of the present application, a reference signal index comprised in the at least one reference signal index indicated by the first radio link monitoring configuration is only associated with one of the first PCI and the second PCI.

Specifically, according to one aspect of the present application, any reference signal index indicated by the first radio link monitoring configuration is only associated with one of the first PCI and the second PCI.

Specifically, according to one aspect of the present application, reference signal resources corresponding to any reference signal index associated with the second PCI comprised in the at least reference signal index indicated by the first radio link monitoring configuration only comprise a CSI-RS; an SSB transmitted by a transmitter of the first radio link monitoring configuration is only associated with the first PCI instead of the second PCI.

Specifically, according to one aspect of the present application, according to the first RLF report, a Transmission Configuration Index (TCI) is configured.

Specifically, according to one aspect of the present application, the second node is a UE.

Specifically, according to one aspect of the present application, the second node is an IoT terminal.

Specifically, according to one aspect of the present application, the second node is a relay.

Specifically, according to one aspect of the present application, the second node is a vehicle terminal.

Specifically, according to one aspect of the present application, the second node is an aircraft.

The present application provides a first node for wireless communications, comprising:
a first receiver, receiving a first message, the first message being used to indicate a first radio link monitoring configuration, the first radio link monitoring configuration being used to indicate at least one reference signal index, each reference signal index in the at least one reference signal index indicating a reference signal resource; the first receiver, measuring the reference signal resources indicated by at least partial reference signal indexes in the at least one reference signal index to determine RLF; and
a first transmitter, transmitting a second message, the second message comprising a first RLF report;
herein, the first RLF report comprises a first bitmap and a first reference signal index measurement result set; the first reference signal index measurement result set comprises K1 reference signal index(es), K1 being a positive integer; the first bitmap indicates whether any of the K1 reference signal index(es) comprised in the first reference signal index measurement result set belongs to the first radio link monitoring configuration; any reference signal index comprised in the first reference signal index measurement result set is associated with a first PCI;
the first RLF report comprises a second bitmap and a second reference signal index measurement result set; the second reference signal index measurement result set comprise K2 reference signal index(es), K2 being a positive integer; the second bitmap indicates whether any of the K2 reference signal index(es) comprised in the second reference signal index measurement result set belongs to the first radio link monitoring configuration; any reference signal index comprised in the second reference signal index measurement result set is associated with a second PCI.

The present application provides a second node for wireless communications, comprising:
a second transmitter, transmitting a first message, the first message being used to indicate a first radio link monitoring configuration, the first radio link monitoring configuration being used to indicate at least one reference signal index, each reference signal index in the at least one reference signal index indicating a reference signal resource;
a receiver of the first message, measuring the reference signal resources indicated by at least partial reference signal indexes in the at least one reference signal index to determine RLF; and
a second receiver, receiving a second message, the second message comprising a first RLF report;
herein, the first RLF report comprises a first bitmap and a first reference signal index measurement result set; the first reference signal index measurement result set comprises K1 reference signal index(es), K1 being a positive integer; the first bitmap indicates whether any of the K1 reference signal index(es) comprised in the first reference signal index measurement result set belongs to the first radio link monitoring configuration; any reference signal index comprised in the first reference signal index measurement result set is associated with a first PCI;
the first RLF report comprises a second bitmap and a second reference signal index measurement result set; the second reference signal index measurement result set comprise K2 reference signal index(es), K2 being a positive integer; the second bitmap indicates whether any of the K2 reference signal index(es) comprised in the second reference signal index measurement result set belongs to the first radio link monitoring configuration; any reference signal index comprised in the second reference signal index measurement result set is associated with a second PCI.

In one embodiment, the present application has the following advantages over conventional schemes:
solving the problem of generating and reporting RLF reports when multiple physical cells are used. When physical resources, including TRPs, from multiple physical cells are used, the method proposed in the present application supports indicating reference signal resources of different physical cells used for monitoring RLF, allowing the base station to have more detailed information about RLF.
the base station can configure a TCI more reasonably according to an RLF report reported by the UE to avoid an occurrence of the RLF.

The base station can configure reference signal resources belonging to or associated with different physical cells for a same BWP of a serving cell to monitor/detect RLF, so as to reduce the trigger of RLF, improve the quality of service, and enhance the coverage of the cell.

The present application provides a method in a first node for wireless communications, comprising:
receiving a first message, the first message being used to indicate a first reference signal index set; the first reference signal index set comprising at most L1 reference signal indexes, L1 being a positive integer greater than 1;
any reference signal index in the first reference signal index set indicating a reference signal resource; and
assessing first-type radio link quality based on reference signal resources identified by at most L2 reference signal indexes in reference signal indexes indicated by the first reference signal index set, where L2 is a positive integer greater than 1;
herein, at least one reference signal index in the first reference signal index set is associated with a first PCI; at least one of L1 or L2 depends on a first parameter, and the first parameter is related to whether there exists at least one reference signal index in the first reference signal index set being associated with a second PCI; whenever the evaluated first-type radio link quality is worse than a first threshold, a physical layer of the first node reporting a first-type indication to a higher layer of the first node; as a response to the higher layer of the first node continuously receiving Q1 first-type indication(s), starting the first timer, Q1 being a positive integer; as a response to the first timer being expired, detecting RLF.

In one embodiment, a problem to be solved in the present application comprises: how to determine a number of reference signal resources used for radio link monitoring in a serving cell that supports multiple PCIs.

In one embodiment, advantages of the above method comprise: the method proposed in the present application can determine appropriate reference signal resources for radio link monitoring for a serving cell supporting multiple PCIs, which can obtain more stable, reliable radio link monitoring results, which is helpful for avoiding service interruptions and improving coverage.

Specifically, according to an aspect of the present application, the first parameter is a greater one of a maximum number of SSB indexes in a first cell and a maximum number of SSB indexes in a second cell; a PCI of the second cell is the second PCI.

Specifically, according to an aspect of the present application, the first parameter is a sum of a maximum number of SSB indexes in a first cell and a maximum number of SSB indexes in a second cell; a PCI of the second cell is the second PCI.

Specifically, according to one aspect of the present application, the first message is used to indicate a first offset, and the first offset is a positive integer; the first offset and a maximum number of SSB indexes of a first cell are used together to determine the first parameter;
there exists at least one reference signal index in the first reference signal index set being associated with the second PCI.

Specifically, according to one aspect of the present application, when there exists at least one reference signal index in the first reference signal index set being associated with the second PCI, there exists a first mapping relation between the first parameter and the L1;
when there does not exist a reference signal index in the first reference signal index set being associated with the second PCI, there exists a second mapping relation between the first parameter and the L1;
the first mapping relation is different from the second mapping relation.

Specifically, according to one aspect of the present application, when there exists at least one reference signal index in the first reference signal index set being associated with the second PCI, there exists a third mapping relation between the first parameter and the L2;
when there does not exist a reference signal index in the first reference signal index set being associated with the second PCI, there exists a fourth mapping relation between the first parameter and the L2;
the third mapping relation is different from the fourth mapping relation.

Specifically, according to one aspect of the present application, when there does not exist a reference signal index in the first reference signal index set being associated with the second PCI, a minimum value of the value range of the L2 is a first value; when there exists at least one reference signal index in the first reference signal index set being associated with the second PCI, and a minimum value of a value range of the L2 is a second value; the second value is greater than the first value.

Specifically, according to one aspect of the present application, a value of the first parameter satisfies:

Lmax=X(min(i+d,2))
herein, Lmax is the first parameter; X (i) is a maximum number of SSB indexes in a first cell, where i is a non-negative integer less than 3; min ( ) is an operation taking the minimum value; a configurable range of a maximum number of SSB indexes in the first cell at least comprises: X (0)=4, X (1)=8, X (2)=64;
when there does not exist a reference signal index in the first reference signal index set being associated with the second PCI, d is equal to 0;
when there exists at least one reference signal index in the first reference signal index set being associated with the second PCI, d is equal to 1.

Specifically, according to one aspect of the present application, the first node is accessed by not using a shared spectrum channel.

Specifically, according to one aspect of the present application, the first node is accessed by using a shared spectrum channel.

Specifically, according to one aspect of the present application, when there does not exist a reference signal index in the first reference signal index set being associated with the second PCI, and when a maximum number of SSB indexes in a first cell is equal to 4, the L2 is equal to 2;
when there exists at least one reference signal index in the first reference signal index set being associated with the second PCI, and when a maximum number of SSB indexes in a first cell is equal to 4, the L2 is greater than 2.

Specifically, according to one aspect of the present application, when there does not exist a reference signal index in the first reference signal index set being associated with the second PCI, and when a maximum number of SSB indexes in a first cell is equal to 4, the L1 is equal to 2;
when there exists at least one reference signal index in the first reference signal index set being associated with the second PCI, and when a maximum number of SSB indexes in a first cell is equal to 4, the L1 is greater than 2.

Specifically, according to one aspect of the present application, when there does not exist a reference signal index in the first reference signal index set being associated with the second PCI, and when a maximum number of SSB indexes in a first cell is equal to 8, the L2 is equal to 4;
when there exists at least one reference signal index in the first reference signal index set being associated with the second PCI, and when a maximum number of SSB indexes in a first cell is equal to 8, the L1 is greater than 4.

Specifically, according to one aspect of the present application, a maximum number of SSB indexes in a first cell is less than 64, and the first cell is identified by the first PCI, and the first PCI is configured by a physCellId of the ServingCellConfigCommon received by the first node.

Specifically, according to one aspect of the present application, the first reference signal index set comprises at least one reference signal index being associated with the second PCI; the first reference signal index set comprises at least one reference signal index being associated with the first PCI;
the first message is used to indicate a number of reference signal index(es) associated with the first PCI among the at most L2 reference signal index(es).

Specifically, according to one aspect of the present application, the first reference signal index set comprises at least one reference signal index being associated with the second PCI; the first reference signal index set comprises at least one reference signal index being associated with the first PCI;
a difference value between a number of reference signal index(es) associated with the first PCI and a number of reference signal index(es) associated with the second PCI among at most L2 reference signal index(es) is not greater than 1.

Specifically, according to one aspect of the present application, the first node is a UE.

Specifically, according to one aspect of the present application, the first node is an IoT terminal.

Specifically, according to one aspect of the present application, the first node is a relay.

Specifically, according to one aspect of the present application, the first node is a vehicle terminal.

Specifically, according to one aspect of the present application, the first node is an aircraft.

A method in a second node for wireless communications, comprising:
transmitting a first message, the first message being used to indicate a first reference signal index set; the first reference signal index set comprising at most L1 reference signal indexes, L1 being a positive integer greater than 1; any reference signal index in the first reference signal index set indicating a reference signal resource; and
a receiver of the first message, assessing first-type radio link quality based on reference signal resources identified by at most L2 reference signal indexes in reference signal indexes indicated by the first reference signal index set, where L2 is a positive integer greater than 1;
herein, at least one reference signal index in the first reference signal index set is associated with the first PCI; at least one of L1 or L2 depends on a first parameter, and the first parameter is related to whether there exists at least one reference signal index in the first reference signal index set being associated with a second PCI; whenever the evaluated first-type radio link quality is worse than a first threshold, a physical layer of a receiver of the first message reports a first-type indication to a higher layer of a receiver of the first message; as a response to the higher layer of a receiver of the first message continuously receiving Q1 the first-type indications, starting a first timer, Q1 being a positive integer; as a response to the first timer being expired, detecting RLF.

Specifically, according to an aspect of the present application, the first parameter is a greater one of a maximum number of SSB indexes in a first cell and a maximum number of SSB indexes in a second cell; a PCI of the second cell is the second PCI.

Specifically, according to an aspect of the present application, the first parameter is a sum of a maximum number of SSB indexes in a first cell and a maximum number of SSB indexes in a second cell; a PCI of the second cell is the second PCI.

Specifically, according to one aspect of the present application, the first message is used to indicate a first offset, and the first offset is a positive integer; the first offset and a maximum number of SSB indexes of a first cell are used together to determine the first parameter;

there exists at least one reference signal index in the first reference signal index set being associated with the second PCI.

Specifically, according to one aspect of the present application, a value of the first parameter satisfies:

Lmax=X(min(i+d,2))
herein, Lmax is the first parameter; X (i) is a maximum number of SSB indexes in a first cell, where i is a non-negative integer less than 3; min ( ) is an operation taking the minimum value; a configurable range of a maximum number of SSB indexes in the first cell at least comprises: X (0)=4, X (1)=8, X (2)=64;
when there does not exist a reference signal index in the first reference signal index set being associated with the second PCI, d is equal to 0;
when there exists at least one reference signal index in the first reference signal index set being associated with the second PCI, d is equal to 1.

Specifically, according to one aspect of the present application, the first reference signal index set comprises at least one reference signal index being associated with the second PCI; the first reference signal index set comprises at least one reference signal index being associated with the first PCI;
the first message is used to indicate a number of reference signal index(es) associated with the first PCI among the at most L2 reference signal index(es).

Specifically, according to one aspect of the present application, a first signaling is transmitted, the first signaling comprises ServingCellConfigCommon, and a physCellId field of the ServingCellConfigCommon indicates the first PCI; the first PCI is used to identify a first cell.

Specifically, according to one aspect of the present application, the second node is a UE.

Specifically, according to one aspect of the present application, the second node is an IoT terminal.

Specifically, according to one aspect of the present application, the second node is a relay.

Specifically, according to one aspect of the present application, the second node is a vehicle terminal.

Specifically, according to one aspect of the present application, the second node is an aircraft.

The present application provides a first node for wireless communications, comprising:
a first receiver, receiving a first message, the first message being used to indicate a first reference signal index set; the first reference signal index set comprising at most L1 reference signal indexes, L1 being a positive integer greater than 1; any reference signal index in the first reference signal index set indicating a reference signal resource; and
the first receiver, assessing first-type radio link quality based on reference signal resources identified by at most L2 reference signal indexes in reference signal indexes indicated by the first reference signal index set, where L2 is a positive integer greater than 1;
herein, at least one reference signal index in the first reference signal index set is associated with a first PCI; at least one of L1 or L2 depends on a first parameter, and the first parameter is related to whether there exists at least one reference signal index in the first reference signal index set being associated with a second PCI; whenever the evaluated first-type radio link quality is worse than a first threshold, a physical layer of the first node reporting a first-type indication to a higher layer of the first node; as a response to the higher layer of the first node continuously receiving Q1 first-type indication(s), starting the first timer, Q1 being a positive integer; as a response to the first timer being expired, detecting RLF.

The present application provides a second node for wireless communications, comprising:
a second transmitter, transmitting a first message, the first message being used to indicate a first reference signal index set; the first reference signal index set comprising at most L1 reference signal indexes, L1 being a positive integer greater than 1; any reference signal index in the first reference signal index set indicating a reference signal resource; and
a receiver of the first message, assessing first-type radio link quality based on reference signal resources identified by at most L2 reference signal indexes in reference signal indexes indicated by the first reference signal index set, where L2 is a positive integer greater than 1;
herein, at least one reference signal index in the first reference signal index set is associated with a first PCI; at least one of L1 or L2 depends on a first parameter, and the first parameter is related to whether there exists at least one reference signal index in the first reference signal index set being associated with a second PCI; whenever the evaluated first-type radio link quality is worse than a first threshold, a physical layer of the first node reporting a first-type indication to a higher layer of the first node; as a response to the higher layer of the first node continuously receiving Q1 first-type indication(s), starting the first timer, Q1 being a positive integer; as a response to the first timer being expired, detecting RLF.

In one embodiment, the present application has the following advantages over conventional schemes:
the base station can configure reference signal resources associated with multiple PCIs for radio link monitoring, which helps to reduce the likelihood of RLF.
for the scenario where one serving cell is configured with multiple PCIs, the result of radio link monitoring result is more accurate, and once RLF is detected, the corresponding RLF report can provide richer link quality information, especially link quality information for a cell identified by a single PCI when the link fails, which is conducive to the optimization of the network for this scenario.
the base station can configure reference signal resources belonging to or associated with different physical cells for a BWP of a serving cell to monitor/detect RLF, so as to reduce the trigger of RLF, improve the quality of service, and enhance the coverage of the cell. The UE can report link failure for a single BWP, which facilitates further network optimization.
the UE can select appropriate reference signal resources for radio link monitoring for different TRPs or reference signal resources associated with different PCIs, which is conducive to obtaining more accurate monitoring results and avoiding transmission interruption.

### BRIEF DESCRIPTION OF THE DRAWINGS

Other features, objects and advantages of the present application will become more apparent from the detailed description of non-restrictive embodiments taken in conjunction with the following drawings:

FIG. 1A illustrates a flowchart of receiving a first message, assessing first-type radio link quality according to at least partial reference signal resources indicated by the first reference signal index set, assessing second-type radio link quality according to at least partial reference signal resources indicated by the second reference signal index set, and executing a first operation according to one embodiment of the present application;

FIG. 1B illustrates a flowchart of receiving a first message and transmitting a second message according to one embodiment of the present application;

FIG. 1C illustrates a flowchart of receiving a first message and assessing first-type radio quality according to reference signal resources identified by at most L2 reference signal index(es) in reference signal indexes indicated by a first reference signal index set according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5A illustrates a flowchart of radio signal transmission according to one embodiment of the present application;

FIG. 5B illustrates a flowchart of radio signal transmission according to one embodiment of the present application;

FIG. 5C illustrates a flowchart of radio signal transmission according to one embodiment of the present application;

FIG. 6A illustrates a schematic diagram of a first bitmap indicating whether a reference signal index belongs to the first radio link monitoring configuration according to one embodiment of the present application;

FIG. 6B illustrates a schematic diagram of a bitmap indicating whether a reference signal index belongs to the first radio link monitoring configuration according to one embodiment of the present application;

FIG. 6C illustrates a schematic diagram of a reference signal index identifying reference signal resources according to one embodiment of the present application;

FIG. 7A illustrates a schematic diagram of a first link failure variable according to one embodiment of the present application;

FIG. 7B illustrates a schematic diagram of a first RLF variable according to one embodiment of the present application;

FIG. 7C illustrates a schematic diagram of a first parameter, L1 and L2 according to one embodiment of the present application;

FIG. 8A illustrates a schematic diagram of a second message being used to indicate a link observation record according to one embodiment of the present application;

FIG. 8B illustrates a schematic diagram of a second measurement result according to one embodiment of the present application;

FIG. 8C illustrates a schematic diagram of at least one of L1 or L2 depending on a first parameter according to one embodiment of the present application;

FIG. 9 illustrates a schematic diagram of a second measurement result according to one embodiment of the present application;

FIG. 10 illustrates a schematic diagram of measuring the reference signal resources indicated by at least partial reference signal indexes in the at least one reference signal index to determine RLF according to one embodiment of the present application;

FIG. 11A illustrates a schematic diagram of a processor in a first node according to one embodiment of the present application;

FIG. 11B illustrates a schematic diagram of a processor in a first node according to one embodiment of the present application;

FIG. 11C illustrates a schematic diagram of a processor in a first node according to one embodiment of the present application;

FIG. 12A illustrates a schematic diagram of a processor in a second node according to one embodiment of the present application;

FIG. 12B illustrates a schematic diagram of a processor in a second node according to one embodiment of the present application;

FIG. 12C illustrates a schematic diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1A

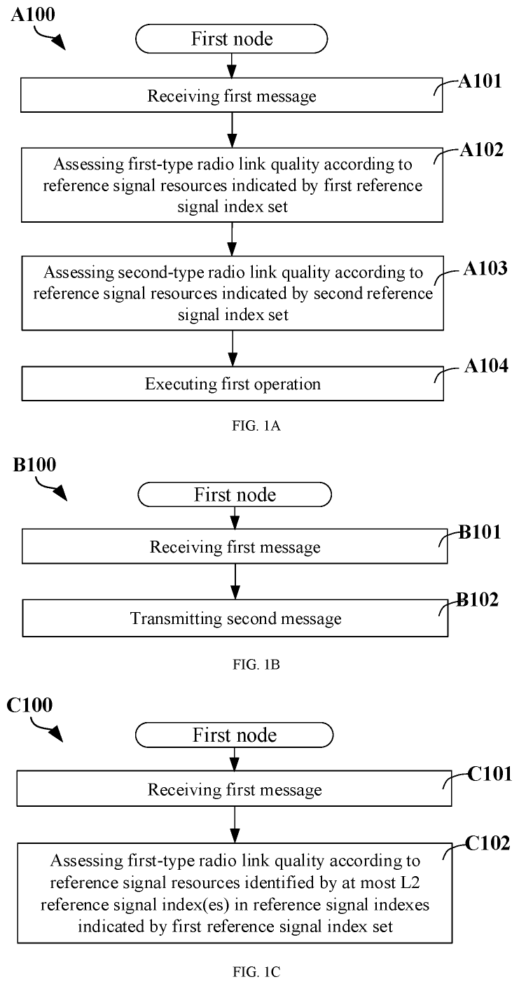

Embodiment 1A illustrates a flowchart of receiving a first message, assessing first-type radio link quality according to at least partial reference signal resources indicated by the first reference signal index set, assessing second-type radio link quality according to at least partial reference signal resources indicated by the second reference signal index set, and executing a first operation according to one embodiment of the present application, as shown in FIG. 1A. In FIG. 1A, each box represents a step. It should be noted particularly that the order in which the boxes are arranged does not imply a chronological sequence of each step respectively marked.

In Embodiment 1A, a first node in the present application receives a first message in step A101; assesses first-type radio link quality according to at least partial reference signal resources indicated by the first reference signal index in step A102; assesses second-type radio link quality according to at least partial reference signal resources indicated by the second reference signal index in step A103; executes a first operation in step A104;
herein, the first message is used to indicate the first reference signal index set and the second reference signal index set; the first reference signal index set and the second reference signal index set each comprises at least one reference signal index; any reference signal index in the first reference signal index set indicates a reference signal resource; any reference signal index in the second reference signal index set indicates a reference signal resource; at least one reference signal index in the first reference signal index set is associated with a first PCI, and at least one reference signal index in the first reference signal index set is associated with a second PCI; any reference signal index in the second reference signal index set is associated with the first PCI;
the first node, whenever the evaluated first-type radio link quality is worse than a first threshold, a physical layer of the first node reports a first-type indication to a higher layer of the first node; as a response to the higher layer of the first node continuously receiving Q1 first-type indication(s), starting the first timer, Q1 being a positive integer; as a response to the first timer being expired, detecting RLF;
the first node, whenever the evaluated second-type radio link quality is worse than a second threshold, a physical layer of the first node reports a second-type indication to a higher layer of the first node;
the first node, as a response to all conditions in a first condition set being satisfied, executing a first operation;
herein, the first condition set comprises the higher layer of the first node continuously receiving Q2 second-type indication(s); the executing a first operation does not comprise detecting RLF; the first operation comprises generating a link observation record, or the first operation comprises transmitting a link observation record.

In one embodiment, the first node is a User Equipment (UE).

In one embodiment, the first node is a Mobile Station (MS).

In one embodiment, bandwidth self-adaptation is supported in 5G NR; a subset of a total cell bandwidth of a cell is called a BWP; the base station realizes bandwidth self-adaptation by configuring BWPs to the UE and telling the UE which of the configured BWPs is a currently active BWP.

In one embodiment, a transmitter of the first message is a serving cell of the first node.

In one embodiment, a transmitter of the first message is a PCell of the first node.

In one embodiment, a transmitter of the first message is an SpCell of the first node.

In one embodiment, the first message is an RRC message.

In one embodiment, the first message comprises and only comprises an RRCReconfiguration.

In one embodiment, the first message comprises a first sub-message and a second sub-message, and the first sub-message is used to indicate a first reference signal index set; the second sub-message is used to indicate a second reference signal index set.

In one subembodiment of the above embodiment, the first sub-message comprises a first radio link monitoring configuration.

In one subembodiment of the above embodiment, the first sub-message comprises an RRCReconfiguration message.

In one subembodiment of the above embodiment, the first sub-message comprises RadioLinkMonitoringConfig.

In one subembodiment of the above embodiment, the first sub-message comprises RadioLinkMonitoringConfig of each BWP.

In one subembodiment of the above embodiment, the first sub-message comprises RadioLinkMonitoringConfig of a BWP.

In one subembodiment of the above embodiment, the second-message comprises an RRCReconfiguration message.

In one subembodiment of the above embodiment, the second sub-message comprises cellgroupconfig.

In one subembodiment of the above embodiment, the second sub-message comprises servingcellconfig.

In one subembodiment of the above embodiment, the second sub-message comprises measObjNR.

In one subembodiment of the above embodiment, the second message comprises MeasObjectToAddModList.

In one subembodiment of the above embodiment, the second sub-message comprises ReportConfigNR.

In one subembodiment of the above embodiment, the second sub-message comprises RadioLinkMonitoringConfig of one BWP.

In one embodiment, the first message comprises a first radio link monitoring configuration.

In one subembodiment of the above embodiment, the second sub-message comprises RadioLinkMonitoringConfig.

In one subembodiment of the above embodiment, a first radio link monitoring configuration comprises RadioLinkMonitoringConfig.

In one subembodiment of the above embodiment, a first radio link monitoring configuration is RadioLinkMonitoringConfig.

In one subembodiment of the above embodiment, a first radio link monitoring configuration is BeamFailureRecoveryConfig.

In one subembodiment of the above embodiment, a first radio link monitoring configuration comprises RadioLinkMonitoringRS.

In one subembodiment of the above embodiment, a first radio link monitoring configuration is RadioLinkMonitoringRS.

In one subembodiment of the above embodiment, a first radio link monitoring configuration indicates reference signal resources provided or associated with an activated TCI state in CORESETs used to receive a PDCCH on an active BWP of the first node.

In one subembodiment of the above embodiment, the first radio link monitoring configuration comprises the first reference signal index set.

In one embodiment, the first message indicates an identity of the first radio link monitoring configuration.

In one embodiment, the first message comprises the first radio link monitoring configuration.

In one embodiment, at least partial reference signal indexes in the second reference signal index set belong to the first reference signal index set.

In one embodiment, the first reference signal index set is configured through unicast; the second reference signal index set is configured through non-unicast.

In one embodiment, the first reference signal index set is configured through unicast; the second reference signal index set is configured through unicast.

In one embodiment, each reference signal index in the first reference signal index set indicates a reference signal resource, and the reference signal resource is a synchronization signal block or synchronization signal/PBCH block (SSB) or a Channel State Information Reference Signal (CSI-RS).

In one embodiment, an index of each reference signal in the first reference signal index set is an ssb-index or a csi-rs-index.

In one embodiment, an index of each reference signal in the second reference signal index set is an ssb-index or a csi-rs-index.

In one embodiment, each reference signal index in the first reference signal index set indicates a reference signal resource, and the reference signal resource is an SSB or a CSI-RS resource.

In one embodiment, each reference signal index in the first reference signal index set indicates a reference signal resource, and the reference signal resource is an SSB resource or a CSI-RS resource.

In one embodiment, each reference signal index in the first reference signal index set indicates a reference signal resource, and the reference signal resource is a resource occupied by an SSB or a resource occupied by a CSI-RS.

In one embodiment, each reference signal index in the second reference signal index set indicates a reference signal resource, and the reference signal resource is a synchronization signal block or synchronization signal/PBCH block (SSB) or a Channel State Information-Reference Signal (CSI-RS).

In one embodiment, each reference signal index in the second reference signal index set indicates a reference signal resource, and the reference signal resource is an SSB resource or a CSI-RS resource.

In one embodiment, each reference signal index in the second reference signal index set indicates a reference signal resource, and the reference signal resource is a resource occupied by an SSB or a resource occupied by a CSI-RS.

In one embodiment, each reference signal index in the second reference signal index set belongs to the first reference signal index set.

In one embodiment, each ssb-index reference signal index in the second reference signal index set belongs to the first reference signal index set.

In one embodiment, each csi-rs-index reference signal index in the second reference signal index set belongs to the first reference signal index set.

In one embodiment, all reference signal indexes associated with the first PCI in the first reference signal index set belong to the second reference signal index set.

In one embodiment, the csi-rs-index indicates a NZP-CSI-RS-ResourceId.

In one embodiment, the SSB is a synchronization signal block.

In one embodiment, the SSB is a synchronization signal/PBCH block (SS/PBCH block).

In one embodiment, any reference signal index in the first reference signal index set is a non-negative integer.

In one embodiment, any reference signal index in the first reference signal index set is a structure.

In one embodiment, any reference signal index in the first reference signal index set is a structure comprising a non-negative integer.

In one embodiment, any reference signal index in the first reference signal index set comprises a structure of a PCI and an SSB-index.

In one embodiment, any reference signal index in the first reference signal index set comprises a structure of a PCI and a csi-rs-index.

In one embodiment, any reference signal index in the first reference signal index set comprises an SSB-index.

In one embodiment, any reference signal index in the first reference signal index set comprises a csi-rs-index.

In one embodiment, any reference signal index in the first reference signal index set comprises a NZP-CSI-RS-ResourceId.

In one embodiment, any reference signal index in the first reference signal index set comprises a CSI-RS Resource Indicator (CRI).

In one embodiment, the second reference signal index set only comprises a reference signal index on an active BWP.

In one embodiment, the second reference signal index set only indicates reference signal resources on an active BWP.

In one embodiment, the second reference signal index set comprises a reference signal index on multiple BWPs.

In one embodiment, the second reference signal index set comprises reference signal resources on multiple BWPs.

In one embodiment, any reference signal index in the second reference signal index set is a non-negative integer.

In one embodiment, any reference signal index in the second reference signal index set is a structure.

In one embodiment, any reference signal index in the second reference signal index set is a structure comprising a non-negative integer.

In one embodiment, any reference signal index in the second reference signal index set comprises a structure of a PCI and an SSB-index.

In one embodiment, any reference signal index in the second reference signal index set comprises a structure of a PCI and a csi-rs-index.

In one embodiment, any reference signal index in the second reference signal index set comprises an SSB-index.

In one embodiment, any reference signal index in the second reference signal index set comprises a csi-rs-index.

In one embodiment, any reference signal index in the second reference signal index set comprises a NZP-CSI-RS-ResourceId.

In one embodiment, any reference signal index in the second reference signal index set comprises a CSI-RS Resource Indicator (CRI).

In one embodiment, each reference signal index in the second reference signal index set indicates that a reference signal resource is a detectionResource.

In one embodiment, each reference signal index in the second reference signal index set indicates that a reference signal resource is SSB-index.

In one embodiment, each reference signal index in the second reference signal index set indicates that a reference signal resource is a resource corresponding to or identified by or determined by an SSB-index.

In one embodiment, each reference signal index in the second reference signal index set indicates that a reference signal resource is a csi-rs-index.

In one embodiment, each reference signal index in the second reference signal index set indicates that a reference signal resource is a resource corresponding to or identified or determined by a csi-rs-index.

In one embodiment, each reference signal index in the first reference signal index set indicates that a reference signal resource is a detectionResource.

In one embodiment, each reference signal index in the first reference signal index set indicates that a reference signal resource is an SSB-index.

In one embodiment, each reference signal index in the first reference signal index set indicates that a reference signal resource is a resource corresponding to or identified by or determined by an SSB-index.

In one embodiment, each reference signal index in the first reference signal index set indicates that a reference signal resource is a csi-rs-index.

In one embodiment, each reference signal index in the first reference signal index set indicates that a reference signal resource is a resource corresponding to or identified or determined by a csi-rs-index.

In one embodiment, the resource comprises at least one of time-domain frequency-domain resources or spatial-domain resources.

In one embodiment, reference signal resources identified by a reference signal index in the second reference signal index set belongs to a BWP used for multicast.

In one embodiment, reference signal resources identified by a reference signal index in the second reference signal index set are configured to a BWP used for multicast.

In one embodiment, reference signal resources identified by a reference signal index in the second reference signal index set are used for a reception of multicast services.

In one embodiment, a reference signal index corresponding to any reference signal resource of a BWP used for multicast belongs to the second reference signal index set.

In one embodiment, the being used for multicast comprises Multicast Broadcast Service (MBS) services.

In one embodiment, the multicast services comprise MBS.

In one embodiment, the being used for multicast comprises Point to Multipoint (PTM).

In one embodiment, the first PCI is different from the second PCI.

In one embodiment, the first PCI is a Physical Cell Identifier (PCI).

In one embodiment, the first PCI is PhysCellId.

In one embodiment, the first PCI is Physical cell ID.

In one embodiment, the first PCI identifies a physical cell.

In one embodiment, the first PCI is used to generate an SSB identifying a physical cell.

In one embodiment, the first PCI is quasi co-located with an SSB of an identified physical cell.

In one embodiment, the first PCI is a physCellId comprised in the received ServingCellConfigCommon.

In one embodiment, the first PCI is a physCellId comprised in a received spCellConfigCommon.

In one embodiment, the second PCI is a PCI.

In one embodiment, the second PCI is PhysCellId.

In one embodiment, the second PCI is a Physical cell ID.

In one embodiment, the second PCI identifies a physical cell.

In one embodiment, the second PCI is used to generate an SSB identifying a physical cell.

In one embodiment, the second PCI is quasi co-located with an SSB of an identified physical cell.

In one embodiment, the second PCI is not indicated by a physCellId comprised in the received ServingCellConfigCommon.

In one embodiment, the first PCI is not a physCellId comprised in the received spCellConfigCommon.

In one embodiment, the second PCI is not indicated by the received ServingCellConfigCommon.

In one embodiment, the first PCI is not indicated by the received spCellConfigCommon.

In one embodiment, the first reference signal index set at least comprises one reference signal index.

In one embodiment, the second reference signal index set at least comprises one reference signal index.

In one embodiment, the first reference signal index set comprises a reference signal index of a reference signal on a BWP.

In one embodiment, the first reference signal index set comprises a reference signal index of a reference signal on multiple BWPs.

In one embodiment, the first reference signal index set comprises a reference signal index of a reference signal on an active BWP.

In one embodiment, the second reference signal index set comprises a reference signal index of a reference signal on an active BWP.

In one embodiment, the second reference signal index set comprises a reference signal index of a reference signal on multiple BWPs.

In one embodiment, the first reference signal index set comprises a reference signal index associated with the first PCI, as well as a reference signal index associated with the second PCI.

In one embodiment, a number of reference signal index(es) comprised in the first reference signal index set is configurable.

In one embodiment, a number of reference signal index(es) comprised in the second reference signal index set is configurable.

In one embodiment, the meaning of the phrase that any reference signal index in the second reference signal index set is associated with the first PCI is that any reference signal index in the second reference signal index set is only associated with the first PCI instead of the second PCI.

In one embodiment, the meaning of the phrase that any reference signal index in the second reference signal index set is associated with the first PCI is that all reference signal indexes in the second reference signal index set are associated with the first PCI instead of the second PCI.

In one embodiment, RadioLinkMonitoringRS indicated by the first message comprises the first reference signal index set.

In one embodiment, the first message implicitly indicates the second reference signal index set; all reference signal indexes associated with the first PCI in the first reference signal index set consist the second reference signal index set.

In one embodiment, all reference signal indexes associated with the first PCI in the first reference signal index set belong to the second reference signal index set; the second reference signal index set only comprises a reference signal index associated with the first PCI in the first reference signal index set.

In one embodiment, the first condition set comprises an expiration of the second timer, and the higher layer of the first node continuously receiving the Q2 second-type indication(s) is used to trigger starting the second timer.

In one subembodiment of the embodiment, the second timer is T310.

In one subembodiment of the embodiment, the second timer is a timer other than T310.

In one subembodiment of the embodiment, an expiration value of the second timer is the same as an expiration value of the first timer.

In one subembodiment of the embodiment, an expiration value of the second timer is less than an expiration value of the first timer.

In one subembodiment of the embodiment, when the higher layer of the first node continuously receives the Q2 second-type indication(s), the second timer starts.

In one embodiment, the first condition set comprises that the first timer is not expired.

In one embodiment, the first condition set comprises that the first timer is not started.

In one embodiment, the first condition set comprises that a number of the first-type indication(s) continuously received from the higher layer of the first node is less than Q1.

In one embodiment, Q2 is a positive integer.

In one embodiment, Q2 is equal to the Q1.

In one embodiment, an evaluation period for the first-type radio link quality is the same as an evaluation period for the second-type radio link quality.

In one embodiment, an evaluation period for the first-type radio link quality is independent from an evaluation period for the second-type radio link quality.

In one embodiment, reporting periods of the first-type radio link quality and the second-type radio link quality from the physical layer of the first node to the higher layer of the first node are the same.

In one embodiment, an evaluation period for the first-type radio link quality is one frame.

In one embodiment, an evaluation period of the first-type radio link quality is 10 milliseconds.

In one embodiment, an evaluation period of the first-type radio link quality is a maximum value between a shortest radio link monitoring period and 10 ms.

In one embodiment, an evaluation period of the first-type radio link quality is a maximum value between a shortest radio link monitoring period and a Discontinuous Reception (DRX) period.

In one embodiment, an evaluation period for the second-type radio link quality is one frame.

In one embodiment, an evaluation period of the second-type radio link quality is 10 milliseconds.

In one embodiment, an evaluation period of the second-type radio link quality is a maximum value between a shortest radio link monitoring period and 10 ms.

In one embodiment, an evaluation period of the second-type radio link quality is a maximum value between a shortest radio link monitoring period and a Discontinuous Reception (DRX) period.

In one embodiment, Q1 is equal to the Q2.

In one embodiment, Q1 and Q2 are independently configured.

In one embodiment, Q1 is configured by a System Information Block (SIB).

In one embodiment, Q2 is configured by an SIB.

In one embodiment, Q1 is N310.

In one embodiment, Q2 is N310.

In one embodiment, Q2 is a value other than N310.

In one embodiment, a serving cell of the first node is configured with the first threshold.

In one embodiment, a serving cell of the first node is configured with the second threshold.

In one embodiment, the first threshold is the same as the second threshold.

In one embodiment, the first threshold is determined by receiving quality of a PDCCH (physical downlink control channel).

In one embodiment, the second threshold is determined by receiving quality of a PDCCH.

In one embodiment, the first threshold corresponds to observation quality of a radio link when a BLER of a PDCCH is 10%.

In one embodiment, the first threshold corresponds to observation quality of a radio link when a BLER of an assumed PDCCH is 10%.

In one subembodiment of the above embodiment, assuming that a PDCCH channel is transmitted on reference signal resources identified by the first reference signal index set, a measurement result of the reference signal resources identified by the first reference signal index set is the first threshold when the reception quality of the PDCCH is BLER (block error rate)=10%.

In one subembodiment of the above embodiment, when a measurement result of reference signal resources identified by the first reference signal index set is the first threshold, a PDCCH is transmitted on reference signal resources identified by the first reference signal index set, and BLER of the transmitted PDCCH is equal to 10%.

In one subembodiment of the above embodiment, the first threshold is an observation result of reference signal resources identified by the first reference signal index set determined by the hypothesis experiment for reception quality of the PDCCH, where the reception quality of the PDCCH channel is BLER equal to 10%.

In one embodiment, the second threshold corresponds to observation quality of a radio link when a BLER of a PDCCH is 10%.

In one embodiment, the second threshold corresponds to observation quality of a radio link when a BLER of an assumed PDCCH is 10%.

In one subembodiment of the above embodiment, assuming that a PDCCH channel is transmitted on reference signal resources identified by the first reference signal index set, a measurement result of reference signal resources identified by the second reference signal index set is the second threshold when the reception quality of the PDCCH is BLER (block error rate)=10%.

In one subembodiment of the above embodiment, when a measurement result of reference signal resources identified by the second reference signal index set is the second threshold, a PDCCH is transmitted on reference signal resources identified by the second reference signal index set, and BLER of the transmitted PDCCH is equal to 10%.

In one subembodiment of the above embodiment, the second threshold is an observation result of reference signal resource identified by the second reference signal index set determined by the hypothesis experiment for reception quality of the PDCCH channel, where the reception quality of the PDCCH channel is BLER equal to 10%.

In one embodiment, the first threshold is equal to the second threshold.

In one embodiment, the first threshold is less than the second threshold.

In one embodiment, the first threshold is RSRP, and the first-type radio link quality is RSRP of the reference signal resources indicated by the first reference signal index set.

In one subembodiment of the embodiment, RSRP of the reference signal resources indicated by the first reference signal index set is a measurement result on the reference signal resource indicated by the first reference signal index set.

In one subembodiment of the embodiment, RSRP of the reference signal resources indicated by the first reference signal index set is an evaluation result on the reference signal resource indicated by the first reference signal index set.

In one embodiment, the first threshold is Reference Signal Receiving Quality (RSRQ), and the first-type radio link quality is RSRQ of the reference signal resources indicated by the first reference signal index set.

In one subembodiment of the embodiment, RSRP of the reference signal resources indicated by the first reference signal index set is a measurement result on the reference signal resource indicated by the first reference signal index set.

In one subembodiment of the embodiment, RSRP of the reference signal resources indicated by the first reference signal index set is an evaluation result on the reference signal resource indicated by the first reference signal index set.

In one embodiment, the first threshold is an SINR, and the first-type radio link quality is a Signal to Interference plus Noise Ratio (SINR) of the reference signal resources indicated by the first reference signal index set.

In one subembodiment of the embodiment, RSRP of the reference signal resources indicated by the first reference signal index set is a measurement result on the reference signal resource indicated by the first reference signal index set.

In one subembodiment of the embodiment, RSRP of the reference signal resources indicated by the first reference signal index set is an evaluation result on the reference signal resource indicated by the first reference signal index set.

In one embodiment, the second threshold is RSRP, and the second-type radio link quality is RSRP of the reference signal resources indicated by the second reference signal index set.

In one subembodiment of the embodiment, RSRP of the reference signal resources indicated by the second reference signal index set is a measurement result on the reference signal resource indicated by the second reference signal index set.

In one subembodiment of the embodiment, RSRP of the reference signal resources indicated by the second reference signal index set is an evaluation result on the reference signal resource indicated by the second reference signal index set.

In one embodiment, the second threshold is Reference Signal Receiving Quality (RSRQ), and the second-type radio link quality is RSRQ of the reference signal resources indicated by the second reference signal index set.

In one subembodiment of the embodiment, RSRP of the reference signal resources indicated by the second reference signal index set is a measurement result on the reference signal resources indicated by the second reference signal index set.

In one subembodiment of the embodiment, RSRP of the reference signal resources indicated by the second reference signal index set is an evaluation result on the reference signal resources indicated by the second reference signal index set.

In one embodiment, the second threshold is an SINR, and the second-type radio link quality is a Signal to Interference plus Noise Ratio (SINR) of the reference signal resources indicated by the second reference signal index set.

In one subembodiment of the embodiment, RSRP of the reference signal resources indicated by the second reference signal index set is a measurement result on the reference signal resources indicated by the second reference signal index set.

In one subembodiment of the embodiment, RSRP of the reference signal resources indicated by the second reference signal index set is an evaluation result on the reference signal resources indicated by the second reference signal index set.

In one embodiment, the physical layer of the first node is a PHY layer or a PHY sublayer.

In one embodiment, the higher layer of the first node is an RRC layer or RRC sublayer.

In one embodiment, the higher layer of the first node is a MAC layer or MAC sublayer.

In one embodiment, the higher layer of the first node comprises an RRC layer.

In one embodiment, the higher layer of the first node comprises a MAC layer.

In one embodiment, the first-type radio link quality comprises RSRP.

In one embodiment, the first-type radio link quality comprises RSRQ.

In one embodiment, the first-type radio link quality comprises SINR.

In one embodiment, the first-type indication is “out-of-sync”.

In one embodiment, the second-type radio link quality comprises RSRP.

In one embodiment, the second-type radio link quality comprises RSRQ.

In one embodiment, the second-type radio link quality comprises SINR.

In one embodiment, the second-type indication is “out-of-sync”.

In one embodiment, the second-type indication is used to indicate that the second-type radio link quality is worse than a second threshold.

In one embodiment, the second-type indication is used to indicate that the second-type radio link quality of reference signal resources identified by any reference signal index in the second reference signal index set is worse than the second threshold.

In one embodiment, the second-type indication is that the second-type radio link quality is worse than a second threshold.

In one embodiment, the second-type indication is “out-of-sync” of a cell identified by the first PCI.

In one embodiment, the second-type indication is “out-of-sync” of a radio link of a cell identified by the first PCI.

In one embodiment, the first timer is T310.

In one embodiment, the first timer and the second timer are respectively configured by a serving cell of the first node.

In one embodiment, a value of Q1 is one of 1, 2, 3, 4, 6, 8, 10 or 20.

In one embodiment, a value of Q2 is one of 1, 2, 3, 4, 6, 8, 10 or 20.

In one embodiment, the Q1 and the Q2 are respectively configured by a serving cell of the first node.

In one embodiment, an expiration of the first timer triggers RLF.

In one embodiment, an expiration of the first timer triggers that the first node assumes that RLF occurs or is detected.

In one embodiment, an expiration of the first timer confirms the behavior of detecting RLF.

In one embodiment, when all conditions in the first condition set are satisfied, the first node executes the first operation.

In one embodiment, the link observation record comprises the second-type radio link quality.

In one embodiment, the link observation record comprises a measurement result for reference signal resources identified by at least one reference signal index in the second reference signal index set.

In one embodiment, the link observation record comprises best n1 measurement results of reference signal resources identified by a reference signal index in the second reference signal index set, n1 being a positive integer.

In one subembodiment of the embodiment, the n1 is indicated by a serving cell of the first node.

In one embodiment, the link observation record comprises a measurement result for reference signal resources of a cell identified by the first PCI.

In one embodiment, the link observation record comprises a measurement result for reference signal resources associated with a cell identified by the first PCI.

In one embodiment, the link observation record comprises an indication that all conditions in the first condition set are satisfied.

In one embodiment, the link observation record comprises that the higher layer of the first node continuously receives the Q2 second-type indication(s).

In one embodiment, the behavior of transmitting a link observation record comprises generating the link observation record.

In one embodiment, the meaning of the phrase of assessing first-type radio link quality according to at least partial reference signal resources indicated by the first reference signal index set comprises: when a serving cell of the first node is configured with multiple downlink BWPs, the first node performs radio link monitoring (RLM) on an active BWP employing reference signal resources indicated by at least partial reference signal indexes of the first reference signal index set.

In one subembodiment of the embodiment, the first node measures the reference signal resources indicated by all reference signal indexes of the first reference signal index set.

In one subembodiment of the embodiment, the first node measures the reference signal resources indicated by all reference signal indexes belonging to a same BWP in the first reference signal index set.

In one subembodiment of the embodiment, the first node measures the reference signal resources indicated by all reference signal indexes belonging to a same cell in the first reference signal index set.

In one subembodiment of the embodiment, the first node measures the reference signal resources indicated by all reference signal indexes associated with a same PCI in the first reference signal index set.

In one subembodiment of the embodiment, the at least partial reference signal indexes in the first reference signal index set are a reference signal index belonging to an active BWP.

In one subembodiment of the embodiment, the first reference signal index set only comprises a reference signal index of an active BWP.

In one embodiment, the meaning of the phrase of assessing first-type radio link quality according to at least partial reference signal resources indicated by the first reference signal index set comprises: when there is no reference signal index provided for radio link monitoring on an active BWP, the first node adopts reference signal resources belonging to reference signal resources provided by or associated with an activated TCI state in Control Resource Sets (CORESETs) receiving a PDCCH on an active BWP in reference signal resources corresponding to at least partial reference signal indexes of the first reference signal index set for executing radio link monitoring.

In one subembodiment of the embodiment, the first message comprises reference signal resources provided by or associated with an activate TCI state in the CORESETs.

In one embodiment, the meaning of the phrase of assessing first-type radio link quality according to at least partial reference signal resources indicated by the first reference signal index set comprises: in non-DRX mode operation, the physical layer of the first node assesses quality of radio link every assessment cycle, assesses a threshold configured violating rlmInSyncOutOfSyncThreshold in a past time cycle, and the first node determines that an assessment cycle is a maximum value between a shortest periodic radio link monitoring resources and 10 milliseconds.

In one subembodiment of the above embodiment, a serving cell of the first node indicates the rlmInSyncOutOfSyncThreshold.

In one subembodiment of the above embodiment, the first node determines the rlmInSyncOutOfSyncThreshold according to an internal algorithm.

In one subembodiment of the embodiment, the rlmInSyncOutOfSyncThreshold is used to indicate the first threshold.

In one subembodiment of the embodiment, the rlmInSyncOutOfSyncThreshold is used to determine the first threshold.

In one subembodiment of the embodiment, a serving cell of the first node indicates the assessment cycle.

In one subembodiment of the embodiment, the first threshold is Qout.

In one embodiment, the meaning of the phrase of assessing first-type radio link quality according to at least partial reference signal resources indicated by the first reference signal index set comprises: in Discontinuous Reception (DRX) mode operation, a physical layer of the first node assesses a radio connection quality every assessment cycle, assesses a threshold configured violating rlmInSyncOutOfSyncThreshold in a past time cycle, and the first node determines that the assessment cycle is a maximum value between a shortest periodic radio link monitoring resource and a DRX cycle.

In one subembodiment of the above embodiment, a serving cell of the first node indicates the rlmInSyncOutOfSyncThreshold.

In one subembodiment of the above embodiment, the first node determines the rlmInSyncOutOfSyncThreshold according to an internal algorithm.

In one subembodiment of the embodiment, the rlmInSyncOutOfSyncThreshold is used to indicate the first threshold.

In one subembodiment of the embodiment, the rlmInSyncOutOfSyncThreshold is used to determine the first threshold.

In one subembodiment of the embodiment, a serving cell of the first node indicates the assessment cycle.

In one subembodiment of the embodiment, the first threshold is Qout.

In one embodiment, the meaning of the phrase of assessing first-type radio link quality according to at least partial reference signal resources indicated by the first reference signal index set comprises: when radio link quality of all reference signal resources used for radio link monitoring is worse than the first threshold, the physical layer of the first node indicates “out-of-sync” to the higher layer in frames where radio link quality is evaluated; when radio link quality of any of reference signal resource used for radio link monitoring is better than a Qin threshold, a physical layer of the first node indicates “in-sync” to a higher layer in those frames where radio link quality is evaluated.

In one subembodiment of the embodiment, the first node measures reference signal resources used for radio link monitoring to obtain the first-type radio link quality.

In one subembodiment of the embodiment, when a number of “out-of-sync” indicated to a higher layer reaches Q1, the first node starts the first timer, for example, the first timer is T310, and an expiration of the first timer determines RLF.

In one subembodiment of the embodiment, the first reference signal index set indicates at least partial reference signal resources in reference signal resources used for radio link monitoring.

In one subembodiment of the embodiment, the first reference signal index set indicates all reference signal resources in reference signal resources used for radio link monitoring.

In one subembodiment of the embodiment, the first reference signal index set indicates a reference signal index of reference signal resources in reference signal resources used for radio link monitoring.

In one subembodiment of the above embodiment, the first node determines the first threshold and the Qin threshold based on an internal algorithm.

In one subembodiment of the above embodiment, a serving cell of the first node indicates the first threshold and the Qin threshold.

In one subembodiment of the above embodiment, the first-type indication is “out-of-sync”.

In one subembodiment of the above embodiment, the third-type indication is “in-sync”.

In one embodiment, the meaning of the phrase of assessing first-type radio link quality according to at least partial reference signal resources indicated by the first reference signal index set comprises: when radio link quality of all reference signal resources used for radio link monitoring is worse than the first threshold, the physical layer of the first node indicates “out-of-sync” to the higher layer in frames where radio link quality is evaluated; when radio link quality of any of reference signal resource used for radio link monitoring is better than a Qin threshold, a physical layer of the first node indicates “in-sync” to a higher layer in those frames where radio link quality is evaluated.

In one subembodiment of the embodiment, the first node measures reference signal resources used for radio link monitoring to obtain the first-type radio link quality.

In one subembodiment of the embodiment, when a number of continuous “out-of-sync” indicated to a higher layer reaches Q1, the first node starts the first timer, for example, the first timer is T310, and an expiration of the first timer determines the RLF.

In one subembodiment of the embodiment, when a number of continuous “out-of-sync” indicated to a higher layer reaches Q1, where the Q1 is configured by a serving cell of the first node, the first node starts the first timer, for example, a first timer is T310, and an expiration of the first timer determines the RLF; when continuous “in-sync” received by the higher layer reaches Q3, where Q3 is configured by a serving cell of the first node, and the continuous first-type indications are counted again.

In one subembodiment of the embodiment, the first reference signal index set indicates at least partial reference signal resources in reference signal resources used for radio link monitoring.

In one subembodiment of the embodiment, the first reference signal index set indicates all reference signal resources in reference signal resources used for radio link monitoring.

In one subembodiment of the embodiment, the first reference signal index set indicates a reference signal index of reference signal resources in reference signal resources used for radio link monitoring.

In one subembodiment of the above embodiment, an expiration of the first timer triggers the RLF.

In one embodiment, the meaning of the phrase of assessing first-type radio link quality according to at least partial reference signal resources indicated by the first reference signal index set comprises: evaluating the first-type radio link quality based on reference signal resources identified by a reference signal index belonging to an active BWP comprised in the first reference signal index set.

In one embodiment, the meaning of the phrase of assessing first-type radio link quality according to at least partial reference signal resources indicated by the first reference signal index set comprises: evaluating the first-type radio link quality based on reference signal resources identified by all reference signal indexes comprised in the first reference signal index set.

In one embodiment, the meaning of the phrase of assessing first-type radio link quality according to at least partial reference signal resources indicated by the first reference signal index set comprises: evaluating the first-type radio link quality based on reference signal resources identified by each reference signal index comprised in the first reference signal index set.

In one embodiment, the meaning of the phrase of assessing first-type radio link quality according to at least partial reference signal resources indicated by the first reference signal index set comprises: evaluating the first-type radio link quality based on reference signal resources identified by all reference signal indexes comprised in the first reference signal index set.

In one embodiment, the meaning of the phrase of assessing first-type radio link quality according to at least partial reference signal resources indicated by the first reference signal index set comprises: evaluating the first-type radio link quality based on reference signal resources identified by partial reference signal indexes comprised in the first reference signal index set.

In one embodiment, the meaning of the phrase of assessing first-type radio link quality according to at least partial reference signal resources indicated by the first reference signal index set comprises: evaluating the first-type radio link quality based on reference signal resources identified by N_{RLM} reference signal index(es) comprised in the first reference signal index set.

In one subembodiment of the embodiment, a value of the N_{RLM} is one of 2, 4 and 8.

In one subembodiment of the embodiment, a value of the N_{RLM} is obtained through network configuration.

In one subembodiment of the embodiment, a value of N_{RLM} is determined by an index of a candidate SS/PBCH block during the cell search process.

In one embodiment, the meaning of the phrase of assessing first-type radio link quality according to at least partial reference signal resources indicated by the first reference signal index set comprises: measuring reference signal resources identified by any reference signal index in the first reference signal index set, so as to determine whether radio link quality of reference signal resources indicated by all reference signal indexes in the first reference signal index set is worse than the first threshold.

In one subembodiment of the embodiment, when radio link quality of reference signal resources indicated by all reference signal indexes in the first reference signal index set is worse than the first threshold, a physical layer of the first node reports a first-type indication to a higher layer of the first node.

In one subembodiment of the embodiment, the behavior of measuring reference signal resources identified by any reference signal index in the first reference signal index set is used to determine the first-type radio link quality.

In one subembodiment of the embodiment, the first-type radio link quality is a measurement result for reference signal resources identified by any reference signal index in the first reference signal index set.

In one subembodiment of the embodiment, the measurement result comprises one of RSRP, RSRQ and SINR.

In one subembodiment of the embodiment, the first-type radio link quality is best one of measurement results for reference signal resources identified by any reference signal index in the first reference signal index set.

In one embodiment, the meaning of the phrase of assessing second-type radio link quality according to at least partial reference signal resources indicated by the second reference signal index set comprises: assessing the second-type radio link quality according to reference signal resources belonging to an active BWP identified by a reference signal index in the second reference signal index set.

In one embodiment, the meaning of the phrase of assessing second-type radio link quality according to at least partial reference signal resources indicated by the second reference signal index set comprises: assessing the second-type radio link quality according to reference signal resources identified by all reference signal indexes in the second reference signal index set.

In one embodiment, the meaning of the phrase of assessing second-type radio link quality according to at least partial reference signal resources indicated by the second reference signal index set comprises: assessing the second-type radio link quality according to reference signal resources identified by partial reference signal indexes in the second reference signal index set.

In one embodiment, the meaning of the phrase of assessing second-type radio link quality according to at least partial reference signal resources indicated by the second reference signal index set comprises: assessing the second-type radio link quality according to reference signal resources identified by all reference signal indexes in the second reference signal index set.

In one embodiment, the meaning of the phrase of assessing second-type radio link quality according to at least partial reference signal resources indicated by the second reference signal index set comprises: assessing the second-type radio link quality according to reference signal resources identified by each reference signal index in the second reference signal index set.

In one embodiment, the meaning of the phrase of assessing second-type radio link quality according to at least partial reference signal resources indicated by the second reference signal index set comprises: assessing the second-type radio link quality according to reference signal resources identified by partial reference signal indexes in the second reference signal index set.

In one embodiment, the meaning of the phrase of assessing second-type radio link quality according to at least partial reference signal resources indicated by the second reference signal index set comprises: evaluating the second-type radio link quality based on reference signal resources identified by N_{RLM} reference signal index(es) comprised in the second reference signal index set.

In one subembodiment of the embodiment, a value of the N_{RLM} is one of 2, 4 and 8.

In one subembodiment of the embodiment, a value of the N_{RLM} is obtained through network configuration.

In one subembodiment of the embodiment, a value of N_{RLM} is determined by an index of a candidate SS/PBCH block during the cell search process.

In one embodiment, the meaning of the phrase of assessing second-type radio link quality according to at least partial reference signal resources indicated by the second reference signal index set comprises: measuring reference signal resources identified by any reference signal index in the second reference signal index set, so as to determine whether radio link quality of reference signal resources indicated by all reference signal indexes in the second reference signal index set is worse than the second threshold.

In one subembodiment of the embodiment, when radio link quality of reference signal resources indicated by all reference signal indexes in the second reference signal index set is worse than the second threshold, a physical layer of the first node reports a second-type indication to a higher layer of the first node.

In one subembodiment of the embodiment, the behavior of measuring reference signal resources identified by any reference signal index in the second reference signal index set is used to determine the second-type radio link quality.

In one subembodiment of the embodiment, the second-type radio link quality is a measurement result for reference signal resources identified by any reference signal index in the second reference signal index set.

In one subembodiment of the embodiment, the measurement result comprises one of RSRP, RSRQ and SINR.

In one subembodiment of the embodiment, the second-type radio link quality is best one of measurement results for reference signal resources identified by any reference signal index in the second reference signal index set.

In one subembodiment of the embodiment, the second-type radio link quality is a best one among all measurement results of reference signal resources identified by all reference signal indexes in the second reference signal index set.

In one embodiment, the meaning of the phrase of assessing first-type radio link quality according to at least partial reference signal resources indicated by the first reference signal index set comprises: executing radio link monitoring on a reference signal index comprised in the first reference signal index set.

In one embodiment, the meaning of the phrase of assessing second-type radio link quality according to at least partial reference signal resources indicated by the second reference signal index set comprises: executing radio link monitoring on a reference signal index comprised in the second reference signal index set.

In one embodiment, the meaning of the phrase of assessing second-type radio link quality according to at least partial reference signal resources indicated by the second reference signal index set comprises: when a serving cell of the first node is configured with multiple downlink BWPs, the first node adopts reference signal resources indicated by at least partial reference signal indexes in the second reference signal index set on an active BWP to execute radio link monitoring (RLM).

In one subembodiment of the embodiment, the first node measures the reference signal resources indicated by all reference signal indexes in the second reference signal index set.

In one subembodiment of the embodiment, the first node measures the reference signal resources indicated by all reference signal indexes belonging to a same BWP in the second reference signal index set.

In one subembodiment of the embodiment, the first node measures the reference signal resources indicated by all reference signal indexes belonging to a same cell in the second reference signal index set.

In one subembodiment of the embodiment, the first node measures the reference signal resources indicated by all reference signal indexes associated with a same PCI in the second reference signal index set.

In one embodiment, the meaning of the phrase of assessing second-type radio link quality according to at least partial reference signal resources indicated by the second reference signal index set comprises: when there is no reference signal index provided for radio link monitoring on an active BWP, the first node adopts reference signal resources belonging to reference signal resources provided by or associated with an activated TCI state in CORESETs receiving a PDCCH on an active BWP in reference signal resources corresponding to at least partial reference signal indexes of the second reference signal index set for executing radio link monitoring.

In one subembodiment of the embodiment, the first message comprises reference signal resources provided by or associated with an activate TCI state in the CORESETs.

In one embodiment, the meaning of the phrase of assessing second-type radio link quality according to at least partial reference signal resources indicated by the second reference signal index set comprises: in non-DRX mode operation, the physical layer of the first node assesses quality of radio link every assessment cycle, assesses whether it violates a threshold configured by rlmInSyncOutOfSyncThreshold in past assessment cycles, and the assessment cycle determined by the first node is a maximum value between a shortest periodic radio link monitoring resource and 10 milliseconds.

In one embodiment, the meaning of the phrase of assessing second-type radio link quality according to at least partial reference signal resources indicated by the second reference signal index set comprises: when a serving cell of the first node is configured with multiple downlink BWPs, the first node performs a measurement on an active BWP employing reference signal resources indicated by at least partial reference signal indexes in the second reference signal index set.

In one subembodiment of the embodiment, the first node measures the reference signal resources indicated by all reference signal indexes in the second reference signal index set.

In one subembodiment of the embodiment, the first node measures the reference signal resources indicated by all reference signal indexes belonging to a same BWP in the second reference signal index set.

In one subembodiment of the embodiment, the first node measures the reference signal resources indicated by all reference signal indexes belonging to a same cell in the second reference signal index set.

In one subembodiment of the embodiment, the first node measures the reference signal resources indicated by all reference signal indexes associated with a same PCI in the second reference signal index set.

In one embodiment, the meaning of the phrase of assessing second-type radio link quality according to at least partial reference signal resources indicated by the second reference signal index set comprises: when there is no reference signal index provided for radio link monitoring on an active BWP, the first node adopts reference signal resources belonging to reference signal resources provided by or associated with an activated TCI state in CORESETs receiving a PDCCH on an active BWP in reference signal resources corresponding to at least partial reference signal indexes of the second reference signal index set for executing a measurement.

In one subembodiment of the embodiment, the first message comprises reference signal resources provided by or associated with an activate TCI state in the CORESETs.

In one embodiment, the meaning of the phrase of assessing second-type radio link quality according to at least partial reference signal resources indicated by the second reference signal index set comprises: in non-DRX mode operation, the physical layer of the first node assesses quality of radio link every assessment cycle, assesses whether it violates a threshold configured by rlmInSyncOutOfSyncThreshold in past assessment cycles, and the assessment cycle determined by the first node is a maximum value between a shortest periodic radio link monitoring resource and 10 milliseconds.

In one subembodiment of the embodiment, the rlmInSyncOutOfSyncThreshold is indicated by a serving cell of the first node.

In one embodiment, the behavior of detecting RLF comprises: if RLF is detected in a PSCell, it is considered that the RLF is detected for SCG (secondary cell group), if an MCG (master cell group) is not suspended, the SCG failure information process is initiated to report the SCG failure information, and if an MCG is suspended, the connection reconstruction process is initiated.

In one embodiment, the behavior of detecting RLF comprises: storing RLF information in a first link failure variable; if timer T316 is configured and SCG transmission is not suspended and PSCell changes and additions are not in progress, the MCG failure message process is initiated to report MCG RLF, otherwise, the connection reconstruction process is initiated.

In one subembodiment of the above embodiment, the first link failure variable is VarRLF-Report.

In one embodiment, the behavior of detecting RLF comprises: storing RLF information in a first link failure variable; if timer T316 is not configured or SCG transmission is suspended or a PSCell change is in progress or a PSCell addition is in progress, the connection re-establishment process is initiated.

In one subembodiment of the above embodiment, the first link failure variable is VarRLF-Report.

In one embodiment, the meaning of the phrase of at least one reference signal index in the first reference signal index set being associated with a first PCI comprises: the first PCI is used to generate at least one reference signal index comprised in the first reference signal index set.

In one embodiment, the meaning of the phrase of at least one reference signal index in the first reference signal index set being associated with a first PCI comprises: the first PCI is used to generate a reference signal identified by at least one reference signal index comprised in the first reference signal index set.

In one embodiment, the meaning of the phrase of at least one reference signal index in the first reference signal index set being associated with a first PCI comprises: the first reference signal index set comprises at least one reference signal index, and a reference signal identified by the at least one reference signal index and an SSB of a physical cell determined by the first PCI are Quasi Co-Location/Quasi Co-Located (QCL).

In one embodiment, the meaning of the phrase of at least one reference signal index in the first reference signal index set being associated with a first PCI comprises: the first reference signal index set comprises at least one reference signal index, and a reference signal identified by the at least one reference signal index is transmitted by a cell identified by the first PCI.

In one embodiment, the meaning of the phrase of at least one reference signal index in the first reference signal index set being associated with a first PCI comprises: the first reference signal index set comprises at least one reference signal index, radio resources occupied by a reference signal identified by the at least one reference signal index are indicated by a configuration signaling, an RLC bearer to which the configuration signaling is conveyed is configured through a CellGroupConfig IE, and a Special Cell (SpCell) configured by the CellGroupConfig IE comprises the first PCI.

In one embodiment, the meaning of the phrase of at least one reference signal index in the first reference signal index set being associated with a first PCI comprises: the first reference signal index set comprises at least one reference signal index, radio resources occupied by a reference signal identified by the at least one reference signal index are indicated by a configuration signaling, an RLC bearer to which the configuration signaling is conveyed is configured through a CellGroupConfig cell, and an SpCell configured by the CellGroupConfig cell comprises the first PCI.

In one embodiment, the meaning of the phrase that at least one reference signal index in the first reference signal index set is associated with a second PCI comprises: the second PCI is used to generate at least one reference signal index comprised in the first reference signal index set.

In one embodiment, the meaning of the phrase that at least one reference signal index in the first reference signal index set is associated with a second PCI comprises: the second PCI is used to generate a reference signal identified by at least one reference signal index comprised in the first reference signal index set.

In one embodiment, the meaning of the phrase that at least one reference signal index in the first reference signal index set is associated with a second PCI comprises: the first reference signal index set comprises at least one reference signal index, and a reference signal identified by the at least one reference signal index and an SSB of a physical cell determined by the second PCI are Quasi Co-Location/Quasi Co-Located (QCL).

In one embodiment, the meaning of the phrase that at least one reference signal index in the first reference signal index set is associated with a second PCI comprises: the first reference signal index set comprises at least one reference signal index, and a reference signal identified by the at least one reference signal index is transmitted by a cell identified by the second PCI.

In one embodiment, the meaning of the phrase that at least one reference signal index in the first reference signal index set is associated with a second PCI comprises: the first reference signal index set comprises at least one reference signal index, radio resources occupied by a reference signal identified by the at least one reference signal index are indicated by a configuration signaling, an RLC bearer to which the configuration signaling is conveyed is configured through a CellGroupConfig IE, and an SpCell configured by the CellGroupConfig IE comprises the second PCI.

In one embodiment, the meaning of the phrase that at least one reference signal index in the first reference signal index set is associated with a second PCI comprises: the first reference signal index set comprises at least one reference signal index, radio resources occupied by a reference signal identified by the at least one reference signal index are indicated by a configuration signaling, an RLC bearer to which the configuration signaling is conveyed is configured through a CellGroupConfig cell, and an SpCell configured by the CellGroupConfig cell comprises the second PCI.

In one embodiment, the meaning of the phrase that any reference signal index in the second reference signal index set is associated with the first PCI comprises: the first PCI is used to generate any reference signal index comprised in the second reference signal index set.

In one embodiment, the meaning of the phrase that any reference signal index in the second reference signal index set is associated with the first PCI comprises: the first PCI is used to generate a reference signal identified by any reference signal index comprised in the second reference signal index set.

In one embodiment, the meaning of the phrase that any reference signal index in the second reference signal index set is associated with the first PCI comprises: a reference signal identified by any reference signal index comprised in the second reference signal index set and an SSB of a physical cell determined by the first PCI are QCL.

In one embodiment, the meaning of the phrase that any reference signal index in the second reference signal index set is associated with the first PCI comprises: a reference signal identified by any reference signal index comprised in the second reference signal index set is transmitted by a cell identified by the first PCI.

In one embodiment, the meaning of the phrase that any reference signal index in the second reference signal index set is associated with the first PCI comprises: radio resources occupied by a reference signal identified by any reference signal index comprised in the second reference signal index set are indicated by a configuration signaling, an RLC bearer to which the configuration signaling is conveyed is configured through a CellGroupConfig IE, and an SpCell configured by the CellGroupConfig IE comprises the first PCI.

In one embodiment, the meaning of the phrase that any reference signal index in the second reference signal index set is associated with the first PCI comprises: radio resources occupied by a reference signal identified by any reference signal index comprised in the second reference signal index set are indicated by a configuration signaling, an RLC bearer to which the configuration signaling is conveyed is configured through a CellGroupConfig cell, and an SpCell configured by the CellGroupConfig cell comprises the first PCI.

In one embodiment, the first node assesses third-type radio link quality according to at least partial reference signal resources indicated by the second reference signal index set; whenever the evaluated third-type radio link quality is better than a third threshold, a physical layer of the first node reporting a third-type indication to a higher layer of the first node.

In one embodiment, the meaning of the phrase of “assessing third-type radio link quality according to at least partial reference signal resources indicated by the second reference signal index set” comprises: the first node assesses third-type radio link quality according to reference signal resources identified by any reference signal index comprised in the second reference signal index set.

In one embodiment, the meaning of the phrase of “assessing third-type radio link quality according to at least partial reference signal resources indicated by the second reference signal index set” comprises: the first node assesses third-type radio link quality according to reference signal resources identified by each reference signal index comprised in the second reference signal index set.

In one embodiment, the meaning of the phrase of “assessing third-type radio link quality according to at least partial reference signal resources indicated by the second reference signal index set” comprises: the first node assesses third-type radio link quality according to reference signal resources identified by partial reference signal indexes comprised in the second reference signal index set.

In one embodiment, the meaning of the phrase of “continuously receiving Q2 the second-type indication(s)” is not receiving the third-type indication in the procedure of continuously receiving the Q2 second-type indication(s).

In one embodiment, the third-type indication comprises “in-sync”.

In one embodiment, the third-type indication is used to indicate that the third-type radio link quality is better than the third threshold.

In one embodiment, the third-type radio link quality is radio link quality of any reference signal resource in the reference signal resources indicated by the second reference signal index set.

In one embodiment, the third-type radio link quality is a worst one of radio link quality of reference signal resources in the reference signal resources indicated by the second reference signal index set.

In one embodiment, the third-type radio link quality is a worst one of radio link quality of reference signal resources participating in an assessment in reference signal resources indicated by the second reference signal index set.

In one embodiment, the radio link quality comprises an RSRP value.

In one embodiment, the radio link quality comprises an RSRQ value.

In one embodiment, the radio link quality comprises an SINR value.

In one embodiment, the meaning of the phrase of “evaluating second-type radio link quality according to at least partial reference signal resources indicated by the second reference signal index set” comprises that the first node measures the reference signal resources indicated by the second reference signal index set, and a measurement result of the behavior of measuring is used to generate the third-type radio link quality.

In one embodiment, the meaning of the phrase of “evaluating second-type radio link quality according to at least partial reference signal resources indicated by the second reference signal index set” comprises that the first node measures the reference signal resources indicated by the second reference signal index set, and a worst one of measurement results of the behavior of measuring is the third-type radio link quality.

In one embodiment, the meaning of the phrase of “evaluating second-type radio link quality according to at least partial reference signal resources indicated by the second reference signal index set” comprises that the first node measures the reference signal resources indicated by the second reference signal index set, and any worst one of measurement results of the behavior of measuring is the third-type radio link quality.

In one embodiment, a serving cell of the first node indicates the first threshold.

In one embodiment, the third threshold is determined by reception quality of a PDCCH channel.

In one subembodiment of the above embodiment, reception quality of the PDCCH channel refers to BLER equal to 1%.

In one subembodiment of the above embodiment, reception quality of the PDCCH channel refers to BLER not greater than 1%.

In one subembodiment of the above embodiment, a measurement result on reference signal resources when reception quality of the PDCCH channel is BLER equal to 1% is the third threshold.

In one embodiment, the higher layer of the first node continuously receiving the Q3 third-type indication(s) is used to stop the second timer.

In one embodiment, Q3 is configured by a serving cell of the first node.

In one embodiment, Q3 is a positive integer.

In one embodiment, Q3 is equal to the Q2.

In one embodiment, Q3 is not equal to the Q2, and the Q3 is independent from the Q2.

In one embodiment, the meaning of the phrase of “continuously receiving the Q3 third-type indication(s)” is the second-type indication is not received during the procedure of receiving the Q3 third-type indication(s).

In one embodiment, the first node assesses fourth-type radio link quality according to the reference signal resources indicated by the first reference signal index set, whenever evaluated the fourth-type radio link quality is better than a fourth threshold, a physical layer of the first node reports a fourth-type indication to a higher layer of the first node.

In one subembodiment of the embodiment, the meaning of the phrase of assessing fourth-type radio link quality according to the reference signal resources indicated by the first reference signal index set is: the first node assessing fourth-type radio link quality according to reference signal resources identified by any reference signal index comprised in the first reference signal index set.

In one subembodiment of the embodiment, the meaning of the phrase of assessing fourth-type radio link quality according to the reference signal resources indicated by the first reference signal index set is: the first node assessing fourth-type radio link quality according to reference signal resources identified by each reference signal index comprised in the first reference signal index set.

In one subembodiment of the embodiment, the meaning of the phrase of assessing fourth-type radio link quality according to the reference signal resources indicated by the first reference signal index set is: the first node assessing fourth-type radio link quality according to reference signal resources identified by partial reference signal indexes comprised in the first reference signal index set.

In one embodiment, the meaning of the phrase of continuously receiving Q1 first-type indication(s) is not receiving the fourth-type indication in the procedure of continuously receiving Q1 first-type indication(s).

In one embodiment, the fourth-type indication comprises “in-sync”.

In one embodiment, the fourth-type indication is used to indicate that the fourth-type radio link quality is better than the fourth threshold.

In one embodiment, the fourth-type radio link quality is radio link quality of any reference signal resource in the reference signal resources indicated by the first reference signal index set.

In one embodiment, the fourth-type radio link quality is a worst one of radio link quality of reference signal resources in the reference signal resources indicated by the first reference signal index set.

In one embodiment, the fourth-type radio link quality is a worst one of radio link quality of reference signal resources participating in an assessment in reference signal resources indicated by the first reference signal index set.

In one embodiment, the radio link quality comprises an RSRP value.

In one embodiment, the radio link quality comprises an RSRQ value.

In one embodiment, the radio link quality comprises an SINR value.

In one embodiment, the meaning of the phrase of assessing fourth-type radio link quality according to the reference signal resources indicated by the first reference signal index set comprises that the first node measures the reference signal resources indicated by the first reference signal index set, and a measurement result of the behavior of measuring is used to generate the fourth-type radio link quality.

In one embodiment, the meaning of the phrase of assessing fourth-type radio link quality based on reference signal resources indicated by the first reference signal index set comprises that the first node measures the reference signal resources indicated by the first reference signal index set, and a worst one of measurement results of the behavior of measuring is the fourth-type radio link quality.

In one embodiment, the meaning of the phrase of assessing fourth-type radio link quality based on reference signal resources indicated by the first reference signal index set comprises that the first node measures the reference signal resources indicated by the first reference signal index set, and any worst one of measurement results of the behavior of measuring is the fourth-type radio link quality.

In one embodiment, a serving cell of the first node indicates the fourth threshold.

In one embodiment, the fourth threshold is determined by reception quality of a PDCCH channel.

In one subembodiment of the above embodiment, reception quality of the PDCCH channel refers to BLER equal to 1%.

In one subembodiment of the above embodiment, reception quality of the PDCCH channel refers to BLER not greater than 1%.

In one subembodiment of the above embodiment, a measurement result on reference signal resources with reception quality of BLER equal to 1% for the PDCCH channel is the fourth threshold.

In one embodiment, the higher layer of the first node continuously receiving the Q4 third-type indication(s) is used to stop the first timer.

In one embodiment, Q4 is configured by a serving cell of the first node.

In one embodiment, Q4 is a positive integer.

In one embodiment, Q4 is equal to the Q1.

In one embodiment, Q4 is not equal to the Q1, and the Q4 is independent from the Q1.

In one embodiment, Q4 is equal to the Q3.

In one embodiment, the meaning of the phrase of continuously receiving Q4 fourth-type indication(s) is, the first-type indication is not received during the process of receiving Q4 fourth-type indication(s).

In one embodiment, the behavior of transmitting a link observation record comprises transmitting a second message, and the second message is used to indicate the link observation record; whether a transmission of the second message and the second condition set being satisfied occur in a same RRC connection procedure is related to a configuration method of the second reference signal index set.

In one embodiment, the second message is an RRC message.

In one embodiment, the second message comprises UEInformationResponse.

In one embodiment, the second message is UEInformationResponse.

In one embodiment, the second message comprises UEAssistanceInformation.

In one embodiment, the second message comprises a MAC CE.

In one embodiment, the second message comprises UCI.

In one embodiment, a physical channel occupied by the second message comprises a physical uplink control channel (PUCCH).

In one embodiment, a physical channel occupied by the second message comprises a Physical Uplink Shared Channel (PUSCH).

In one embodiment, configuration methods of the second reference signal index set comprise: configuring through system messages, configuring through measObjNR, configuring through radiolinkmonitoringconfig, and configuring through CSI-ReportConfig.

In one embodiment, when a configuration method of the second reference signal index set is configuring through a system message, a transmission of the second message and the second condition set being satisfied occur in different RRC connection procedures.

In one embodiment, when a configuration method of the second reference signal index set is configuring through a radiolinkmonitoringconfig cell, a transmission of the second message and the second condition set being satisfied occur during different RRC connection procedures.

In one embodiment, when a configuration method of the second reference signal index set is configuring through measObjNR, a transmission of the second message and the second condition set being satisfied occur in a same RRC connection procedure.

In one embodiment, when a configuration method of the second reference signal index set is configuring through CSI-ReportConfig, a transmission of the second message and the second condition set being satisfied occur in a same RRC connection procedure.

In one embodiment, the phrase of “occurring in different RRC connection procedures” means, a transmission of the second message is in a next RRC connection procedure, and the second condition set being satisfied occurs in a current RRC access procedure.

In one embodiment, the phrase of “occurring in a same RRC connection procedure” means, RRC state of the first node does not change between the second condition set being satisfied and a transmission of the second message.

In one embodiment, the phrase of “occurring in a same RRC connection procedure” means, the first node is always in RRC_CONNECTED state between the second condition set being satisfied and a transmission of the second message.

In one embodiment, the phrase of “occurring in a same RRC connection procedure” means, the first node does not receive RRCRelease between the second condition set being satisfied and a transmission of the second message.

In one embodiment, when a transmission of the second message and the second condition set being satisfied occur in different RRC connection procedures, the second message is an RRC message.

In one embodiment, when a transmission of the second message and the second condition set being satisfied occur in a same RRC connection procedure, the second message is a MAC CE.

In one embodiment, when a transmission of the second message and the second condition set being satisfied occur in a same RRC connection procedure, the second message is uplink control information (UCI).

In one embodiment, the behavior of transmitting a link observation record comprises transmitting a second message, and the second message indicates the link observation record through indicating a first identity;
herein, the first identity is associated with the first PCI.

In one subembodiment of the embodiment, the first identity is the first PCI.

In one subembodiment of the embodiment, the first identity is an index of the first PCI.

In one subembodiment of the embodiment, the first identity is an index of a configuration associated with the first PCI.

In one subembodiment of the embodiment, the first identity is an index of a configuration of the second reference signal index associated with the first PCI.

In one embodiment, the behavior of executing a first operation comprises storing the link observation record in a first link failure variable;
the first receiver detects RLF; stores information of the RLF in the first link failure variable;
the behavior of storing information of the RLF in the first link failure variable comprises: maintaining the link observation record stored in the first link failure variable; clearing information other than the link observation record stored in the first link failure variable;

In one subembodiment of the embodiment, the first link failure variable comprises VarRLF-Report.

In one subembodiment of the embodiment, the RLF is radio link failure.

In one subembodiment of the embodiment, the first link failure variable comprises the link observation record and the information of the RLF.

In one subembodiment of the embodiment, the phrase of maintaining the link observation record stored in the first link failure variable; clearing information other than the link observation record stored in the first link failure variable comprises: when the information of the RLF is stored in the first link failure variable, not clearing the link observation record.

In one subembodiment of the embodiment, the phrase of maintaining the link observation record stored in the first link failure variable; clearing information other than the link observation record stored in the first link failure variable comprises: when the information of the RLF is stored in the first link failure variable, clearing all contents in the first link failure variable, after storing the information of the RLF in the first link failure variable, re-storing the link observation record in the first link failure variable.

In one subembodiment of the embodiment, PCells of the first node in the behavior of storing the link observation record in a first link failure variable and the behavior of detecting RLF are the same.

In one subembodiment of the embodiment, SpCells of the first node in the behavior of storing the link observation record in a first link failure variable and the behavior detecting RLF are the same.

In one subembodiment of the embodiment, PCells of the first node in the behavior of storing the link observation record in a first link failure variable and the behavior of storing information of the RLF in the first link failure variable are the same.

In one subembodiment of the embodiment, SPCells of the first node in the behavior of storing the link observation record in a first link failure variable and the behavior of storing information of the RLF in the first link failure variable are the same.

In one subembodiment of the embodiment, the link observation record is stored in an entry other than Rlf-Report-R16 in the first link failure variable.

In one subembodiment of the embodiment, the meaning of the phrase of “clearing information other than the link observation record stored in the first link failure variable” is to first clear the previously stored RLF information, and then store the information of the RLF.

In one embodiment, when a PCell change occurs at the first node, a link observation record stored in the first link failure variable is cleared.

In one embodiment, when an SPCell change occurs at the first node, a link observation record stored in the first link failure variable is cleared.

In one embodiment, when a PCell change occurs at the first node, a link observation record stored in the first link failure variable is not cleared.

In one embodiment, when an SPCell change occurs at the first node, a link observation record stored in the first link failure variable is not cleared.

In one embodiment, when a PCell change occurs at the first node, information of RLF stored in the first link failure variable is cleared.

In one embodiment, when an SPCell change occurs at the first node, information of RLF stored in the first link failure variable is cleared.

In one embodiment, the behavior of executing a first operation comprises storing the link observation record in a second link failure variable; the second link failure variable is different from a first link failure variable; the first link failure variable is used to store information about RLF;
the second link failure variable is used to generate a second message;
the behavior of transmitting a link observation record comprises transmitting the second message.

In one subembodiment of the embodiment, the first link failure variable is VarRLF-Report.

In one subembodiment of the embodiment, the second link failure variable is a variable other than VarRLF-Report.

In one subembodiment of the embodiment, the second link failure variable is VarLogMeasReport.

In one subembodiment of the embodiment, the second link failure variable is VarmTRPMeasReport.

In one subembodiment of the embodiment, the second link failure variable is VarPCIMeasReport.

In one subembodiment of the embodiment, the second link failure variable is VarCellMeasReport.

In one subembodiment of the embodiment, the second link failure variable is VarCellFailure-Report.

In one subembodiment of the embodiment, the second link failure variable is VarCellLinkFailure-Report.

In one subembodiment of the embodiment, the second link failure variable is VarPhysicalCellLinkFailure-Report.

In one subembodiment of the embodiment, the second link failure variable is VarPhysicalCellLinkFailure-Report.

In one subembodiment of the embodiment, the second link failure variable is VarPhysiCellLinkFailure-Report.

In one subembodiment of the embodiment, the second link failure variable is VarPhysiCellFailure-Report.

In one subembodiment of the embodiment, the second message comprises a link observation record in the second link failure variable.

In one subembodiment of the embodiment, the second message comprises at least partial information in a link observation record in the second link failure variable.

In one subembodiment of the embodiment, the second link failure variable saves the first PCI.

In one subembodiment of the embodiment, the second message comprises the first PCI or an index of the first PCI.

In one embodiment, the first condition set being satisfied indicates that a triggering condition of an event is satisfied.

In one embodiment, the first condition set being satisfied triggers an event.

In one embodiment, the behavior of transmitting a link observation record comprises failure occurring in transmitting a cell identified by the first PCI.

In one subembodiment of the above embodiment, the failure occurred in a cell identified by the first PCI is link failure.

In one subembodiment of the above embodiment, the failure occurred in a cell identified by the first PCI is RLF.

In one subembodiment of the above embodiment, the failure occurred in a cell identified by the first PCI is connection failure.

In one subembodiment of the above embodiment, the failure occurred in a cell identified by the first PCI is path failure.

In one subembodiment of the above embodiment, the failure occurred in a cell identified by the first PCI is RLF identified by a PCI or only comprising a PCI.

In one subembodiment of the above embodiment, the failure occurred in a cell identified by the first PCI is link failure identified by a PCI or only comprising a PCI.

In one subembodiment of the above embodiment, the failure occurred in a cell identified by the first PCI is path failure identified by a PCI or only comprising a PCI.

In one subembodiment of the above embodiment, the failure occurred in a cell identified by the first PCI is connection failure from a cell identified by a PCI or only comprising a PCI to the first node.

In one subembodiment of the above embodiment, failure occurred in a cell identified by the first PCI is link failure at the physical cell level.

In one subembodiment of the above embodiment, the link observation record is comprised in measResultLastServCell-r16.

In one subembodiment of the above embodiment, the link observation record is comprised in a field other than measResultLastServCell-r16.

### Embodiment 1B

Embodiment 1B illustrates a flowchart of receiving a first message and transmitting a second message according to one embodiment of the present application, as shown in FIG. 1B. In FIG. 1B, each box represents a step. It should be noted particularly that the order in which the boxes are arranged does not imply a chronological sequence of each step respectively marked.

In Embodiment 1B, a first node in the present application receives a first message in step B101; transmits a second message in step B102;
herein, the first message is used to indicate a first radio link monitoring configuration, the first radio link monitoring configuration is used to indicate at least one reference signal index, each reference signal index in the at least one reference signal index indicates a reference signal resource; the first node measures the reference signal resources indicated by at least partial reference signal indexes in at least one reference signal index to determine RLF; the second message comprises a first RLF report;
the first RLF report comprises a first bitmap and a first reference signal index measurement result set; the first reference signal index measurement result set comprises K1 reference signal index(es), K1 being a positive integer; the first bitmap indicates whether any of the K1 reference signal index(es) comprised in the first reference signal index measurement result set belongs to the first radio link monitoring configuration; any reference signal index comprised in the first reference signal index measurement result set is associated with a first PCI;
the first RLF report comprises a second bitmap and a second reference signal index measurement result set;
the second reference signal index measurement result set comprise K2 reference signal index(es), K2 being a positive integer; the second bitmap indicates whether any of the K2 reference signal index(es) comprised in the second reference signal index measurement result set belongs to the first radio link monitoring configuration; any reference signal index comprised in the second reference signal index measurement result set is associated with a second PCI.

In one embodiment, the first node is a User Equipment (UE).

In one embodiment, the first node is a Mobile Station (MS).

In one embodiment, a transmitter of the first message is a serving cell of the first node.

In one embodiment, a transmitter of the first message is a PCell of the first node.

In one embodiment, a transmitter of the first message is an SpCell of the first node.

In one embodiment, the first message is an RRC message.

In one embodiment, the first message comprises and only comprises RRCReconfiguration.

In one embodiment, a first radio link monitoring configuration comprises RadioLinkMonitoringConfig.

In one embodiment, a first radio link monitoring configuration is RadioLinkMonitoringConfig.

In one embodiment, a first radio link monitoring configuration is BeamFailureRecoveryConfig.

In one embodiment, a first radio link monitoring configuration comprises RadioLinkMonitoringRS.

In one embodiment, a first radio link monitoring configuration is RadioLinkMonitoringRS.

In one embodiment, a first radio link monitoring configuration indicates reference signal resources provided by or associated with an activated TCI state in CORESETs used to receive a PDCCH on an activated BWP of the first node.

In one embodiment, the first message indicates an identity of the first radio link monitoring configuration.

In one embodiment, the first message comprises the first radio link monitoring configuration.

In one embodiment, the first bitmap is sbRLMConfigBitmap.

In one embodiment, the second bitmap is sbRLMConfigBitmap.

In one embodiment, the first bitmap is csi-rsRLMConfigBitmap.

In one embodiment, the second bitmap is csi-rsRLMConfigBitmap.

In one embodiment, a length of the first bitmap is 64 bits.

In one embodiment, a length of the first bitmap is 96 bits.

In one embodiment, a length of the first bitmap is related to a type of reference signal resources corresponding to a reference signal index identified in by the first bitmap, and a type of the reference signal resources is one of SSB or CSI-RS.

In one embodiment, any bit in the first bitmap is 0, which is used to identify that a corresponding reference signal index in the K1 reference signal indexes comprised in the first reference signal index measurement result set does not belong to the first radio link monitoring configuration.

In one embodiment, any bit in the first bitmap is 1, which is used to identify that a corresponding reference signal index in the K1 reference signal indexes comprised in the first reference signal index measurement result set belongs to the first radio link monitoring configuration.

In one embodiment, a length of the second bitmap is 64 bits.

In one embodiment, a length of the second bitmap is 96 bits.

In one embodiment, a length of the second bitmap is related to a type of reference signal resources corresponding to a reference signal index identified by the second bitmap, and a type of the reference signal resources is one of SSB or CSI-RS.

In one embodiment, any bit in the second bitmap is 0, which is used to identify that a corresponding reference signal index in the K2 reference signal index(es) comprised in the second reference signal index measurement result set does not belong to the first radio link monitoring configuration.

In one embodiment, any bit in the second bitmap is 1, which is used to identify that a corresponding reference signal index in the K2 reference signal index(es) comprised in the second reference signal index measurement result set belongs to the first radio link monitoring configuration.

In one embodiment, lengths of the first bitmap and the second bitmap are the same.

In one embodiment, lengths of the first bitmap and the second bitmap are different.

In one embodiment, a sum of a length of the first bitmap and a length of the second bitmap is 64 bits.

In one embodiment, a sum of a length of the first bitmap and a length of the second bitmap is 96 bits.

In one embodiment, the first bitmap comprises ssbRLMConfigBitmap.

In one embodiment, the first bitmap comprises csi-rsRLMConfigBitmap.

In one embodiment, the first bitmap is ssbRLMConfigBitmap.

In one embodiment, the first bitmap is csi-rsRLMConfigBitmap.

In one embodiment, the second bitmap comprises ssbRLMConfigBitmap.

In one embodiment, the second bitmap comprises csi-rsRLMConfigBitmap.

In one embodiment, the second bitmap is ssbRLMConfigBitmap.

In one embodiment, the second bitmap is csi-rsRLMConfigBitmap.

In one embodiment, each reference signal index in the at least one reference signal index indicates a reference signal resource, and the reference signal resource is a synchronization signal block or synchronization signal/PBCH block (SSB) or a Channel State Information Reference Signal (CSI-RS).

In one embodiment, each reference signal index in the at least one reference signal index indicates a reference signal resource, and the reference signal resource is an SSB resource or a CSI-RS resource.

In one embodiment, each reference signal index in the at least one reference signal index indicates a reference signal resource, and the reference signal resource is a resource occupied by an SSB resource or a resource occupied by a CSI-RS resource.

In one embodiment, if any of the K1 reference signal indexes comprised in the first reference signal index measurement result set has a same value as one of the at least one reference signal index indicated by the first radio link monitoring configuration, and the any reference signal index in the K1 reference signal indexes comprised in the first reference signal index measurement result set identify same reference signal resources as the reference signal index in the at least one reference signal index indicated by the first radio link monitoring configuration; if any of the K1 reference signal indexes comprised in the first reference signal index measurement result set has different values as one of the at least one reference signal index indicated by the first radio link monitoring configuration, and the any reference signal index in the K1 reference signal indexes comprised in the first reference signal index measurement result set does not identify same reference signal resources as the reference signal index in the at least one reference signal index indicated by the first radio link monitoring configuration.

In one embodiment, if a value of any of the K1 reference signal indexes comprised in the first reference signal index measurement result set and a value of one of the at least one reference signal index indicated by the first radio link monitoring configuration are the same and are associated with a same PCI, and the any reference signal index in the K1 reference signal indexes comprised in the first reference signal index measurement result set identify same reference signal resources as the reference signal index in the at least one reference signal index indicated by the first radio link monitoring configuration; if a value of any of the K1 reference signal indexes comprised in the first reference signal index measurement result set and a value of one of the at least one reference signal index indicated by the first radio link monitoring configuration are different and are associated with different PCIs, the any reference signal index in the K1 reference signal indexes comprised in the first reference signal index measurement result set does not identify same reference signal resources as the reference signal index in the at least one reference signal index indicated by the first radio link monitoring configuration.

In one embodiment, if a value of any of the K2 reference signal index(es) comprised in the second reference signal index measurement result set and a value of one of the at least one reference signal index indicated by the first radio link monitoring configuration are the same, and the any reference signal index in the K2 reference signal index(es) comprised in the second reference signal index measurement result set identify same reference signal resources as the reference signal index in the at least one reference signal index indicated by the first radio link monitoring configuration; if a value of any of the K2 reference signal index(es) comprised in the second reference signal index measurement result set and a value of one of the at least one reference signal index indicated by the first radio link monitoring configuration are different, the any reference signal index in the K2 reference signal index(es) comprised in the second reference signal index measurement result set does not identify same reference signal resources as the reference signal index in the at least one reference signal index indicated by the first radio link monitoring configuration.

In one embodiment, if a value of any of the K2 reference signal index(es) comprised in the second reference signal index measurement result set and a value of one of the at least one reference signal index indicated by the first radio link monitoring configuration are the same and are associated with a same PCI, and the any reference signal index in the K2 reference signal index(es) comprised in the second reference signal index measurement result set identify same reference signal resources as the reference signal index in the at least one reference signal index indicated by the first radio link monitoring configuration; if a value of any of the K2 reference signal index(es) comprised in the second reference signal index measurement result set and a value of one of the at least one reference signal index indicated by the first radio link monitoring configuration are different and are associated with different PCIs, the any reference signal index in the K2 reference signal index(es) comprised in the second reference signal index measurement result set does not identify same reference signal resources as the reference signal index in the at least one reference signal index indicated by the first radio link monitoring configuration.

In one embodiment, reference signal resources identified by any reference signal index in the K1 reference signal indexes comprised in the first reference signal index measurement result set is SSB.

In one embodiment, reference signal resources identified by any reference signal index in the K1 reference signal indexes comprised in the first reference signal index measurement result set is SSB resources or resources occupied by SSB.

In one embodiment, reference signal resources identified by any reference signal index in the K1 reference signal indexes comprised in the first reference signal index measurement result set is a CSI-RS.

In one embodiment, reference signal resources identified by any reference signal index in the K1 reference signal indexes comprised in the first reference signal index measurement result set is CSI-RS resources or resources occupied by CSI-RS.

In one embodiment, reference signal resources identified by any reference signal index in the K2 reference signal index(es) comprised in the second reference signal index measurement result set is SSB.

In one embodiment, reference signal resources identified by any reference signal index in the K2 reference signal index(es) comprised in the second reference signal index measurement result set is SSB resources or resources occupied by SSB.

In one embodiment, reference signal resources identified by any reference signal index in the K2 reference signal index(es) comprised in the second reference signal index measurement result set is a CSI-RS.

In one embodiment, reference signal resources identified by any reference signal index in the K2 reference signal index(es) comprised in the second reference signal index measurement result set is CSI-RS resources or resources occupied by CSI-RS.

In one embodiment, the first PCI is different from the second PCI.

In one embodiment, the first PCI is a Physical Cell Identifier (PCI).

In one embodiment, the first PCI is a PhysCellId.

In one embodiment, the first PCI is a Physical cell ID.

In one embodiment, the first PCI is a physical cell.

In one embodiment, the first PCI is used to generate an SSB identifying a physical cell.

In one embodiment, the first PCI is quasi co-located with an SSB of the identified physical cell.

In one embodiment, the first PCI is a physCellId comprised in the received ServingCellConfigCommon.

In one embodiment, the first PCI is a physCellId comprised in the received spCellConfigCommon.

In one embodiment, the second PCI is a PCI.

In one embodiment, the second PCI is PhysCellId.

In one embodiment, the second PCI is Physical cell ID.

In one embodiment, the second PCI identifies a physical cell.

In one embodiment, the second PCI is used to generate an SSB identifying a physical cell.

In one embodiment, the second PCI is quasi co-located with an SSB of the identified physical cell.

In one embodiment, the second PCI is not indicated by a physCellId comprised in the received ServingCellConfigCommon.

In one embodiment, the first PCI is not a physCellId comprised in the received spCellConfigCommon.

In one embodiment, the second PCI is not indicated by the received ServingCellConfigCommon.

In one embodiment, the first PCI is not indicated by the received spCellConfigCommon.

In one embodiment, the first node determines that RLF information is stored in a first RLF variable through measuring the reference signal resources indicated by at least partial reference signal indexes in the at least one reference signal index.

In one embodiment, the first node determines that RLF information is stored in VarRLF-Report through measuring the reference signal resources indicated by at least partial reference signal indexes in the at least one reference signal index.

In one embodiment, the first radio link detection configuration comprises a first monitoring reference signal index set, and a reference signal determined by any reference signal index in the first monitoring reference signal index set belongs to the first monitoring reference signal set; an index of any reference signal comprised in a first monitoring reference signal set belongs to the first monitoring reference signal index set.

In one embodiment, a reference signal comprised in the first monitoring reference signal set is an SSB.

In one embodiment, a reference signal comprised in the first monitoring reference signal set is a CSI-RS.

In one embodiment, the first radio link detection configuration comprises a first monitoring reference signal index set, and reference signal resources determined by any reference signal index in the first monitoring reference signal index set belongs to the first monitoring reference signal resource set; a reference signal index corresponding to any reference signal resource comprised in a first monitoring reference signal resource set belongs to the first monitoring reference signal index set.

In one embodiment, reference signal resources comprised in the first monitoring reference signal resource set are an SSB.

In one embodiment, reference signal resources comprised in the first monitoring reference signal resource set are a CSI-RS.

In one embodiment, each reference signal index in the at least one reference signal index indicates that a reference signal resource is detectionResource.

In one embodiment, each reference signal index in the at least one reference signal index indicates that a reference signal resource is SSB-index.

In one embodiment, each reference signal index in the at least one reference signal index indicates that resources corresponding to or identified by or determined by SSB-index.

In one embodiment, each reference signal index in the at least one reference signal index indicates that a reference signal resource is csi-rs-index.

In one embodiment, each reference signal index in the at least one reference signal index indicates that a reference signal resource is a resource corresponding to or identified by or determined by csi-rs-index.

In one embodiment, each reference signal index in the at least one reference signal index indicates that a reference signal resource is a resource corresponding to or identified by or determined by csi-rs-index.

In one subembodiment of the embodiment, the csi-rs-index indicates a NZP-CSI-RS-ResourceId.

In one subembodiment of the embodiment, the first radio link monitoring configuration indicates the csi-rs-index through indicating NZP-CSI-RS-ResourceId.

In one embodiment, any reference signal index in the at least one reference signal index is a non-negative integer.

In one embodiment, any reference signal index in the at least one reference signal index is a structure.

In one embodiment, any reference signal index in the at least one reference signal index is a structure comprising a non-negative integer.

In one embodiment, any reference signal index in the at least one reference signal index comprises a structure of a PCI and SSB-index.

In one embodiment, any reference signal index in the at least one reference signal index comprises a structure of a PCI and csi-rs-index.

In one embodiment, any reference signal index in the at least one reference signal index comprises SSB-index.

In one embodiment, any reference signal index in the at least one reference signal index comprises csi-rs-index.

In one embodiment, any reference signal index in the at least one reference signal index comprises NZP-CSI-RS-ResourceId.

In one embodiment, any reference signal index in the at least one reference signal index comprises a CSI-RS Resource Indicator (CRI).

In one embodiment, the first bitmap is unrelated to the second bitmap.

In one embodiment, the first bitmap is orthogonal to the second bitmap.

In one embodiment, the first reference signal index measurement result set is orthogonal to the second reference signal index measurement result set.

In one embodiment, K1 is equal to 1.

In one embodiment, K1 is equal to 2.

In one embodiment, K1 is equal to 4.

In one embodiment, K1 is equal to 9.

In one embodiment, K1 is equal to 10.

In one embodiment, K1 is equal to 64.

In one embodiment, K1 is equal to 96.

In one embodiment, K2 is equal to 1.

In one embodiment, K2 is equal to 2.

In one embodiment, K2 is equal to 4.

In one embodiment, K2 is equal to 9.

In one embodiment, K2 is equal to 10.

In one embodiment, K2 is equal to 64.

In one embodiment, K2 is equal to 96.

In one embodiment, a sum of K1 and K2 is equal to 9.

In one embodiment, a sum of K1 and K2 is equal to 10.

In one embodiment, a sum of K1 and K2 is not greater than 10.

In one embodiment, a sum of K1 and K2 is equal to 20.

In one embodiment, a sum of K1 and K2 is not greater than 64.

In one embodiment, the second message is an RRC message.

In one embodiment, the second message comprises UEInformationResponse.

In one embodiment, the second message is UEInformationResponse.

In one embodiment, the second message comprises UEAssistanceInformation.

In one embodiment, the first RLF report comprises RLF-Report.

In one embodiment, the first RLF report is RLF-Report.

In one embodiment, the first RLF report comprises LogMeasReport.

In one embodiment, each reference signal index in the at least one reference signal index indicates that a reference signal resource belongs to a current active BWP.

In one embodiment, each reference signal index in the at least one reference signal index indicates that a reference signal resource is configured to a current active BWP.

In one embodiment, any reference signal resource of a currently active BWP belongs to a reference signal resource indicated by a reference signal index in the at least one reference signal index.

In one embodiment, any reference signal resource of a currently active BWP is configured as a reference signal resource indicated by a reference signal index in the at least one reference signal index.

In one embodiment, the first radio link monitoring configuration comprises Q1 sub-configurations, Q1 being a positive integer greater than 1; any of the Q1 sub-configurations comprised in the first radio link monitoring configuration corresponds to a BWP.

In one subembodiment of the above embodiment, any sub-configuration in the Q1 sub-configurations comprised in the first radio link monitoring configuration indicates at least one reference signal index, and any sub-configuration in the Q1 sub-configurations comprised in the first radio link monitoring configuration indicates that a reference signal resource identified by any reference signal index in the at least one reference signal index belongs to a same BWP; a reference signal index corresponding to reference signal resources on a same BWP only belongs to a same sub-configuration among the Q1 sub-configurations comprised in the first radio link monitoring configuration.

In one embodiment, the reference signal resource indicated by each reference signal index in the at least one reference signal index belongs to a default BWP.

In one embodiment, the reference signal resource indicated by each reference signal index in the at least one reference signal index is configured to a default BWP.

In one embodiment, any reference signal resource of a default BWP belongs to a reference signal resource indicated by a reference signal index in the at least one reference signal index.

In one embodiment, any reference signal resource of a default BWP is configured as a reference signal resource indicated by a reference signal index in the at least one reference signal index.

In one embodiment, the reference signal resource indicated by each reference signal index in the at least one reference signal index belongs to a BWP used for multicast.

In one embodiment, the reference signal resource indicated by each reference signal index in the at least one reference signal index is configured to a BWP used for multicast.

In one embodiment, any reference signal resource of a BWP used for multicast belongs to a reference signal resource indicated by a reference signal index in the at least one reference signal index.

In one embodiment, any reference signal resource of a BWP used for multicast is configured to a reference signal resource indicated by a reference signal index in the at least one reference signal index.

In one embodiment, the being used for multicast comprises Multicast Broadcast Service (MBS).

In one embodiment, the being used for multicast comprises Point to Multipoint (PTM).

In one embodiment, each reference signal index in the at least one reference signal index indicates that a reference signal resource belongs to any BWP.

In one embodiment, any reference signal resource of any BWP belongs to a reference signal resource indicated by a reference signal index in the at least one reference signal index.

In one embodiment, each reference signal index in the at least one reference signal index indicates that a reference signal resource belongs to different BWPs.

In one embodiment, any reference signal resource of different BWPs belongs to a reference signal resource indicated by a reference signal index in the at least one reference signal index.

In one embodiment, each reference signal index in the at least one reference signal index indicates that a reference signal resource belongs to a same BWP.

In one embodiment, any reference signal resource of a same BWP belongs to a reference signal resource indicated by a reference signal index in the at least one reference signal index.

In one embodiment, each reference signal index in the at least one reference signal index indicates that a reference signal resource belongs to any BWP of the first node.

In one embodiment, any reference signal resource of any BWP of the first node belongs to a reference signal resource indicated by a reference signal index in the at least one reference signal index.

In one embodiment, each reference signal index in the at least one reference signal index indicates that a reference signal resource comprises part or all of all reference signal resources of all BWPs configured to a first node.

In one embodiment, each reference signal index in the at least one reference signal index indicates that a reference signal resource comprises one of all BWPs configured to a first node.

In one embodiment, as a response to the behavior of determining RLF, the first node stores link failure information in a first radio link failure variable;
herein, the first RLF report comprises the link failure information stored in the first RLF variable.

In one embodiment, in the behavior of transmitting a second message, the second message comprising a first radio link failure report comprises setting rlf-Report of the second message to a value of rlf-Report in the first radio link failure variable.

In one embodiment, the meaning of the phrase that any reference signal index comprised in the first reference signal index measurement result set is associated with a first PCI comprises: the first PCI is used to generate the any reference signal index comprised in the first reference signal index measurement result set.

In one embodiment, the meaning of the phrase that any reference signal index comprised in the first reference signal index measurement result set is associated with a first PCI comprises: the first PCI is used to generate a reference signal identified by the any reference signal index comprised in the first reference signal index measurement result set.

In one embodiment, the meaning of the phrase that any reference signal index comprised in the first reference signal index measurement result set is associated with a first PCI comprises: a reference signal identified by any reference signal index comprised in the first reference signal index measurement result set and an SSB of a physical cell determined by the first PCI are QCL.

In one embodiment, the meaning of the phrase that any reference signal index comprised in the first reference signal index measurement result set is associated with a first PCI comprises: a reference signal identified by any reference signal index comprised in the first reference signal index measurement result set is transmitted by a cell identified by the first PCI.

In one embodiment, the meaning of the phrase that any reference signal index comprised in the first reference signal index measurement result set is associated with a first PCI comprises: radio resources occupied by a reference signal identified by any reference signal index comprised in the first reference signal index measurement result set are indicated by a configuration signaling, an RLC bearer to which the configuration signaling is conveyed is configured through a CellGroupConfig IE, and an SpCell configured by the CellGroupConfig IE comprises the first PCI.

In one embodiment, the meaning of the phrase that any reference signal index comprised in the first reference signal index measurement result set is associated with a first PCI comprises: radio resources occupied by a reference signal identified by any reference signal index comprised in the first reference signal index measurement result set are indicated by a configuration signaling, an RLC bearer to which the configuration signaling is conveyed is configured through a CellGroupConfig cell, and an SpCell configured by the CellGroupConfig cell comprises the first PCI.

In one embodiment, the meaning of the phrase that any reference signal index comprised in the second reference signal index measurement result set is associated with a second PCI comprises: the second PCI is used to generate the any reference signal index comprised in the second reference signal index measurement result set.

In one embodiment, the meaning of the phrase that any reference signal index comprised in the second reference signal index measurement result set is associated with a second PCI comprises: the second PCI is used to generate a reference signal identified by the any reference signal index comprised in the second reference signal index measurement result set.

In one embodiment, the meaning of the phrase that any reference signal index comprised in the second reference signal index measurement result set is associated with a second PCI comprises: a reference signal identified by any reference signal index comprised in the second reference signal index measurement result set and an SSB of a physical cell determined by the second PCI are QCL.

In one embodiment, the meaning of the phrase that any reference signal index comprised in the second reference signal index measurement result set is associated with a second PCI comprises: a reference signal identified by any reference signal index comprised in the second reference signal index measurement result set is transmitted by a cell identified by the second PCI.

In one embodiment, the meaning of the phrase that any reference signal index comprised in the second reference signal index measurement result set is associated with a second PCI comprises: radio resources occupied by a reference signal identified by any reference signal index comprised in the second reference signal index measurement result set are indicated by a configuration signaling, an RLC bearer to which the configuration signaling is conveyed is configured through a CellGroupConfig IE, and an SpCell configured by the CellGroupConfig IE comprises the second PCI.

In one embodiment, the meaning of the phrase that any reference signal index comprised in the second reference signal index measurement result set is associated with a second PCI comprises: radio resources occupied by a reference signal identified by any reference signal index comprised in the second reference signal index measurement result set are indicated by a configuration signaling, an RLC bearer to which the configuration signaling is conveyed is configured through a CellGroupConfig IE, and an SpCell configured by the CellGroupConfig IE comprises the second PCI.

In one embodiment, any reference signal index comprised in the first reference signal index measurement result set belongs to one of the K1 reference signal indexes comprised in the first reference signal index measurement result set.

In one embodiment, any reference signal index comprised in the second reference signal index measurement result set belongs to one of the K2 reference signal index(es) comprised in the second reference signal index measurement result set.

In one embodiment, the first node is in RRC_CONNECTED state.

In one embodiment, the first node is in RRC_IDLE state.

In one embodiment, the first node is in RRC_INACTIVATE state.

In one embodiment, the first node is in RRC-INACTIVE state or RRC_IDLE state.

In one embodiment, the first reference signal index measurement result set comprises rsIndexResults.

In one embodiment, the first reference signal index measurement result set comprises measResult.

In one embodiment, the first reference signal index measurement result set comprises MeasResultRLFNR.

In one embodiment, the first reference signal index measurement result set comprises K1 reference signal indexes and K1 measurement results.

In one subembodiment of the embodiment, the K1 reference signal indexes respectively correspond to the K1 measurement results.

In one subembodiment of the embodiment, the K1 reference signal indexes and the K1 measurement results appear in pairs.

In one subembodiment of the embodiment, one of the K1 reference signal indexes appears in pairs in a same data structure as one of the K1 measurements.

In one subembodiment of the embodiment, the first reference signal index measurement result set comprises K1 ResultsPerSSB-Indexes, where any of the K1 ResultsPerSSB-Indexes comprises one of the K1 reference signal indexes and one of the K1 measurement results.

In one subembodiment of the embodiment, the K1 measurement results comprise at least one of RSRP, RSRQ or SINR.

In one embodiment, the first reference signal index measurement result set comprises the first PCI.

In one embodiment, the first reference signal index measurement result set not explicitly comprises the first PCI.

In one embodiment, any of the K1 reference signal indexes comprised in the first reference signal index measurement result set is associated with the first PCI.

In one embodiment, the second reference signal index measurement result set comprises rsIndexResults.

In one embodiment, the second reference signal index measurement result set comprises rsIndexResults1.

In one embodiment, the second reference signal index measurement result set comprises rsIndexResults2.

In one embodiment, the second reference signal index measurement result set comprises measResult.

In one embodiment, the second reference signal index measurement result set comprises MeasResultRLFNR.

In one embodiment, the second reference signal index measurement result set comprises K2 reference signal index(es) and K2 measurement results.

In one subembodiment of the above embodiment, the K2 reference signal index(es) respectively correspond to the K2 measurement results.

In one subembodiment of the embodiment, the K2 reference signal index(es) and the K2 measurement results appear in pairs.

In one subembodiment of the embodiment, one of the K2 reference signal index(es) appears in pairs in a same data structure as one of the K2 measurement results.

In one subembodiment of the embodiment, the second reference signal index measurement result set comprises K2 ResultsPerSSB-Index, where any of the K2 ResultsPerSSB-Index comprises one of the K2 reference signal index(es) and one of the K2 measurement results.

In one subembodiment of the embodiment, the second reference signal index measurement result set comprises K2 ResultsPerSSB-Index1, where any of the K2 ResultsPerSSB-Index1 comprises one of the K2 reference signal index(es) and one of the K2 measurement results.

In one subembodiment of the embodiment, the second reference signal index measurement result set comprises K2 ResultsPerSSB-Index2, where any of the K2 ResultsPerSSB-Index2 comprises one of the K2 reference signal index(es) and one of the K2 measurement results.

In one subembodiment of the embodiment, the K2 measurement results comprise at least one of RSRP, RSRQ or SINR.

In one embodiment, the second reference signal index measurement result set comprises the first PCI.

In one embodiment, the second reference signal index measurement result set not explicitly comprises the first PCI.

In one embodiment, any of the K2 reference signal index(es) comprised in the second reference signal index measurement result set is associated with the first PCI.

In one embodiment, the at least one reference signal index indicated by the first radio link monitoring configuration comprises a reference signal index associated with the first PCI and a reference signal index associated with the second PCI.

In one embodiment of the above embodiment, a reference signal index associated with the first PCI comprised in the at least one reference signal index indicated by the first radio link monitoring configuration comprises an SSB-index.

In one embodiment of the above embodiment, a reference signal index associated with the first PCI comprised in the at least one reference signal index indicated by the first radio link monitoring configuration comprises a CSI-RS-index.

In one embodiment of the above embodiment, a reference signal index associated with the second PCI comprised in the at least one reference signal index indicated by the first radio link monitoring configuration comprises a CSI-RS-index.

In one embodiment of the above embodiment, a reference signal index associated with the second PCI comprised in the at least one reference signal index indicated by the first radio link monitoring configuration comprises an SSB index.

In one embodiment, the first RLF report comprises a first measurement result, and the first measurement result comprises a measurement result of a primary cell of the first node based on an available reference signal measurement result until the RLF is detected;
the first measurement result comprises the first bitmap and the first reference signal index measurement result set; the first measurement result comprises the second bitmap and the second reference signal index measurement result set.

In one subembodiment of the above embodiment, the first measurement result comprises or only comprises measResultLastServCell.

In one subembodiment of the above embodiment, the first measurement result comprises cell-level RSRP of a PCell of the first node, and the first measurement result is based on available, valid, saved, generated, or measured SSB and CSI-RS measurement results until the first node detects the RLF.

In one subembodiment of the above embodiment, the first measurement result refers to a log measurement result performed within a PCell where RLF is detected.

In one subembodiment of the above embodiment, the first measurement result comprises a measResult list, the measResult list comprised in the first measurement result at least comprises two measResults, and one measResult in the measResult list comprised in the first measurement result comprises the first bitmap and the first reference signal index measurement result set; a measResult in the measResult list comprised in the first measurement result comprises the second bitmap and the second reference signal index measurement result; the first bitmap and the first reference signal index measurement result set, as well as the second bitmap and the second reference signal index measurement result set are respectively comprised in different measResults in the measResult list comprised in the first measurement result.

In one subembodiment of the above embodiment, the first measurement result comprises at least two rsIndexResults, and one of the at least two rsIndexResults comprised in the first measurement result comprises the first bitmap and the first reference signal index measurement result set; one of the at least two rsIndexResults comprised in the first measurement result comprises the second bitmap and the second reference signal index measurement result set; the first bitmap and the first reference signal index measurement result set, as well as the second bitmap and the second reference signal index measurement result set are respectively comprised in different rsIndexResults in the at least two rsIndexResults comprised in the first measurement result.

In one subembodiment of the above subembodiment, rsIndexResults comprising the first bitmap and the first reference signal index measurement result set and rsIndexResults comprising the second bitmap and the second reference signal index measurement result set respectively comprise the first PCI and the second PCI.

In one subembodiment of the above subembodiment, rsIndexResults comprising the first bitmap and the first reference signal index measurement result set does not comprise the first PCI, and rsIndexResults comprising the second bitmap and the second reference signal index measurement result set comprise the second PCI.

In one subembodiment of the above embodiment, the first measurement result comprises one rsIndexResults, and the rsIndexResults comprised in the first measurement result comprises the first bitmap and the first reference signal index measurement result set, and comprises the second bitmap and the second reference signal index measurement result set at the same time.

In one subembodiment of the above embodiment, the first measurement result comprises one rsIndexResults, and the rsIndexResults comprised in the first measurement result comprises the first bitmap and the first reference signal index measurement result set; the rsIndexResults comprised in the first measurement result does not comprise the second bitmap and the second reference signal index measurement result set.

In one subembodiment of the above embodiment, the first measurement result comprises one rsIndexResults, and the rsIndexResults comprised in the first measurement result comprises the first bitmap and the first reference signal index measurement result set; the rsIndexResults comprised in the first measurement result does not comprise the second bitmap and the second reference signal index measurement result set; the second bitmap and the second reference signal index measurement result set are comprised in a cell with a different name from rsIndexResults but the same data structure.

In one embodiment, advantages of the above methods are that UE can report measurement results of different physical cells at the same time when reporting a measurement result of a last serving cell.

In one embodiment, the meaning of the phrase of an effective reference signal measurement result comprises: a generated reference signal measurement result.

In one embodiment, the meaning of the phrase of an effective reference signal measurement result comprises: a latest reference signal measurement result.

In one embodiment, the meaning of the phrase of an effective reference signal measurement result comprises: an available reference signal measurement result.

In one embodiment, the first RLF report comprises a first measurement result and a second measurement result, and the first measurement result comprises a measurement result of a primary cell of the first node based on an available reference signal measurement result until the RLF is detected; the second measurement result comprises an available measurement result of a measurement object configured by a cell other than a primary cell of the first node;
the first measurement result comprises the first bitmap and the first reference signal index measurement result set; the second measurement result comprises the second bitmap and the second reference signal index measurement result set.

In one subembodiment of the above embodiment, the first measurement result comprises or only comprises measResultLastServCell.

In one subembodiment of the above embodiment, the second measurement result comprises or only comprises measResultNeighCells.

In one subembodiment of the above embodiment, the first measurement result does not comprise the first PCI.

In one subembodiment of the above embodiment, the first measurement result implicitly indicates the first PCI.

In one subembodiment of the above embodiment, the second measurement result does not comprise the first PCI.

In one subembodiment of the above embodiment, the second measurement result comprises the first PCI.

In one subembodiment of the above embodiment, the second measurement result comprises measurement results of up to eight carrier frequencies.

In one subembodiment of the above embodiment, the second measurement result comprises at least one MeasResultNR cell, and rsIndexResults of the at least one MeasResultNR cell comprised in the second measurement result comprise the second bitmap.

In one subembodiment of the above embodiment, the first measurement result comprises cell-level RSRP of a PCell of the first node, and the first measurement result is based on available, valid, saved, generated, or measured SSB and CSI-RS measurement results until the first node detects the RLF.

In one subembodiment of the above embodiment, the first measurement result refers to a log measurement result performed within a PCell where RLF is detected.

In one subembodiment of the above embodiment, the second measurement result refers to a measurement result of a neighboring cell.

In one subembodiment of the above embodiment, the second measurement result comprises all available measurement results of a cell with a best measurement result other than a PCell of the first node.

In one subembodiment of the above embodiment, a reference signal index only associated with the second PCI in the second measurement result is indicated by a bitmap to determine whether it belongs to the first radio link monitoring configuration.

In one subembodiment of the above embodiment, a bitmap comprised in the second measurement result only has the second bitmap.

In one subembodiment of the above embodiment, a bitmap comprised in the second measurement result only has the third bitmap.

In one subembodiment of the above embodiment, a bitmap comprised in the second measurement result only has the second bitmap and a third bitmap.

In one subembodiment of the above embodiment, a bitmap comprised in the second measurement result is only related to the second PCI.

In one subembodiment of the above embodiment, a bitmap comprised in the second measurement result is only related to the second PCI, and a reference signal index indicated by the first radio link monitoring configuration is only associated with one of the first PCI or the second PCI, and not associated with a PCI other than the first PCI or the second PCI.

In one subembodiment of the above embodiment, measurement results of cells other than a cell corresponding to the second PCI comprised in the second measurement result are ordered such that a highest measurement result is listed first in the second measurement result; locations of the second bitmap and the second reference signal index measurement result set in the second measurement result are unrelated to an order of a measurement result of a cell corresponding to the second PCI.

In one subembodiment of the above embodiment, the second measurement result comprises a first result list and a second result list, where the second result list is MeasResultListNR, and the second result list does not comprise the second PCI; the first result list comprises the second PCI, the second bitmap, and the second reference signal index measurement result set.

In one subembodiment of the above embodiment, the second measurement result comprises a second result list, for example, the second result list is MeasResultListNR, the second result list consists of at least one second result list element, for example, the second result list element is MeasResultNR, and all second result list elements not comprising the second PCI in at least one second result list element comprised in the second result list are sorted according to RSRP of SS/PBCH blocks comprised in a second result list element, where the higher the value of the RSRP of the comprised SS/PBCH block the higher the sorting.

In one subembodiment of the above embodiment, a second result list element comprising the second PCI is always arranged first in the second result list.

In one embodiment, advantages of the above methods are that reporting whether a reference signal index of a cell identified by a second PCI belongs to a first radio link monitoring configuration through a measurement result of a neighboring cell allows the base station to obtain information on whether a reference signal of any neighboring cell or a specific neighboring cell is used for detecting/monitoring RLF, which contributes to the network optimization; on the other hand, by means of reference signal resources of TRPs of other cells configured by a serving cell, where at least partial transmission resources of TRPs of the other cells can be considered as a part of or an extension of total transmission resources of a current serving cell, placing reference signals of the TRPs of other physical cells in the measurement result of the neighboring cell helps to avoid confusion with the measurement result of the cell.

In one embodiment, the first RLF report comprises a first measurement result, a second measurement result and a third measurement result, and the first measurement result comprises a measurement result of a primary cell of the first node based on an available reference signal measurement result until the RLF is detected; the second measurement result comprises an available measurement result of a measurement object configured by a cell other than a primary cell of the first node and a cell identified by the first PCI and a cell identified by the second PCI;
the first measurement result comprises the first bitmap and the first reference signal index measurement result set; the third measurement result comprises the second bitmap and the second reference signal index measurement result set.

In one subembodiment of the above embodiment, the first measurement result comprises or only comprises measResultLastServCell.

In one subembodiment of the above embodiment, the second measurement result comprises or only comprises measResultNeighCells.

In one subembodiment of the above embodiment, the first measurement result refers to a log measurement result performed within a PCell where RLF is detected.

In one subembodiment of the above embodiment, the second measurement result refers to a measurement result of a neighboring cell.

In one subembodiment of the above embodiment, the second measurement result refers to a measurement result of a neighboring cell not comprising a cell identified by the second PCI.

In one subembodiment of the above embodiment, the second measurement result comprises all available measurement quantities of a cell with a best measurement result other than a cell identified by the second physical cell and other than a PCell of the first node.

In one subembodiment of the above embodiment, a reference signal index only associated with the second PCI in the third measurement result is indicated by a bitmap to determine whether it belongs to the first radio link monitoring configuration.

In one subembodiment of the above embodiment, the third measurement result comprises or only comprises a measurement result of a cell identified by the second PCI.

In one subembodiment of the above embodiment, the third measurement result does not comprise the second measurement result nor the first measurement result.

In one subembodiment of the above embodiment, neither the second measurement result nor the first measurement result comprises the third measurement result.

In one embodiment, advantages of the above method are that it is possible to avoid as much as possible confusion between measurement results of the reference signals of TRPs associated with other PCIs configured by a current serving cell, other measurement results of the current serving cell, and other measurement results of the neighboring cell, so as to reduce protocol and development complexity.

In one embodiment, a serving cell of the first node configures the measurement object.

In one embodiment, the measurement object comprises frequency related to measurement.

In one embodiment, the measurement object comprises reference signal resources related to measurement.

In one embodiment, the measurement object comprises a measurement threshold related to measurement.

In one embodiment, the measurement object comprises measurement identity.

In one embodiment, the measurement object is measObjectNR.

In one embodiment, a serving cell of the first node can be configured with one or more than one measurement object.

In one embodiment, the first node executes a measurement for the measurement object.

In one embodiment, the first RLF report comprises a first measurement result and a second measurement result, and the first measurement result comprises a measurement result of a primary cell of the first node based on an available reference signal measurement result until the RLF is detected; the second measurement result comprises an available measurement result of a measurement object configured by a cell other than a primary cell of the first node;
the first measurement result comprises the first bitmap and the first reference signal index measurement result set; whether the second bitmap and the second reference signal index measurement result set are comprised by the first measurement result or are comprised by the second measurement result set is related to a type of a reference signal index comprised by the second reference signal index measurement result set; the type of the reference signal index is one of SSB-index or CSI-RS-index.

In one subembodiment of the above embodiment, the first measurement result comprises or only comprises measResultLastServCell.

In one subembodiment of the above embodiment, the second measurement result comprises or only comprises measResultNeighCells.

In one subembodiment of the above embodiment, the first measurement result refers to a log measurement result performed within a PCell where RLF is detected.

In one subembodiment of the above embodiment, the second measurement result refers to a measurement result of a neighboring cell.

In one subembodiment of the above embodiment, the second measurement result comprises all available measurement quantities of a cell with a best measurement result other than a PCell of the first node.

In one subembodiment of the above embodiment, when a type of a reference signal identified by a reference signal index comprised in the second reference signal index measurement result set is SSB-index, the first measurement result comprises the second bitmap and the second reference signal index measurement result set; when a type of a reference signal identified by a reference signal index comprised in the second reference signal index measurement result set is CSI-RS-index, the second measurement result comprises the second bitmap and the second reference signal index measurement result set.

In one subembodiment of the above embodiment, when a type of a reference signal identified by a reference signal index comprised in the second reference signal index measurement result set is SSB-index, the second measurement result comprises the second bitmap and the second reference signal index measurement result set; when a type of a reference signal identified by a reference signal index comprised in the second reference signal index measurement result set is CSI-RS-index, the first measurement result comprises the second bitmap and the second reference signal index measurement result set.

In one embodiment, the first RLF report comprises a third bitmap and a third reference signal index measurement result set; the third reference signal index measurement result set comprises K3 reference signal index(es), and the K3 is a positive integer; the third bitmap indicates whether any of the K3 reference signal index(es) comprised in the third reference signal index measurement result set belongs to the first radio link monitoring configuration; any reference signal index comprised in the third reference signal index measurement result set is associated with a second PCI.

In one subembodiment of the above embodiment, the K3 is equal to one of 1, 2, 4, 8, 9, 10 and 64.

In one subembodiment of the above embodiment, K3 is configurable.

In one subembodiment of the above embodiment, a sum of K1 and K3 is equal to 8.

In one subembodiment of the above embodiment, a sum of K1 and K3 is equal to 9.

In one subembodiment of the above embodiment, a sum of K1 and K3 is equal to 10.

In one subembodiment of the above embodiment, a sum of K1 and K3 is not greater than 10.

In one subembodiment of the above embodiment, a sum of K2 and K3 is not greater than 10.

In one subembodiment of the above embodiment, a sum of K1, K2 and K3 is equal to 10.

In one subembodiment of the above embodiment, a sum of K1, K2 and K3 is not greater than 10.

In one subembodiment of the above embodiment, a length of the first bitmap and a length of the third bitmap are the same.

In one subembodiment of the above embodiment, a length of the first bitmap and a length of the third bitmap are different.

In one subembodiment of the above embodiment, a sum of a length of the second bitmap and a length of the third bitmap is 64 bits.

In one subembodiment of the above embodiment, a sum of a length of the third bitmap and a length of the second bitmap is 96 bits.

In one subembodiment of the above embodiment, the third bitmap comprises ssbRLMConfigBitmap.

In one subembodiment of the above embodiment, the third bitmap comprises csi-rsRLMConfigBitmap.

In one subembodiment of the above embodiment, the third bitmap is ssbRLMConfigBitmap.

In one subembodiment of the above embodiment, the third bitmap is csi-rsRLMConfigBitmap.

In one subembodiment of the above embodiment, the second bitmap is ssbRLMConfigBitmap, and the third bitmap is csi-rsRLMConfigBitmap.

In one subembodiment of the above embodiment, the third bitmap is ssbRLMConfigBitmap, and the second bitmap is csi-rsRLMConfigBitmap.

In one subembodiment of the above embodiment, the first bitmap is ssbRLMConfigBitmap, the second bitmap is ssbRLMConfigBitmap, and the third bitmap is csi-rsRLMConfigBitmap.

In one subembodiment of the above embodiment, the first bitmap is csi-rsRLMConfigBitmap, the second bitmap is csi-rsRLMConfigBitmap, and the third bitmap is csi-rsRLMConfigBitmap.

In one subembodiment of the above embodiment, the first RLF report comprises a first measurement result, and the first measurement result comprises a measurement result of a primary cell of the first node based on an available reference signal measurement result until the RLF is detected;
the first measurement result comprises the first bitmap and the first reference signal index measurement result set; the first measurement result comprises the second bitmap and the second reference signal index measurement result set; the first measurement result comprises the third bitmap and the third reference signal index measurement result set.

In one subembodiment of the above embodiment, the first RLF report comprises a first measurement result and a second measurement result, and the first measurement result comprises a measurement result of a primary cell of the first node based on an available reference signal measurement result until the RLF is detected; the second measurement result comprises an available measurement result of a measurement object configured by a cell other than a primary cell of the first node;
the first measurement result comprises the first bitmap and the first reference signal index measurement result set; the second measurement result comprises the second bitmap and the second reference signal index measurement result set; the second measurement result comprises the third bitmap and the third reference signal index measurement result set.

In one subembodiment of the above embodiment, the first RLF report comprises a first measurement result, a second measurement result and a third measurement result, and the first measurement result comprises a measurement result of a primary cell of the first node based on an available reference signal measurement result until the RLF is detected; the second measurement result comprises an available measurement result of a measurement object configured by a cell other than a primary cell of the first node and a cell identified by the first PCI and a cell identified by the second PCI;
the first measurement result comprises the first bitmap and the first reference signal index measurement result set; the third measurement result comprises the second bitmap and the second reference signal index measurement result set; the third measurement result comprises the third bitmap and the third reference signal index measurement result set.

In one subembodiment of the above embodiment, the third reference signal index measurement result set comprises K3 reference signal indexes and K3 measurement results.

In one subembodiment of the above embodiment, the K3 reference signal index(es) respectively correspond to the K3 measurement results.

In one subembodiment of the embodiment, the K3 reference signal index(es) and the K3 measurement results appear in pairs.

In one subembodiment of the embodiment, one of the K3 reference signal index(es) appears in pairs in a same data structure as one of the K3 measurements.

In one subembodiment of the embodiment, the first reference signal index measurement result set comprises K3 ResultsPerSSB-Index, where any of the K3 ResultsPerSSB-Index comprises one of the K3 reference signal index(es) and one of the K3 measurement results.

In one subembodiment of the embodiment, the K3 measurement results comprise at least one of RSRP, RSRQ or SINR.

In one embodiment, the at least one reference signal index indicated by the first radio link monitoring configuration comprises a reference signal index associated with the first PCI and a reference signal index associated with the second PCI.

In one embodiment, the at least one reference signal index indicated by the first radio link monitoring configuration only comprises a reference signal index associated with the first PCI and not a reference signal index associated with the second PCI.

In one embodiment, any reference signal index in the at least one of the reference signal index indicated by the first radio link monitoring configuration is associated with the first PCI.

In one subembodiment of the above embodiment, any reference signal index in the at least one of the reference signal index indicated by the first radio link monitoring configuration is not associated with the second PCI.

In one subembodiment of the above embodiment, values of all bits in the second bitmap are the same.

In one embodiment, regardless of whether the first radio link monitoring configuration indicates a reference signal index associated with the second PCI, the first node needs or can report the second bitmap.

In one embodiment, advantages of the above method are that even if reference signal indexes indicated by the first radio link monitoring configuration are unrelated to the second PCI, the first node may report measurement results corresponding to the reference signal indexes associated with a second PCI in a first RLF report, while indicating by means of the second bitmap that these reported reference signal indexes do not belong to the first radio link monitoring configuration. This helps the base station to more accurately grasp the information of the first node when the radio link fails, and it is better compatible with various situations and simplifies the same design.

In one embodiment, the first message comprises the first radio link monitoring configuration.

In one embodiment, the first message indicates an insertion of a reference signal index to the first radio link monitoring configuration.

In one embodiment, the first message indicates an identity of the first radio link monitoring configuration.

In one embodiment, the first radio link monitoring configuration explicitly comprises at least one reference signal index.

In one embodiment, the first radio link monitoring configuration comprises Q1 sub-configurations, and each sub-configuration in the Q1 sub-configuration comprises at least one reference signal index.

In one embodiment, the meaning of the phrase that the first radio link monitoring configuration is used to indicate at least one reference signal index comprises: the first radio link monitoring configuration indicates a value of the at least one reference signal index.

In one embodiment, the meaning of the phrase that the first radio link monitoring configuration is used to indicate at least one reference signal index comprises: the first radio link monitoring configuration indicates a value of any reference signal index in the at least one reference signal index.

In one embodiment, the meaning of the phrase that the first radio link monitoring configuration is used to indicate at least one reference signal index comprises: the first radio link monitoring configuration indicates that any reference signal index in the at least one reference signal index is used for an RLF detection.

In one embodiment, the meaning of the phrase that the first radio link monitoring configuration is used to indicate at least one reference signal index comprises: the first radio link monitoring configuration indicates that any reference signal index in the at least one reference signal index is used for an RLF detection and is also used for beam failure detection at the same time.

In one embodiment, the phrase that each reference signal index in the at least one reference signal index indicates a reference signal resource comprises the following meaning: each reference signal index in the at least one reference signal index respectively corresponds to one reference signal resource.

In one subembodiment of the embodiment, a serving cell of the first node explicitly indicates reference signal resources corresponding to each reference signal index in the at least one reference signal index.

In one embodiment, the meaning of the phrase that the first RLF report implicitly indicates the first PCI comprises: the first RLF report comprises a first measurement result, and the first measurement result is fixed for a cell identified by the first PCI.

In one embodiment, the meaning of the phrase that the first RLF report implicitly indicates the first PCI comprises: a cell identified by the first PCI is a serving cell, and the first RLF report comprises a measurement result of a serving cell, but does not comprise the first PCI.

In one embodiment, the meaning of the phrase that the first RLF report implicitly indicates the first PCI comprises: a cell identified by the first PCI is a serving cell, the first RLF report comprises a first measurement result, the first measurement result is fixed for the serving cell, and at least a former of the first measurement result and the first RLF report does not comprise the first PCI.

In one embodiment, each of the at least one reference signal index indicated by the first radio link monitoring configuration indicates that only a part of a reference signal resource is quasi co-located with an SSB transmitted by a serving cell of the first node.

In one embodiment, each reference signal index of the at least one reference signal index indicated by the first radio link monitoring configuration indicates that only a part of a reference signal is quasi co-located with an SSB transmitted by a serving cell of the first node.

In one embodiment, frequency of a cell identified by the first PCI and frequency of a cell identified by the second PCI are partially or all the same.

In one embodiment, frequency of a cell identified by the first PCI and frequency of a cell identified by the second PCI are different.

### Embodiment 1C

Embodiment 1C illustrates a flowchart of receiving a first message and assessing first-type radio quality according to reference signal resources identified by at most L2 reference signal index(es) in reference signal indexes indicated by a first reference signal index set according to one embodiment of the present application, as shown in FIG. 1C. In FIG. 1, each box represents a step. It should be noted particularly that the order in which the boxes are arranged does not imply a chronological sequence of each step respectively marked.

In Embodiment 1C, a first node in the present application receives a first message in step C101; in step C102, assesses first-type radio link quality based on reference signal resources identified by at most L2 reference signal indexes in reference signal indexes indicated by the first reference signal index set;
herein, the first message is used to indicate the first reference signal index set; the first reference signal index set comprises at most L1 reference signal indexes, L1 being a positive integer greater than 1; any reference signal index in the first reference signal index set indicates a reference signal resource; L2 is a positive integer greater than 1; at least one reference signal index in the first reference signal index set is associated with a first PCI; at least one of L1 or L2 depends on a first parameter, and the first parameter is related to whether there exists at least one reference signal index in the first reference signal index set being associated with a second PCI; whenever the evaluated first-type radio link quality is worse than a first threshold, a physical layer of the first node reporting a first-type indication to a higher layer of the first node; as a response to the higher layer of the first node continuously receiving Q1 first-type indication(s), starting the first timer, Q1 being a positive integer; as a response to the first timer being expired, detecting RLF.

In one embodiment, the first node is a User Equipment (UE).

In one embodiment, the first node is a Mobile Station (MS).

In one embodiment, bandwidth self-adaptation is supported in 5G NR; a subset of a total cell bandwidth of a cell is called a BWP; the base station implements bandwidth self-adaptation by configuring BWPs to the UE and telling the UE which of the configured BWPs is a currently active BWP.

In one embodiment, a transmitter of the first message is a serving cell of the first node.

In one embodiment, a transmitter of the first message is a PCell of the first node.

In one embodiment, a transmitter of the first message is an SpCell of the first node.

In one embodiment, the first message is an RRC message.

In one embodiment, the first message comprises and only comprises RRCReconfiguration.

In one subembodiment of the above embodiment, the first message comprises a first radio link monitoring configuration.

In one subembodiment of the above embodiment, the first message comprises an RRCReconfiguration message.

In one subembodiment of the above embodiment, the first message comprises RadioLinkMonitoringConfig.

In one subembodiment of the above embodiment, the first message comprises RadioLinkMonitoringConfig of each BWP.

In one subembodiment of the above embodiment, the first message comprises RadioLinkMonitoringConfig of an active BWP.

In one subembodiment of the above embodiment, the first message comprises RadioLinkMonitoringConfig of one BWP.

In one embodiment, the first message comprises a first radio link monitoring configuration.

In one subembodiment of the above embodiment, the second sub-message comprises RadioLinkMonitoringConfig.

In one subembodiment of the above embodiment, a first radio link monitoring configuration comprises RadioLinkMonitoringConfig.

In one subembodiment of the above embodiment, a first radio link monitoring configuration is RadioLinkMonitoringConfig.

In one subembodiment of the above embodiment, a first radio link monitoring configuration is BeamFailureRecoveryConfig.

In one subembodiment of the above embodiment, a first radio link monitoring configuration comprises RadioLinkMonitoringRS.

In one subembodiment of the above embodiment, a first radio link monitoring configuration is RadioLinkMonitoringRS.

In one subembodiment of the above embodiment, a first radio link monitoring configuration indicates reference signal resources provided by or associated with an activated TCI state in CORESETs used to receive a PDCCH on an active BWP of the first node.

In one subembodiment of the above embodiment, the first radio link monitoring configuration comprises the first reference signal index set.

In one embodiment, the first message indicates an identity of the first radio link monitoring configuration.

In one embodiment, the first reference signal index set is configured by unicast; the second reference signal index set is configured by non-unicast.

In one embodiment, the first reference signal index set is configured by unicast; the second reference signal index set is configured by unicast.

In one embodiment, there exists one-to-one corresponding relation between any reference signal index in the first reference signal index set and a reference signal resource.

In one embodiment, each reference signal index in the first reference signal index set indicates a reference signal resource, and the reference signal resource is a synchronization signal block or synchronization signal/PBCH block (SSB) or a Channel State Information Reference Signal (CSI-RS) resource.

In one embodiment, an index of each reference signal in the first reference signal index set is an ssb-index or a csi-rs-index.

In one embodiment, each reference signal index in the first reference signal index set indicates a reference signal resource, and the reference signal resource is an SSB or a CSI-RS resource.

In one embodiment, each reference signal index in the first reference signal index set indicates a reference signal resource, and the reference signal resource is an SSB resource or a CSI-RS resource.

In one embodiment, each reference signal index in the first reference signal index set indicates a reference signal resource, and the reference signal resource is a resource occupied by an SSB or a resource occupied by a CSI-RS.

In one embodiment, the csi-rs-index indicates NZP-CSI-RS-ResourceId.

In one embodiment, the SSB is a synchronization signal block.

In one embodiment, the SSB is a synchronization signal/PBCH block (SS/PBCH block).

In one embodiment, any reference signal index in the first reference signal index set is a non-negative integer.

In one embodiment, any reference signal index in the first reference signal index set is a structure.

In one embodiment, any reference signal index in the first reference signal index set is a structure comprising a non-negative integer.

In one embodiment, any reference signal index in the first reference signal index set comprises a structure of a PCI and an SSB-index.

In one embodiment, any reference signal index in the first reference signal index set comprises a structure of a PCI and a csi-rs-index.

In one embodiment, any reference signal index in the first reference signal index set comprises an SSB-index.

In one embodiment, any reference signal index in the first reference signal index set comprises a csi-rs-index.

In one embodiment, any reference signal index in the first reference signal index set comprises a NZP-CSI-RS-ResourceId.

In one embodiment, any reference signal index in the first reference signal index set comprises a CSI-RS Resource Indicator (CRI).

In one embodiment, reference signal resources indicated by each reference signal index in the first reference signal index set are detectionResource.

In one embodiment, reference signal resources indicated by each reference signal index in the first reference signal index set are an SSB-index.

In one embodiment, reference signal resources indicated by each reference signal index in the first reference signal index set are resources corresponding to or identified by or determined by an SSB-index.

In one embodiment, reference signal resources indicated by each reference signal index in the first reference signal index set is a csi-rs-index.

In one embodiment, reference signal resources indicated by each reference signal index in the first reference signal index set are resources corresponding to or identified by or determined by a csi-rs-index.

In one embodiment, the resources comprise at least one of time-domain resources, frequency-domain resources or spatial-domain resources.

In one embodiment, a reference signal index corresponding to at least partial reference signal resources of a BWP used for multicast belongs to the first reference signal index set.

In one embodiment, the being used for multicast comprises Multicast Broadcast Service (MBS).

In one embodiment, the multicast service comprises MBS.

In one embodiment, the being used for multicast comprises Point to Multipoint (PTM).

In one embodiment, the first PCI is different from the second PCI.

In one embodiment, the first PCI is a Physical Cell Identifier (PCI).

In one embodiment, the first PCI is a PhysCellId.

In one embodiment, the first PCI is a Physical layer cell ID.

In one embodiment, the first PCI identifies a cell.

In one embodiment, the first PCI is used to generate an SSB identifying a cell.

In one embodiment, the first PCI and an SSB of the identified cell are QCL.

In one embodiment, the first PCI is a physCellId comprised in the received ServingCellConfigCommon.

In one embodiment, the first PCI is a physCellId comprised in the received spCellConfigCommon.

In one embodiment, the second PCI is a PCI.

In one embodiment, the second PCI is a PhysCellId.

In one embodiment, the second PCI is a Physical layer cell ID.

In one embodiment, the second PCI identifies a cell.

In one embodiment, the second PCI is used to generate an SSB identifying a cell.

In one embodiment, the second PCI and an SSB of the identified cell are QCL.

In one embodiment, the second PCI is not indicated by a physCellId comprised in the received ServingCellConfigCommon.

In one embodiment, the second PCI is not a physCellId comprised in the received spCellConfigCommon.

In one embodiment, the second PCI is not indicated by the received ServingCellConfigCommon.

In one embodiment, the first PCI identifies a first cell; the second PCI identifies a second cell.

In one embodiment, the first cell is a cell identified by a physCellId comprised in ServingCellConfigCommon indicated by a serving cell of the first node.

In one embodiment, the first cell is a cell identified by a physCellId comprised in SpCellConfigCommon indicated by a serving cell of the first node.

In one embodiment, the first reference signal index set at least comprises one reference signal index.

In one embodiment, the first reference signal index set comprises a reference signal index of a reference signal on a BWP.

In one embodiment, the first reference signal index set comprises a reference signal index of a reference signal on multiple BWPs.

In one embodiment, the first reference signal index set comprises a reference signal index of a reference signal on an active BWP.

In one embodiment, the first reference signal index set comprises a reference signal index associated with the first PCI, and also comprises a reference signal index associated with the second PCI.

In one embodiment, any reference signal index comprised in the first reference signal index set is only associated with the first PCI.

In one embodiment, any reference signal index comprised in the first reference signal index set is associated with a PCI.

In one embodiment, Q1 is N310.

In one embodiment, a value of Q1 is one of 1, 2, 3, 4, 6, 8, 10 or 20.

In one embodiment, a serving cell of the first node is configured with the first threshold.

In one embodiment, the first message comprises the first threshold.

In one embodiment, the first threshold is determined by receiving quality of a PDCCH.

In one embodiment, the first threshold corresponds to RSRP of a radio link when a BLER of an assumed PDCCH is 10%.

In one embodiment, the first threshold corresponds to radio link observation quality or the first-type radio link quality when a BLER of a PDCCH is 10%.

In one embodiment, the first threshold corresponds to radio link quality or the first-type radio link quality when a BLER of an assumed PDCCH is 10%.

In one subembodiment of the above embodiment, assuming a PDCCH channel is transmitted on reference signal resources identified by the first reference signal index set, a measurement result or theoretical result of reference signal resources identified by the at most L2 reference signal indexes in the first reference signal index set when the reception quality of the PDCCH is BLER (block error rate)=10% is the first threshold.

In one subembodiment of the above embodiment, when a measurement result of reference signal resources identified by the at most L2 reference signal indexes in the first reference signal index set is the first threshold, a PDCCH is transmitted on reference signal resources identified by the at most L2 reference signal indexes in the first reference signal index set, and BLER of the transmitted PDCCH is equal to 10%.

In one subembodiment of the above embodiment, assuming a PDCCH channel is transmitted on a resource block to which reference signal resources identified by the first reference signal index set belong, a measurement result or theoretical result of reference signal resources identified by the at most L2 reference signal indexes in the first reference signal index set when the reception quality of the PDCCH is BLER (block error rate)=10% is the first threshold.

In one subembodiment of the above embodiment, when a measurement result of reference signal resources identified by the at most L2 reference signal indexes in the first reference signal index set is the first threshold, a PDCCH is transmitted on a resource block to which reference signal resources identified by the at most L2 reference signal indexes in the first reference signal index set belong, and BLER of the transmitted PDCCH is equal to 10%.

In one subembodiment of the above embodiment, the first threshold is an observation result or theoretical result of reference signal resources identified by the at most L2 reference signal indexes in the first reference signal index set determined by the hypothesis experiment for reception quality of a PDCCH channel, where the reception quality of the PDCCH channel is BLER equal to 10%.

In one embodiment, the first threshold is RSRP, the first-type radio link quality is RSRP of the reference signal resources indicated by the at most L2 reference signal indexes in the first reference signal index set.

In one subembodiment of the above embodiment, RSRP of the reference signal resources indicated by the at most L2 reference signal indexes in the first reference signal index set is a measurement result on the reference signal resources indicated by the at most L2 reference signal indexes in the first reference signal index set.

In one subembodiment of the embodiment, RSRP of the reference signal resources indicated by the at most L2 reference signal indexes of the first reference signal index set is an evaluation result on the reference signal resources indicated by the first reference signal index set.

In one embodiment, the first threshold is RSRQ (Reference Signal Receiving Quality), the first-type radio link quality is RSRQ of the reference signal resources indicated by the at most L2 reference signal indexes in the first reference signal index set.

In one subembodiment of the embodiment, RSRP of the reference signal resources indicated by the at most L2 reference signal indexes of the first reference signal index set is a measurement result on the reference signal resource indicated by the first reference signal index set.

In one subembodiment of the embodiment, RSRP of the reference signal resources indicated by the at most L2 reference signal indexes of the first reference signal index set is an evaluation result on the reference signal resource indicated by the first reference signal index set.

In one subembodiment of the embodiment, RSRP of the reference signal resources indicated by the at most L2 reference signal indexes of the first reference signal index set is the first-type link quality.

In one embodiment, the first threshold is an SINR, and the first-type radio link quality is a Signal to Interference plus Noise Ratio (SINR) of the reference signal resources indicated by the at most L2 reference signal indexes of the first reference signal index set.

In one subembodiment of the embodiment, RSRP of the reference signal resources indicated by the at most L2 reference signal indexes of the first reference signal index set is a measurement result on the reference signal resource indicated by the first reference signal index set.

In one subembodiment of the embodiment, RSRP of the reference signal resources indicated by the at least L2 reference signal indexes of the first reference signal index set is an evaluation result on the reference signal resources indicated by the first reference signal index set.

In one embodiment, the physical layer of the first node is a PHY layer or a PHY sublayer.

In one embodiment, the higher layer of the first node is an RRC layer or RRC sublayer.

In one embodiment, the higher layer of the first node is a MAC layer or MAC sublayer.

In one embodiment, the higher layer of the first node comprises an RRC layer.

In one embodiment, the higher layer of the first node comprises a MAC layer.

In one embodiment, the first-type radio link quality comprises RSRP.

In one embodiment, the first-type radio link quality comprises RSRQ.

In one embodiment, the first-type radio link quality comprises SINR.

In one embodiment, the first-type indication is “out-of-sync”.

In one embodiment, the first timer is T310.

In one embodiment, the first timer and the second timer are respectively configured by a serving cell of the first node.

In one embodiment, an expiration of the first timer triggers RLF.

In one embodiment, an expiration of the first timer triggers that the first node assumes that RLF occurs or is detected.

In one embodiment, an expiration of the first timer confirms the behavior of detecting RLF.

In one embodiment, an evaluation period for the first-type radio link quality is one frame.

In one embodiment, an evaluation period of the first-type radio link quality is 10 milliseconds.

In one embodiment, an evaluation period of the first-type radio link quality is a maximum value between a shortest radio link monitoring period and 10 ms.

In one embodiment, an evaluation period of the first-type radio link quality is a maximum value between a shortest radio link monitoring period and a Discontinuous Reception (DRX) period.

In one embodiment, the meaning of the phrase of assessing first-type radio link quality based on reference signal resources identified by at most L2 reference signal indexes in reference signal indexes indicated by the first reference signal index set comprises: when a serving cell of the first node is configured with multiple downlink BWPs, the first node performs radio link monitoring (RLM) on an active BWP employing reference signal resources indicated by at most L2 reference signal indexes of the first reference signal index set.

In one subembodiment of the embodiment, the first node measures the reference signal resources indicated by the at most L2 reference signal indexes of the first reference signal index set.

In one subembodiment of the embodiment, the first node measures the reference signal resources indicated by the at most L2 reference signal indexes in all reference signal indexes belonging to a same BWP in the first reference signal index set.

In one subembodiment of the embodiment, the at most L2 reference signal indexes of the first reference signal index set belong to a reference signal index of an active BWP.

In one subembodiment of the embodiment, the first reference signal index set only comprises a reference signal index of an active BWP.

In one embodiment, the meaning of the phrase of assessing first-type radio link quality based on reference signal resources identified by at most L2 reference signal indexes in reference signal indexes indicated by the first reference signal index set comprises: when there is no reference signal index provided for radio link monitoring on an active BWP, the first node adopts reference signal resources belonging to reference signal resources provided by or associated with an activated TCI state in CORESETs receiving a PDCCH on an active BWP in reference signal resources corresponding to the at most L2 reference signal indexes of the first reference signal index set for executing a radio link monitoring.

In one subembodiment of the embodiment, the first message comprises reference signal resources provided by or associated with an activate TCI state in the CORESETs.

In one embodiment, the meaning of the phrase of assessing first-type radio link quality based on reference signal resources identified by at most L2 reference signal indexes in reference signal indexes indicated by the first reference signal index set comprises: in non-DRX mode operation, the physical layer of the first node assesses radio link quality every assessment cycle, assesses a threshold configured violating rlmInSyncOutOfSyncThreshold in a past time cycle or evaluation period, and the first node determines that an assessment cycle is a maximum value between a shortest periodic radio link monitoring resource and 10 milliseconds.

In one subembodiment of the above embodiment, a serving cell of the first node indicates the rlmInSyncOutOfSyncThreshold.

In one subembodiment of the above embodiment, the first node determines the rlmInSyncOutOfSyncThreshold according to an internal algorithm.

In one subembodiment of the embodiment, the rlmInSyncOutOfSyncThreshold is used to indicate the first threshold.

In one subembodiment of the embodiment, the rlmInSyncOutOfSyncThreshold is used to determine the first threshold.

In one subembodiment of the embodiment, a serving cell of the first node indicates the assessment cycle.

In one subembodiment of the embodiment, the first threshold is Qout.

In one subembodiment of the embodiment, the first threshold is Q_{out,LR}.

In one embodiment, the meaning of the phrase of assessing first-type radio link quality based on reference signal resources identified by at most L2 reference signal indexes in reference signal indexes indicated by the first reference signal index set comprises: operating in Discontinuous Reception (DRX) mode, a physical layer of the first node assesses a radio connection quality every assessment cycle, evaluates a threshold (Qout and Qin) violating rlmInSyncOutOfSyncThreshold configuration in a past time cycle, and the first node determines that the assessment cycle is a shortest periodic radio link monitoring resource and a maximum value in a DRX cycle.

In one subembodiment of the above embodiment, a serving cell of the first node indicates the rlmInSyncOutOfSyncThreshold.

In one subembodiment of the above embodiment, the first node determines the rlmInSyncOutOfSyncThreshold according to an internal algorithm.

In one subembodiment of the embodiment, the rlmInSyncOutOfSyncThreshold is used to indicate the first threshold.

In one subembodiment of the embodiment, the rlmInSyncOutOfSyncThreshold is used to determine the first threshold.

In one subembodiment of the embodiment, a serving cell of the first node indicates the assessment cycle.

In one subembodiment of the embodiment, the first threshold is Qouₜ.

In one subembodiment of the embodiment, the first threshold is Q_{out,LR}.

In one embodiment, the meaning of the phrase of assessing first-type radio link quality based on reference signal resources identified by at most L2 reference signal indexes in reference signal indexes indicated by the first reference signal index set comprises: when radio link quality of all reference signal resources used for radio link monitoring is worse than the first threshold, the physical layer of the first node indicates “out-of-sync” to the higher layer in frames where radio link quality is evaluated; when radio link quality of any reference signal resource in reference signal resources used for radio link monitoring is better than a Qin threshold, a physical layer of the first node indicates “in-sync” to a higher layer in those frames in which radio link quality is assessed.

In one subembodiment of the embodiment, the first node measures reference signal resources used for radio link monitoring to obtain the first-type radio link quality.

In one subembodiment of the embodiment, when a number of “out-of-sync” indicated to a higher layer reaches Q1, the first node starts the first timer, for example, the first timer is T310, and an expiration of the first timer determines RLF.

In one subembodiment of the embodiment, the first reference signal index set indicates at least partial reference signal resources in the reference signal resources used for radio link monitoring.

In one subembodiment of the embodiment, the first reference signal index set indicates all reference signal resources in the reference signal resources used for radio link monitoring.

In one subembodiment of the embodiment, the first reference signal index set indicates a reference signal index of reference signal resources in reference signal resources used for radio link monitoring.

In one subembodiment of the above embodiment, the first node determines a first threshold and the Qin threshold based on an internal algorithm.

In one subembodiment of the above embodiment, a serving cell of the first node indicates the first threshold and the Qin threshold.

In one subembodiment of the above embodiment, the first-type indication is “out-of-sync”.

In one embodiment, the meaning of the phrase of assessing first-type radio link quality based on reference signal resources identified by at most L2 reference signal indexes in reference signal indexes indicated by the first reference signal index set comprises: when radio link quality of all reference signal resources used for radio link monitoring is worse than the first threshold, the physical layer of the first node indicates “out-of-sync” to the higher layer in frames where radio link quality is evaluated; when radio link quality of any reference signal resource in reference signal resources used for radio link monitoring is better than a Qin threshold, a physical layer of the first node indicates “in-sync” to a higher layer in frames in which radio link quality is evaluated.

In one subembodiment of the embodiment, the first node measures reference signal resources used for radio link monitoring to obtain the first-type radio link quality.

In one subembodiment of the embodiment, when a number of continuous “out-of-sync” indicated to a higher layer reaches Q1, the first node starts the first timer, for example, the first timer is T310, and an expiration of the first timer determines that the radio link failure.

In one subembodiment of the embodiment, when a number of continuous “out-of-sync” indicated to a higher layer reaches Q1, where the Q1 is configured by a serving cell of the first node, the first node starts the first timer, for example, a first timer is T310, and an expiration of the first timer determines the RLF; when continuous “in-sync” received by the higher layer reaches Q3, where Q3 is configured by a serving cell of the first node, the continuous first-type indication is counted again.

In one subembodiment of the embodiment, the first reference signal index set indicates at least partial reference signal resources in reference signal resources used for radio link monitoring.

In one subembodiment of the embodiment, the first reference signal index set indicates all reference signal resources in reference signal resources used for radio link monitoring.

In one subembodiment of the embodiment, the first reference signal index set indicates a reference signal index of reference signal resources in reference signal resources used for radio link monitoring.

In one subembodiment of the above embodiment, an expiration of the first timer triggers the RLF.

In one embodiment, the meaning of the phrase of assessing first-type radio link quality based on reference signal resources identified by at most L2 reference signal indexes in reference signal indexes indicated by the first reference signal index set comprises: the first node assesses the first radio link quality based on reference signal resources identified by at most L2 reference signal indexes in reference signal indexes indicated by the first reference signal index.

In one embodiment, the first radio link quality is quality of a radio link between the first node and a serving cell of the first node.

In one embodiment, the first radio link quality is radio link quality assessed based on reference signal resources identified by at most L2 reference signal indexes in reference signal indexes indicated by the first reference signal index set.

In one embodiment, the first radio link quality is a measurement result obtained by performing a measurement on reference signal resources identified by at most L2 reference signal indexes in reference signal indexes indicated by the first reference signal index set.

In one embodiment, the first radio link quality is a best one of measurement results obtained by performing a measurement on reference signal resources identified by at most L2 reference signal indexes in reference signal indexes indicated by the first reference signal index set.

In one embodiment, the meaning of the phrase of assessing first-type radio link quality based on reference signal resources identified by at most L2 reference signal indexes in reference signal indexes indicated by the first reference signal index set comprises: measuring reference signal resources identified by at most L2 reference signal indexes in the first reference signal index set to determine whether monitoring quality or evaluation quality of all reference signal resources indicated by the at most L2 reference signal indexes in the first reference signal index set is worse than the first threshold.

In one subembodiment of the embodiment, the first-type radio link quality is a measurement result of reference signal resources identified by the at most L2 reference signal indexes in the first reference signal index set.

In one subembodiment of the embodiment, the measurement result comprises one of RSRP, RSRQ and SINR.

In one subembodiment of the embodiment, the first-type radio link quality is a best one of measurement results of reference signal resources identified by the at most L2 reference signal indexes in the first reference signal index set.

In one subembodiment of the embodiment, the first-type radio link quality is a worst one of measurement results of reference signal resources identified by the at most L2 reference signal indexes in the first reference signal index set.

In one embodiment, the meaning of the phrase of continuously receiving Q1 first-type indications is, not receiving a third-type indication in the procedure of continuously receiving Q1 first-type indications.

In one embodiment, the third-type indication comprises “in-sync”.

In one embodiment, the third-type indication is used to indicate that the third-type radio link quality is better than the third threshold.

In one embodiment, the third-type radio link quality is radio link quality or assessment quality of any of the reference signal resources indicated by the at most L2 reference signal indexes in the first reference signal index set.

In one embodiment, the third-type radio link quality is the best one of radio link quality in reference signal resources indicated by the at most L2 reference signal indexes in the first reference signal index set.

In one embodiment, the radio link quality comprises an RSRP value.

In one embodiment, the radio link quality comprises an RSRQ value.

In one embodiment, the radio link quality comprises an SINR value.

In one embodiment, a serving cell of the first node is configured with the third threshold.

In one embodiment, the first node determines the third threshold based on internal algorithm.

In one embodiment, the first node determines the third threshold based on determined algorithm.

In one embodiment, the first node determines the third threshold based on reception quality of a PDCCH channel.

In one embodiment, the behavior of detecting RLF comprises: if RLF is detected in a PSCell, the RLF is considered to be detected for SCG (secondary cell group), if an MCG (master cell group) is not suspended, the SCG failure information procedure is initiated to report the SCG failure information, and if an MCG is suspended, then the connection reconstruction procedure is initiated.

In one embodiment, the behavior of detecting RLF comprises: storing RLF information in a first link failure variable; if timer T316 is configured and SCG transmission is not suspended and PSCell change and insertion are not in progress, the MCG failure message procedure is initiated to report MCG RLF, otherwise, the connection reconstruction procedure is initiated.

In one subembodiment of the above embodiment, the first link failure variable is VarRLF-Report.

In one embodiment, the behavior of detecting RLF comprises: storing RLF information in a first link failure variable; if timer T316 is not configured or SCG transmission is suspended or PSCell change is in progress or PSCell insertion is in progress, the connection re-establishment procedure is initiated.

In one subembodiment of the above embodiment, the first link failure variable is VarRLF-Report.

In one embodiment, the meaning of the phrase that at least one reference signal index in the first reference signal index set is associated with a first PCI comprises: the first PCI is used to generate at least one reference signal index comprised in the first reference signal index set.

In one embodiment, the meaning of the phrase that at least one reference signal index in the first reference signal index set is associated with a first PCI comprises: the first PCI is used to generate a reference signal identified by at least one reference signal index comprised in the first reference signal index set.

In one embodiment, the meaning of the phrase that at least one reference signal index in the first reference signal index set is associated with a first PCI comprises: the first reference signal index set comprises at least one reference signal index, and a reference signal identified by the at least one reference signal index is Quasi Co-Located (QCL) with an SSB of a cell identified by the first PCI.

In one embodiment, the meaning of the phrase that at least one reference signal index in the first reference signal index set is associated with a first PCI comprises: the first reference signal index set comprises at least one reference signal index, and a reference signal identified by the at least one reference signal index is transmitted by a cell identified by the first PCI.

In one embodiment, the meaning of the phrase that at least one reference signal index in the first reference signal index set is associated with a first PCI comprises: the first reference signal index set comprises at least one reference signal index, radio resources occupied by a reference signal identified by the at least one reference signal index are indicated by a configuration signaling, an RLC bearer to which the configuration signaling is conveyed is configured through a CellGroupConfig IE, and an SpCell configured by the CellGroupConfig IE comprises the first PCI.

In one embodiment, the meaning of the phrase that at least one reference signal index in the first reference signal index set is associated with a first PCI comprises: the first reference signal index set comprises at least one reference signal index, radio resources occupied by a reference signal identified by the at least one reference signal index are indicated by a configuration signaling, an RLC bearer to which the configuration signaling is conveyed is configured through a CellGroupConfig cell, and an SpCell configured by the CellGroupConfig cell comprises the first PCI.

In one embodiment, there exists at least one reference signal index in the first reference signal index set being associated with a second PCI, and the second PCI is used to generate at least one reference signal index comprised in the first reference signal index set.

In one embodiment, there exists at least one reference signal index in the first reference signal index set being associated with a second PCI, and the second PCI is used to generate a reference signal identified by at least one reference signal index comprised in the first reference signal index set.

In one embodiment, there exists at least one reference signal index in the first reference signal index set being associated with a second PCI, the first reference signal index set comprises at least one reference signal index, and a reference signal identified by the at least one reference signal index is QCL with an SSB of a cell identified by the second PCI.

In one embodiment, there exists at least one reference signal index in the first reference signal index set being associated with a second PCI; the first reference signal index set comprises at least one reference signal index, and a reference signal identified by the at least one reference signal index is transmitted by a cell identified by the second PCI.

In one embodiment, there exists at least one reference signal index in the first reference signal index set being associated with a second PCI; the first reference signal index set comprises at least one reference signal index, radio resources occupied by a reference signal identified by the at least one reference signal index are indicated by a configuration signaling, an RLC bearer to which the configuration signaling is conveyed is configured through a CellGroupConfig IE, and an SpCell configured by the CellGroupConfig IE comprises the second PCI.

In one embodiment, there exists at least one reference signal index in the first reference signal index set being associated with a second PCI; the first reference signal index set comprises at least one reference signal index, radio resources occupied by a reference signal identified by the at least one reference signal index are indicated by a configuration signaling, an RLC bearer to which the configuration signaling is conveyed is configured through a CellGroupConfig cell, and CSI-ResourceConfig configured by the CellGroupConfig cell comprises the second PCI.

In one embodiment, there exists at least one reference signal index in the first reference signal index set being associated with a second PCI; the first reference signal index set comprises at least one reference signal index, radio resources occupied by a reference signal identified by the at least one reference signal index are indicated by a configuration signaling, an RLC bearer to which the configuration signaling is conveyed is configured through a CellGroupConfig cell, and ServingCellConfig configured by the CellGroupConfig cell comprises the second PCI.

In one embodiment, the behavior of detecting RLF is used to trigger transmitting a second message, and the second message is used to indicate information of RLF.

In one embodiment, the second message is an RRC message.

In one embodiment, the second message comprises UEInformationResponse.

In one embodiment, the second message is UEInformationResponse.

In one embodiment, the second message comprises UEAssistanceInformation.

In one embodiment, the second message comprises a MAC CE.

In one embodiment, the second message comprises a UCI.

In one embodiment, a physical channel occupied by the second message comprises a physical uplink control channel (PUCCH).

In one embodiment, a physical channel occupied by the second message comprises a Physical Uplink Shared Channel (PUSCH).

In one embodiment, the first parameter is a maximum number of SSB indexes of the first cell.

In one subembodiment of the above embodiment, the SSB index is an SS/PBCH index.

In one subembodiment of the above embodiment, the first parameter is a maximum number of SS/PBCH blocks transmitted within half a frame.

In one embodiment, a maximum number of SSB indexes in the first cell is used to determine the first parameter.

In one embodiment, candidate SS/PBCH blocks within half a frame are indexed from 0 to L−1 in chronologically ascending order.

In one subembodiment of the above embodiment, the candidate SS/PBCH is an SS/PBCH that can be used for cell selection.

In one subembodiment of the above embodiment, the candidate SS/PBCH is an SS/PBCH that is possible to be used for cell selection.

In one subembodiment of the above embodiment, one or more SS/PBCH blocks indicated by ssb-PositionsInBurst can be transmitted in a discovery burst transmission window, and an index of the candidate SS/PB CH block corresponds to an index of an SS/PBCH block comprised in ssb-PositionsInBurst.

In one embodiment, a first SS/PBCH template is for a first SCS (subcarrier spacing);

In one subembodiment of the embodiment, the first SCS is 15 kHz; an index of a first one of symbols of a candidate SS/PBCH block comprises {2, 8}+14*n; for carrier frequency less than or equal to 3 GHz, n=0, 1; for carrier frequency belonging to FR1 but greater than 3 GHz, n=0, 1, 2, 3; shared spectrum channel access is not used.

In one subembodiment of the embodiment, the first SCS is 15 kHz; an index of a first one of symbols of a candidate SS/PBCH block comprises {2, 8}+14*n; when shared spectrum channel access is used, n=0, 1, 2, 3, 4.

In one subembodiment of the embodiment, the first SCS is 30 kHz; an index of the first one of symbols of a candidate SS/PBCH block comprises {4, 8, 16, 20}+28*n; for carrier frequency less than or equal to 3 GHz, n=0; for carrier frequency belonging to FR1 but greater than 3 GHz, n=0, 1;

In one subembodiment of the embodiment, the first SCS is 30 kHz; an index of a first one of symbols of a candidate SS/PBCH block comprises {2, 8}+14*n; paired spectrum operations are used; for carrier frequency less than or equal to 3 GHz, n=0, 1; for carrier frequency belonging to FR1 but greater than 3 GHz, n=0, 1, 2, 3, and no shared spectrum access is used.

In one subembodiment of the embodiment, the first SCS is 30 kHz; an index of a first one of symbols of a candidate SS/PBCH block comprises {2, 8}+14*n; unpaired spectrum operations are used; for carrier frequency less than 1.88 GHz, n=0, 1; for carrier frequency belonging to FR1 but greater than or equal to 1.88 GHz, n=0, 1, 2, 3, and no shared spectrum access is used.

In one subembodiment of the embodiment, the first SCS is 30 kHz; an index of a first one of symbols of a candidate SS/PBCH block comprises {2, 8}+14*n; and shared spectrum access is used; n=0, 1, 2, 3, 4, 5, 6, 7, 8, 9.

In one subembodiment of the embodiment, the first SCS is 120 kHz; an index of a first one of symbols of a candidate SS/PBCH block comprises {4, 8, 16, 20}+28*n; carrier frequency is within FR2, n=0, 1, 2, 3, 5, 6, 7, 8, 10, 11, 12, 13, 15, 16, 17, 18.

In one subembodiment of the embodiment, the first SCS is 240 kHz; an index of a first one of symbols of a candidate SS/PBCH block comprises {8, 12, 16, 20, 32, 36, 40, 44}+56*n; carrier frequency is within FR2, n=0, 1, 2, 3, 5, 6, 7, 8.

In one subembodiment of the embodiment, candidate SS/PBCH blocks within half a frame are indexed in a chronologically ascending order from 0 to L−1, where L is determined by a number of indexes of a first one of symbols of the candidate SS/PBCH block comprised in the first SS/PBCH template.

In one subembodiment of the embodiment, candidate SS/PBCH blocks within half a frame are indexed in a chronologically ascending order from 0 to L−1, where L is determined by a number of the candidate SS/PBCH blocks comprised in the first SS/PBCH template.

In one subembodiment of the embodiment, a maximum number of candidate SS/PBCH blocks within half a frame is a number of candidate SS/PBCH blocks comprised in the first SS/PBCH template.

In one subembodiment of the embodiment, a maximum number of candidate SS/PBCH blocks within half a frame is a number of indexes of a first one of symbols of the candidate SS/PBCH block comprised in the first SS/PBCH template.

In one subembodiment of the embodiment, the half frame is half frame.

In one subembodiment of the embodiment, the half frame is 5 milliseconds.

In one subembodiment of the embodiment, a maximum number of SSB indexes of the first cell is a number of indexes of a first one of symbols of the candidate SS/PBCH block comprised in the first SS/PBCH template.

In one subembodiment of the embodiment, the first parameter is the L.

In one subembodiment of the embodiment, the first parameter is the L, and shared spectrum channel access is not used.

In one subembodiment of the embodiment, when L is equal to 10 and the first SCS is 15 kHz, the first parameter is 8; when L is equal to 20 and the first SCS is 30 kHz, the first parameter is 8; shared spectrum channel access is used.

In one subembodiment of the above embodiment, the symbol is an OFDM symbol.

In one embodiment, the candidate SS/PBCH is an SS/PBCH assumed to be present.

In one embodiment, the candidate SS/PBCH is an SS/PBCH with which reception or detection is attempted or synchronized.

In one embodiment, an index of a first one of symbols of a candidate SS/PBCH is determined based on a subcarrier spacing of an SS/PBCH, where index 0 corresponds to a first one of symbols of a first one of slots within half a frame; in order to support beam scanning for synchronous signals and a PBCH, synchronous signal blocks are periodically transmitted; a synchronization signal block is transmitted in the form of an SS burst set; a transmission of synchronization signal blocks within an SS burst set is completed within 5 milliseconds, which is half a frame; a location of the possible candidate synchronization signal block within 5 milliseconds is L.

In one embodiment, the first parameter is a greater one of a maximum number of SSB indexes in a first cell and a maximum number of SSB indexes in a second cell; a PCI of the second cell is the second PCI.

In one subembodiment of the embodiment, a maximum number of SSB indexes of the second cell is a number of indexes of a first one of symbols of the candidate SS/PBCH block comprised in the second SS/PBCH template of the second cell.

In one subembodiment of the embodiment, the second SS/PBCH template is determined by a subcarrier spacing and carrier frequency of the second cell.

In one subembodiment of the embodiment, the second SS/PBCH template is determined by whether the second cell uses shared spectrum access.

In one subembodiment of the embodiment, all possible values of the second SS/PBCH template are the same as all possible values of the first SS/PBCH template.

In one subembodiment of the embodiment, when a subcarrier spacing of a second cell is the same as a subcarrier spacing of the first cell, neither the first cell nor the second cell uses a shared spectrum channel for access; when a subcarrier spacing of a second cell is the same as a carrier frequency of the first cell, a maximum value of a number of SSB indexes determined by the second SS/PBCH template is equal to a maximum value of a number of SSB indexes determined by the first SS/PBCH template.

In one embodiment, the first parameter is a sum of a maximum number of SSB indexes in a first cell and a maximum number of SSB indexes in a second cell; a PCI of the second cell is the second PCI.

In one subembodiment of the embodiment, the first parameter is a smaller one between a sum of a maximum value of SSB indexes of a first cell and a maximum number of SSB indexes of a second cell and 64.

In one embodiment, the first message is used to indicate a first offset, and the first offset is a positive integer;
the first offset and a maximum number of SSB indexes of a first cell are used together to determine the first parameter;
there exists at least one reference signal index in the first reference signal index set being associated with the second PCI.

In one subembodiment of the above embodiment, the first offset is a maximum number of SSB indexes of the second cell.

In one subembodiment of the above embodiment, the first parameter is equal to a sum of a maximum number of SSB indexes of the first cell and the first offset.

In one subembodiment of the above embodiment, the first parameter is equal to a smaller value between a sum of a maximum number of SSB indexes of the first cell and the first offset and 64.

In one subembodiment of the above embodiment, Lmax=min (L+S, 64); where Lmax is the first parameter; min ( ) is an operation taking the minimum value; S is the first offset.

In one subembodiment of the above embodiment, the first offset is equal to 4.

In one subembodiment of the above embodiment, when a maximum number of SSB indexes of the first cell is equal to 4, the first offset is equal to 4.

In one subembodiment of the above embodiment, when a maximum number of SSB indexes of the first cell is equal to 8, the first offset is equal to 8.

### Embodiment 2

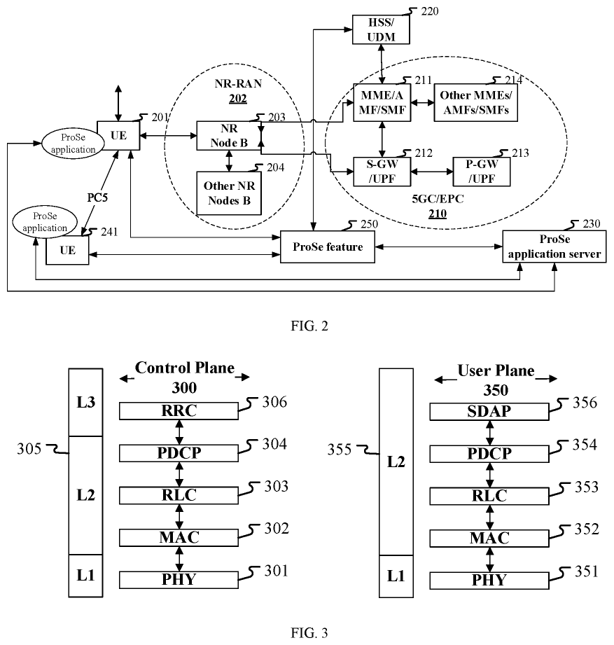

Embodiment 2 illustrates a schematic diagram of a network architecture according to one embodiment of the present application, as shown in FIG. 2. FIG. 2 is a diagram illustrating a V2X communication architecture of 5G NR, Long-Term Evolution (LTE), and Long-Term Evolution Advanced (LTE-A) systems. The 5G NR or LTE network architecture may be called a 5G System/Evolved Packet System (5GS/EPS) 200 or other appropriate terms.

The V2X communication architecture in Embodiment 2 may comprise a UE 201, a UE 241 in communication with UE 201, an NG-RAN 202, a 5G Core Network/Evolved Packet Core (5GC/EPC) 210, a Home Subscriber Server (HSS)/Unified Data Management (UDM) 220, a ProSe feature 250 and a ProSe application server 230. The V2X communication architecture may be interconnected with other access networks. For simple description, the entities/interfaces are not shown. As shown in FIG. 2, the V2X communication architecture provides packet switching services. Those skilled in the art will readily understand that various concepts presented throughout the present application can be extended to networks providing circuit switching services. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an SUNG interface. The 5GC/EPC 210 comprises a Mobility Management Entity (MME)/Authentication Management Field (AMF)/Session Management Function (SMF) 211, other MMES/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS). If near-field communication (prose) is involved, the network architecture can also comprise network elements related to near-field communications, such as ProSe function 250, Pro Se application server 230, etc. The ProSe feature 250 refers to logical functions of network-related actions needed for Proximity-based Service (ProSe), including Direct Provisioning Function (DPF), Direct Discovery Name Management Function and EPC-level Discovery ProSe Function. The ProSe application server 230 is featured with functions like storing EPC ProSe user ID, and mapping between an application-layer user ID and an EPC ProSe user ID as well as allocating ProSe-restricted code-suffix pool.

In one embodiment, the first node in the present application is a UE 201.

In one embodiment, the second node in the present application is a gNB 203.

In one embodiment, a radio link between the UE 201 and NR node B is an uplink.

In one embodiment, a radio link between NR node B and UE 201 is a downlink.

In one embodiment, the UE 201 supports relay transmission.

In one embodiment, the UE 201 supports multicast services.

In one embodiment, the UE 201 does not support relay transmission.

In one embodiment, the UE 201 supports mTRP transmission.

In one embodiment, the UE 201 is a vehicle comprising a car.

In one embodiment, the gNB 203 is a base station.

In one embodiment, the gNB 203 is a base station supports mTRP.

In one embodiment, the gNB 203 is a base station supporting broadcast multicast service.

In one embodiment, a DU of the gNB 203 manages a cell identified by the first PCI and a cell identified by the second PCI.

In one embodiment, the gNB 203 is a flight platform.

In one embodiment, the gNB 203 is satellite equipment.

### Embodiment 3

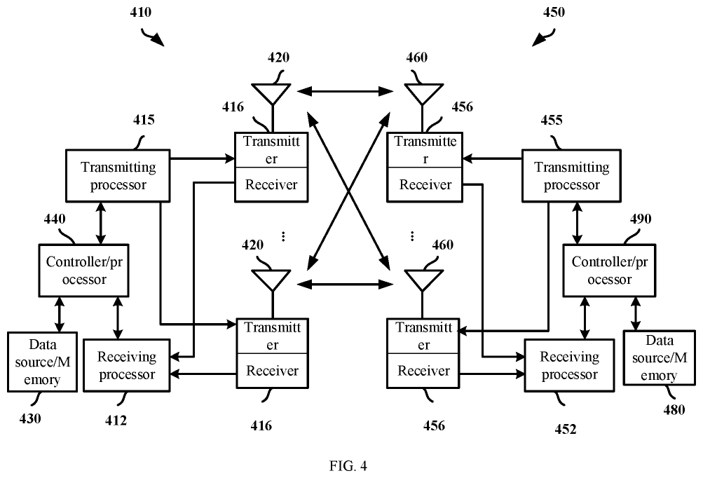

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first node (UE, gNB or a satellite or an aircraft in NTN) and a second node (gNB, UE or a satellite or an aircraft in NTN), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first node and a second node, as well as two UEs via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second node. The PDCP sublayer 304 provides multiplexing among variable radio bearers and logical channels. The PDCP sublayer 304 provides security by encrypting a packet and provides support for a first node handover between second nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second node and a first node. PC5 Signaling Protocol (PC5-S) sublayer 307 is responsible for the processing of signaling protocol at PC5 interface. The radio protocol architecture of the user plane 350 comprises layer 1 (L1) and layer 2 (L2). In the user plane 350, the radio protocol architecture for the first node and the second node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in the figure, the first node may comprise several higher layers above the L2 305. also comprises a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first message in the present application is generated by the RRC 306.

In one embodiment, the second message in the present application is generated by the RRC 306 or the MAC 302 or the PHY 301.

In one embodiment, the third message in the present application is generated by the RRC 306.

In one embodiment, the fourth message in the present application is generated by the RRC 306.

In one embodiment, the first message in the present application is generated by the RRC 306.

In one embodiment, the second message in the present application is generated by the RRC 306.

In one embodiment, the third message in the present application is generated by the RRC 306.

In one embodiment, the fourth message in the present application is generated by the RRC 306.

In one embodiment, the first message in the present application is generated by the RRC 306.

In one embodiment, the second message in the present application is generated by the RRC 306 or the MAC 302 or the PHY 301.

In one embodiment, the third message in the present application is generated by the RRC 306.

In one embodiment, the fourth message in the present application is generated by the RRC 306.

In one embodiment, the first signaling in the present application is generated by the RRC 306.

### Embodiment 4

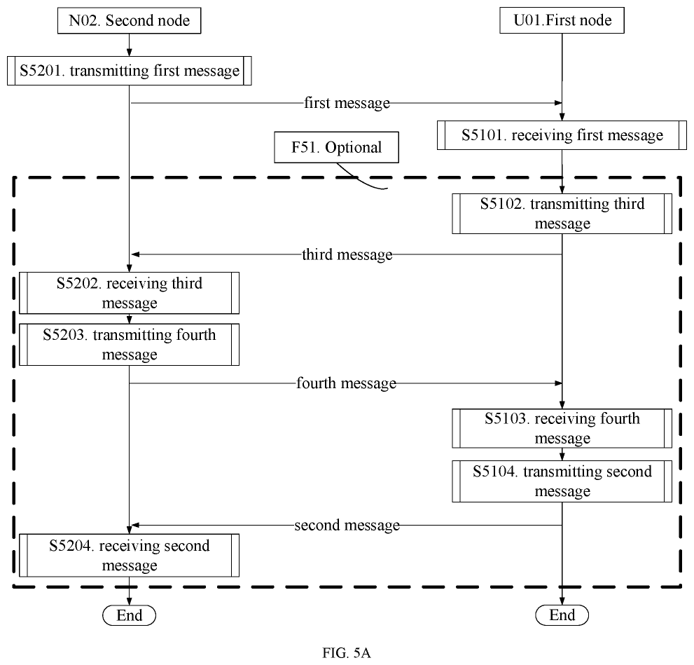

Embodiment 4 illustrates a schematic diagram of a first communication device and a second communication device in the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: receives a first message, the first message is used to indicate the first reference signal index set and the second reference signal index set; the first reference signal index set and the second reference signal index set each comprise at least one reference signal index; any reference signal index in the first reference signal index set indicates a reference signal resource; any reference signal index in the second reference signal index set indicates a reference signal resource; at least one reference signal index in the first reference signal index set is associated with a first PCI, and at least one reference signal index in the first reference signal index set is associated with a second PCI; any reference signal index in the second reference signal index set is associated with the first PCI; assesses first-type radio link quality according to at least partial reference signal resources indicated by the first reference signal index set; whenever the evaluated first-type radio link quality is worse than a first threshold, a physical layer of the first node reporting a first-type indication to a higher layer of the first node; as a response to the higher layer of the first node continuously receiving Q1 first-type indication(s), and starts the first timer, where Q1 is a positive integer; as a response to the first timer being expired, detects an RLF; assesses second-type radio link quality according to at least partial reference signal resources indicated by the second reference signal index; whenever the evaluated second-type radio link quality is worse than a second threshold, a physical layer of the first node reports a second-type indication to a higher layer of the first node; as a response to all conditions in a first condition set being satisfied, executes a first operation; herein, the first condition set comprises the higher layer of the first node continuously receiving Q2 second-type indication(s); the executing a first operation does not comprise detecting RLF; the first operation comprises generating a link observation record, or the first operation comprises transmitting a link observation record.

In one embodiment, the first communication device 450 comprises at least one processor and at least one memory. a memory that stores a computer readable instruction program. The computer readable instruction program generates an action when executed by at least one processor. The action includes: receiving a first message, the first message being used to indicate a first reference signal index set and a second reference signal index set; the first reference signal index set and the second reference signal index set each at least comprising one reference signal index; any reference signal index in the first reference signal index set indicating a reference signal resource; any reference signal index in the second reference signal index set indicating a reference signal resource; at least one reference signal index in the first reference signal index set being associated with a first PCI, and at least one reference signal index in the first reference signal index set being associated with a second PCI; any reference signal index in the second reference signal index set being associated with the first PCI; assessing first-type radio link quality according to at least partial reference signal resources indicated by the first reference signal index set; whenever the evaluated first-type radio link quality is worse than a first threshold, a physical layer of the first node reporting a first-type indication to a higher layer of the first node; as a response to the higher layer of the first node continuously receiving Q1 first-type indication(s), starting the first timer, Q1 being a positive integer; as a response to the first timer being expired, detecting RLF; assessing second-type radio link quality according to at least partial reference signal resources indicated by the second reference signal index; whenever the evaluated second-type radio link quality is worse than a second threshold, a physical layer of the first node reporting a second-type indication to a higher layer of the first node; as a response to all conditions in a first condition set being satisfied, executing a first operation; herein, the first condition set comprises the higher layer of the first node continuously receiving Q2 second-type indication(s); the executing a first operation does not comprise detecting RLF; the first operation comprises generating a link observation record, or the first operation comprises transmitting a link observation record.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: transmits a first message, the first message is used to indicate the first reference signal index set and the second reference signal index set; the first reference signal index set and the second reference signal index set each comprises at least one reference signal index; any reference signal index in the first reference signal index set indicates a reference signal resource; any reference signal index in the second reference signal index set indicates a reference signal resource; at least one reference signal index in the first reference signal index set is associated with a first PCI, and at least one reference signal index in the first reference signal index set is associated with a second PCI; any reference signal index in the second reference signal index set is associated with the first PCI; a receiver of the first message, assesses first-type radio link quality according to at least partial reference signal resources indicated by the first reference signal index set; whenever the evaluated first-type radio link quality is worse than a first threshold, a physical layer of a receiver of the first message reports a first-type indication to a higher layer of a receiver of the first message; as a response to the higher layer of a receiver of the first message continuously receiving Q1 the first-type indications, starts a first timer, Q1 being a positive integer; as a response to the first timer being expired, detects RLF; a receiver of the first message, assesses second-type radio link quality according to at least partial reference signal resources indicated by the second reference signal index; whenever the evaluated second-type radio link quality is worse than a second threshold, a physical layer of a receiver of the first message reports a second-type indication to a higher layer of a receiver of the first message; a receiver of the first message, as a response to all conditions in a first condition set being satisfied, executes a first operation; herein, the first condition set comprises the higher layer of the receiver of the first message continuously receiving Q2 second-type indication(s); the executing a first operation does not comprise detecting RLF; the first operation comprises generating a link observation record, or the first operation comprises transmitting a link observation record.

In one embodiment, the second communication device 410 comprises a memory that stores a computer readable instruction program. The computer readable instruction program generates an action when executed by at least one processor. The action includes: transmitting a first message, the first message being used to indicate a first reference signal index set and a second reference signal index set; the first reference signal index set and the second reference signal index set each at least comprising one reference signal index; any reference signal index in the first reference signal index set indicating a reference signal resource; any reference signal index in the second reference signal index set indicating a reference signal resource; at least one reference signal index in the first reference signal index set being associated with a first PCI, and at least one reference signal index in the first reference signal index set being associated with a second PCI; any reference signal index in the second reference signal index set being associated with the first PCI; a receiver of the first message, assessing first-type radio link quality according to at least partial reference signal resources indicated by the first reference signal index set; whenever the evaluated first-type radio link quality is worse than a first threshold, a physical layer of a receiver of the first message reports a first-type indication to a higher layer of a receiver of the first message; as a response to the higher layer of a receiver of the first message continuously receiving Q1 the first-type indications, starting a first timer, Q1 being a positive integer; as a response to the first timer being expired, detecting RLF; a receiver of the first message, assessing second-type radio link quality according to at least partial reference signal resources indicated by the second reference signal index; whenever the evaluated second-type radio link quality is worse than a second threshold, a physical layer of a receiver of the first message reporting a second-type indication to a higher layer of a receiver of the first message; a receiver of the first message, as a response to all conditions in a first condition set being satisfied, executing a first operation; herein, the first condition set comprises the higher layer of the receiver of the first message continuously receiving Q2 second-type indication(s); the executing a first operation does not comprise detecting RLF; the first operation comprises generating a link observation record, or the first operation comprises transmitting a link observation record.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: receives a first message, the first message is used to indicate a first radio link monitoring configuration, the first radio link monitoring configuration is used to indicate at least one reference signal index, each reference signal index in the at least one reference signal index indicates a reference signal resource; measures the reference signal resources indicated by at least partial reference signal indexes in at least one reference signal index to determine RLF; transmits a second message, the second message comprises a first RLF report; herein, the first RLF report comprises a first bitmap and a first reference signal index measurement result set; the first reference signal index measurement result set comprises K1 reference signal index(es), K1 being a positive integer; the first bitmap indicates whether any of the K1 reference signal index(es) comprised in the first reference signal index measurement result set belongs to the first radio link monitoring configuration; any reference signal index comprised in the first reference signal index measurement result set is associated with a first PCI; the first RLF report comprises a second bitmap and a second reference signal index measurement result set; the second reference signal index measurement result set comprise K2 reference signal index(es), K2 being a positive integer; the second bitmap indicates whether any of the K2 reference signal index(es) comprised in the second reference signal index measurement result set belongs to the first radio link monitoring configuration; any reference signal index comprised in the second reference signal index measurement result set is associated with a second PCI.

In one embodiment, the first communication device 450 comprises at least one processor and at least one memory. a memory that stores a computer readable instruction program. The computer readable instruction program generates an action when executed by at least one processor. The action includes: receiving a first message, the first message being used to indicate a first radio link monitoring configuration, the first radio link monitoring configuration being used to indicate at least one reference signal index, each reference signal index in the at least one reference signal index indicating a reference signal resource; measuring the reference signal resources indicated by at least partial reference signal indexes in the at least one reference signal index to determine RLF; transmitting a second message, the second message comprising a first RLF report; herein, the first RLF report comprises a first bitmap and a first reference signal index measurement result set; the first reference signal index measurement result set comprises K1 reference signal index(es), K1 being a positive integer; the first bitmap indicates whether any of the K1 reference signal index(es) comprised in the first reference signal index measurement result set belongs to the first radio link monitoring configuration; any reference signal index comprised in the first reference signal index measurement result set is associated with a first PCI; the first RLF report comprises a second bitmap and a second reference signal index measurement result set; the second reference signal index measurement result set comprise K2 reference signal index(es), K2 being a positive integer; the second bitmap indicates whether any of the K2 reference signal index(es) comprised in the second reference signal index measurement result set belongs to the first radio link monitoring configuration; any reference signal index comprised in the second reference signal index measurement result set is associated with a second PCI.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: transmits a first message, the first message is used to indicate a first radio link monitoring configuration, the first radio link monitoring configuration is used to indicate at least one reference signal index, each reference signal index in the at least one reference signal index indicates a reference signal resource; a receiver of the first message, measures the reference signal resources indicated by at least partial reference signal indexes in at least one reference signal index to determine RLF; receives a second message, the second message comprises a first RLF report; herein, the first RLF report comprises a first bitmap and a first reference signal index measurement result set; the first reference signal index measurement result set comprises K1 reference signal index(es), K1 being a positive integer; the first bitmap indicates whether any of the K1 reference signal index(es) comprised in the first reference signal index measurement result set belongs to the first radio link monitoring configuration; any reference signal index comprised in the first reference signal index measurement result set is associated with a first PCI; the first RLF report comprises a second bitmap and a second reference signal index measurement result set; the second reference signal index measurement result set comprise K2 reference signal index(es), K2 being a positive integer; the second bitmap indicates whether any of the K2 reference signal index(es) comprised in the second reference signal index measurement result set belongs to the first radio link monitoring configuration; any reference signal index comprised in the second reference signal index measurement result set is associated with a second PCI.

In one embodiment, the second communication device 410 comprises a memory that stores a computer readable instruction program. The computer readable instruction program generates an action when executed by at least one processor. The action includes: transmitting a first message, the first message being used to indicate a first radio link monitoring configuration, the first radio link monitoring configuration being used to indicate at least one reference signal index, each reference signal index in the at least one reference signal index indicating a reference signal resource; a receiver of the first message, measuring the reference signal resources indicated by at least partial reference signal indexes in the at least one reference signal index to determine RLF; receiving a second message, the second message comprising a first RLF report; herein, the first RLF report comprises a first bitmap and a first reference signal index measurement result set; the first reference signal index measurement result set comprises K1 reference signal index(es), K1 being a positive integer; the first bitmap indicates whether any of the K1 reference signal index(es) comprised in the first reference signal index measurement result set belongs to the first radio link monitoring configuration; any reference signal index comprised in the first reference signal index measurement result set is associated with a first PCI; the first RLF report comprises a second bitmap and a second reference signal index measurement result set; the second reference signal index measurement result set comprise K2 reference signal index(es), K2 being a positive integer; the second bitmap indicates whether any of the K2 reference signal index(es) comprised in the second reference signal index measurement result set belongs to the first radio link monitoring configuration; any reference signal index comprised in the second reference signal index measurement result set is associated with a second PCI.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: receives a first message, the first message is used to indicate a first reference signal index set; the first reference signal index set comprises at most L1 reference signal indexes, L1 being a positive integer greater than 1; any reference signal index in the first reference signal index set indicates a reference signals resource; assesses first-type radio link quality based on reference signal resources identified by at most L2 reference signal indexes in reference signal indexes indicated by the first reference signal index set, where L2 is a positive integer greater than 1; herein, at least one reference signal index in the first reference signal index set is associated with a first PCI; at least one of L1 or L2 depends on a first parameter, and the first parameter is related to whether there exists at least one reference signal index in the first reference signal index set being associated with a second PCI; whenever the evaluated first-type radio link quality is worse than a first threshold, a physical layer of the first node reporting a first-type indication to a higher layer of the first node; as a response to the higher layer of the first node continuously receiving Q1 first-type indication(s), the first timer is started, Q1 being a positive integer; as a response to the first timer being expired, RLF is detected.

In one embodiment, the first communication device 450 comprises at least one processor and at least one memory. a memory that stores a computer readable instruction program. The computer readable instruction program generates an action when executed by at least one processor. The action includes: receiving a first message, the first message being used to indicate a first reference signal index set; the first reference signal index set comprising at most L1 reference signal indexes, L1 being a positive integer greater than 1; any reference signal index in the first reference signal index set indicating a reference signal resource; assessing first-type radio link quality based on reference signal resources identified by at most L2 reference signal indexes in reference signal indexes indicated by the first reference signal index set, where L2 is a positive integer greater than 1; herein, at least one reference signal index in the first reference signal index set is associated with a first PCI; at least one of L 1 or L2 depends on a first parameter, and the first parameter is related to whether there exists at least one reference signal index in the first reference signal index set being associated with a second PCI; whenever the evaluated first-type radio link quality is worse than a first threshold, a physical layer of the first node reports a first-type indication to a higher layer of the first node; as a response to the higher layer of the first node continuously receiving Q1 first-type indication(s), the first timer is started, Q1 being a positive integer; as a response to the first timer being expired, RLF is detected.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: transmits a first message, the first message is used to indicate a first reference signal index set; the first reference signal index set comprises at most L1 reference signal indexes, L1 being a positive integer greater than 1; any reference signal index in the first reference signal index set indicates a reference signal resource; a receiver of the first message, assesses first-type radio link quality based on reference signal resources identified by at most L2 reference signal indexes in reference signal indexes indicated by the first reference signal index set, where L2 is a positive integer greater than 1; herein, at least one reference signal index in the first reference signal index set is associated with a first PCI; at least one of L1 or L2 depends on a first parameter, and the first parameter is related to whether there exists at least one reference signal index in the first reference signal index set being associated with a second PCI; whenever the evaluated first-type radio link quality is worse than a first threshold, a physical layer of the first node reports a first-type indication to a higher layer of the first node; as a response to the higher layer of the first node continuously receiving Q1 first-type indication(s), the first timer is started, Q1 being a positive integer; as a response to the first timer being expired, RLF is detected.

In one embodiment, the second communication device 410 comprises a memory that stores a computer readable instruction program. The computer readable instruction program generates an action when executed by at least one processor. The action includes: transmitting a first message, the first message being used to indicate a first reference signal index set; the first reference signal index set comprising at most L1 reference signal indexes, L1 being a positive integer greater than 1; any reference signal index in the first reference signal index set indicating a reference signal resource; a receiver of the first message, assessing first-type radio link quality based on reference signal resources identified by at most L2 reference signal indexes in reference signal indexes indicated by the first reference signal index set, where L2 is a positive integer greater than 1; herein, at least one reference signal index in the first reference signal index set is associated with a first PCI; at least one of L1 or L2 depends on a first parameter, and the first parameter is related to whether there exists at least one reference signal index in the first reference signal index set being associated with a second PCI; whenever the evaluated first-type radio link quality is worse than a first threshold, a physical layer of the first node reports a first-type indication to a higher layer of the first node; as a response to the higher layer of the first node continuously receiving Q1 first-type indication(s), the first timer is started, Q1 being a positive integer; as a response to the first timer being expired, RLF is detected.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a vehicle terminal.

In one embodiment, the first communication device 450 is a relay.

In one embodiment, the second communication device 410 is a base station.

In one embodiment, the receiver 456 (including the antenna 460), the receiving processor 452 and the controller/processor 490 are used to receive the first message in the present application.

In one embodiment, the receiver 456 (including the antenna 460), the receiving processor 452 and the controller/processor 490 are used to receive the fourth message in the present application.

In one embodiment, the transmitter 456 (including the antenna 460), the transmitting processor 455 and the controller/processor 490 are to transmit the second message in the present application.

In one embodiment, the transmitter 456 (including the antenna 460), the transmitting processor 455 and the controller/processor 490 are to transmit the third message in the present application.

In one embodiment, the transmitter 416 (including the antenna 420), the transmitting processor 412 and the controller/processor 440 are used to transmit the first message in the present application.

In one embodiment, the transmitter 416 (including the antenna 420), the transmitting processor 412 and the controller/processor 440 are used to transmit the fourth message in the present application.

In one embodiment, the receiver 416 (including the antenna 420), the receiving processor 412 and the controller/processor 440 are used to receive the second information in the present application.

In one embodiment, the receiver 416 (including the antenna 420), the receiving processor 412 and the controller/processor 440 are used to receive the third information in the present application.

In one embodiment, the receiver 456 (including the antenna 460), the receiving processor 452 and the controller/processor 490 are used to receive the first message in the present application.

In one embodiment, the receiver 456 (including the antenna 460), the receiving processor 452 and the controller/processor 490 are used to receive the fourth message in the present application.

In one embodiment, the transmitter 456 (including the antenna 460), the transmitting processor 455 and the controller/processor 490 are to transmit the second message in the present application.

In one embodiment, the transmitter 456 (including the antenna 460), the transmitting processor 455 and the controller/processor 490 are to transmit the third message in the present application.

In one embodiment, the transmitter 416 (including the antenna 420), the transmitting processor 412 and the controller/processor 440 are used to transmit the first message in the present application.

In one embodiment, the transmitter 416 (including the antenna 420), the transmitting processor 412 and the controller/processor 440 are used to transmit the fourth message in the present application.

In one embodiment, the receiver 416 (including the antenna 420), the receiving processor 412 and the controller/processor 440 are used to receive the second information in the present application.

In one embodiment, the receiver 416 (including the antenna 420), the receiving processor 412 and the controller/processor 440 are used to receive the third information in the present application.

In one embodiment, the receiver 456 (including the antenna 460), the receiving processor 452 and the controller/processor 490 are used to receive the first message in the present application.

In one embodiment, the receiver 456 (including the antenna 460), the receiving processor 452 and the controller/processor 490 are used to receive the fourth message in the present application.

In one embodiment, the receiver 456 (including the antenna 460), the receiving processor 452 and the controller/processor 490 are used to receive the first signaling in the present application.

In one embodiment, the transmitter 456 (including the antenna 460), the transmitting processor 455 and the controller/processor 490 are to transmit the second message in the present application.

In one embodiment, the transmitter 456 (including the antenna 460), the transmitting processor 455 and the controller/processor 490 are to transmit the third message in the present application.

In one embodiment, the transmitter 416 (including the antenna 420), the transmitting processor 412 and the controller/processor 440 are used to transmit the first message in the present application.

In one embodiment, the transmitter 416 (including the antenna 420), the transmitting processor 412 and the controller/processor 440 are used to transmit the fourth message in the present application.

In one embodiment, the transmitter 416 (including the antenna 420), the transmitting processor 412 and the controller/processor 440 are used to transmit the first signaling in the present application.

In one embodiment, the receiver 416 (including the antenna 420), the receiving processor 412 and the controller/processor 440 are used to receive the second information in the present application.

In one embodiment, the receiver 416 (including the antenna 420), the receiving processor 412 and the controller/processor 440 are used to receive the third information in the present application.

### Embodiment 5A

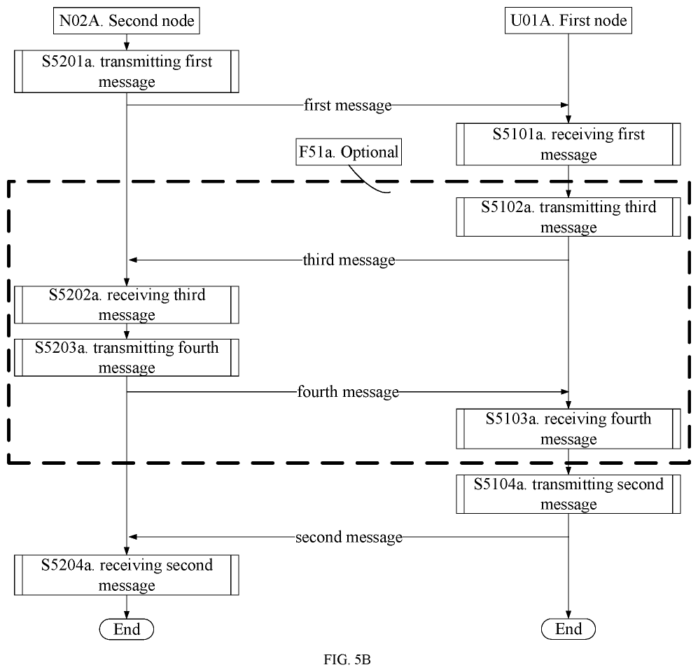

Embodiment 5A illustrates a flowchart of radio signal transmission according to one embodiment in the present application, as shown in FIG. 5. In FIG. 5A, U01 corresponds to a first node in the present application, N02 corresponds to a second node in the present application. It is particularly underlined that the order illustrated in the embodiment does not put constraints over sequences of signal transmissions and implementations and steps in F51 are optional.

The first node U01 receives a first message in step S5101; transmits a third message in step S5102; receives a fourth message in step S5103; transmits a second message in step S5104.

The second node N02 transmits a first message in step S5201; receives a third message in step S5205; transmits a fourth message in step S5203; receives a second message in step S5204.

In embodiment 5, the first message is used to indicate a first reference signal index set and a second reference signal index set; the first reference signal index set and the second reference signal index set each at least comprise one reference signal index; any reference signal index in the first reference signal index set indicates a reference signal resource; any reference signal index in the second reference signal index set indicates a reference signal resource; at least one reference signal index in the first reference signal index set is associated with a first PCI, and at least one reference signal index in the first reference signal index set is associated with a second PCI; any reference signal index in the second reference signal index set is associated with the first PCI;
the first node U01 assesses first-type radio link quality according to at least partial reference signal resources indicated by the first reference signal index set; whenever the evaluated first-type radio link quality is worse than a first threshold, a physical layer of the first node reporting a first-type indication to a higher layer of the first node; as a response to the higher layer of the first node continuously receiving Q1 first-type indication(s), starts the first timer, where Q1 is a positive integer; as a response to the first timer being expired, detects an RLF;
the first node U01 assesses second-type radio link quality according to at least partial reference signal resources indicated by the second reference signal index; whenever the evaluated second-type radio link quality is worse than a second threshold, a physical layer of the first node reporting a second-type indication to a higher layer of the first node;
the first node UOL as a response to all conditions in a first condition set being satisfied, executes a first operation;
herein, the first condition set comprises the higher layer of the first node continuously receiving Q2 second-type indication(s); the executing a first operation does not comprise detecting RLF; the first operation comprises generating a link observation record, or the first operation comprises transmitting a link observation record.

In one embodiment, the second node N02 is a serving cell of the first node U01.

In one embodiment, the second node N02 is a PCell of the first node U01.

In one embodiment, the second node N02 is an SpCell of the first node U01.

In one embodiment, the second node N02 configures transmission resources associated with a first PCI and a second PCI to the first node U01.

In one subembodiment of the above embodiment, the transmission resources are used to transmit data of user plane.

In one embodiment, the first message is transmitted by unicast.

In one embodiment, the first message is transmitted by broadcast or groupcast.

In one embodiment, the first PCI is associated with an SSB of the second node N02.

In one embodiment, the first PCI is associated with an SS/PBCH of the second node N02.

In one embodiment, the second PCI is not associated with an SSB of the second node N02.

In one embodiment, the second PCI is not associated with an SS/PBCH of the second node N02.

In one embodiment, the first PCI is QCL with at least one of SSBs of the second node N02.

In one embodiment, the first PCI is QCL with at least one of SS/PBCHs of the second node N02.

In one embodiment, the second PCI is not QCL with any of SSBs of the second node N02.

In one embodiment, the second PCI is not QCL with any of SS/PBCHs of the second node N02.

In one embodiment, the third message indicates that there is available RLF information.

In one subembodiment of the embodiment, the third message indicates that there is available RLF information by indicating that an rlf-InfoAvailable cell is true.

In one subembodiment of the embodiment, the third message indicates that there is available RLF information by carrying an rlf-InfoAvailable cell.

In one embodiment, the third message is an RRC message.

In one embodiment, the third information is used to indicate that the first operation is completed.

In one embodiment, the third information is used to indicate that a second operation is completed.

In one subembodiment of the embodiment, the third message comprises RRCSetupComplete.

In one subembodiment of the embodiment, the third message comprises RRCResumeComplete.

In one subembodiment of the embodiment, the third message comprises RRCReestablishmentComplete.

In one subembodiment of the above embodiment, the third message comprises RRCReconfigurationComplete.

In one subembodiment of the above embodiment, the second operation comprises one of RRC establishment, RRC continuation, RRC reconstruction or RRC reconfiguration.

In one embodiment, the first link failure variable is VarRLF-Report.

In one embodiment, when the first node U01 detects RLF, the first node U01 saves information about the RLF in the first link failure variable.

In one embodiment, the first node U01 determines that the third message indicates having available RLF information based on a storage of available RLF information in a first link failure variable.

In one subembodiment of the embodiment, the available RLF information is any RLF information stored in the first link failure variable.

In one subembodiment of the embodiment, the available RLF information is any undeleted RLF information.

In one subembodiment of the embodiment, the available RLF information is any available RLF information.

In one subembodiment of the embodiment, the available RLF information is latest RLF information.

In one subembodiment of the embodiment, if the first link failure variable stores available RLF information, the third message indicates having available RLF information; if the first link failure variable does not store available RLF information, the third message does not indicate having available RLF information.

In one embodiment, the fourth message indicates requesting an RLF report.

In one subembodiment of the embodiment, the fourth message indicates that there is available RLF information by indicating that an rlf-ReportReq cell is true.

In one subembodiment of the embodiment, the fourth message indicates that there is available RLF information by carrying a rlf-ReportReq cell.

In one embodiment, the fourth message comprises UEInformationRequest.

In one embodiment, the fourth message is used to trigger the second message.

In one embodiment, the second message comprises at least one of an RRC message, a MAC CE or UCI.

In one embodiment, the second message is used to indicate the link observation record.

In one embodiment, the second message comprises the link observation record.

In one embodiment, the second message comprises an rlf-report field, and the rlf-report field comprises the link observation record.

In one subembodiment of the embodiment, the second message comprises that a field within an rlf-report field comprises the link observation record.

In one subembodiment of the above embodiment, the second message comprises that a field within an rlf-report field indicates that link failure occurs in a cell identified by the first PCI.

In one subembodiment of the embodiment, the second message comprises that a bit within an rlf-report field indicates that link failure occurs in a cell identified by the first PCI.

In one subembodiment of the embodiment, the second message comprises that a bit within an rlf-report field comprises the link observation record.

In one subembodiment of the embodiment, the second message comprises that a bit within an rlf-report field indicates that there exists the link observation record.

In one embodiment, if a transmission of the second message and the second condition set being met occur during a same RRC connection process, the third message and the fourth message are not used.

In one embodiment, if a transmission of the second message and the second condition set being met occur during a same RRC connection process, the third message and the fourth message are not triggered.

In one embodiment, if a transmission of the second message and the second condition set being met occur during different RRC connection procedures, the third message and the fourth message are optional.

In one embodiment, reference signal resources corresponding to any reference signal index associated with the second PCI comprised in the at least reference signal index indicated by the first reference signal index set only comprise a CSI-RS; an SSB transmitted by the second node N02 is only associated with the first PCI instead of being associated with the second PCI.

In one embodiment, there at least exists one reference signal index in the second reference signal index set not belonging to the first reference signal index set.

In one embodiment, reference signal resources corresponding to any reference signal index associated with the second PCI comprised in the at least reference signal index indicated by the first radio link monitoring configuration only comprise an SSB; an SSB transmitted by the second node N02 is only associated with the first PCI instead of being associated with the second PCI.

In one embodiment, the second node N02 configures a TCI according to the link observation record.

In one subembodiment of the embodiment, the behavior of configuring a TCI comprises: configuring a TCI through an RRC signaling.

In one subembodiment of the embodiment, the behavior of configuring a TCI comprises: configuring a new TCI through an RRC signaling.

In one subembodiment of the embodiment, the behavior of configuring a TCI comprises: activating a TCI through a MAC CE signaling.

In one subembodiment of the embodiment, the behavior of configuring a TCI comprises: activating a TCI other than a current TCI through a MAC CE signaling.

In one subembodiment of the embodiment, the behavior of configuring a TCI comprises: activating a TCI through a DCI.

In one subembodiment of the embodiment, the behavior of configuring a TCI comprises: activating a TCI other than a current TCI through a DCI.

In one subembodiment of the embodiment, the configured TCI is a TCI other than a TCI associated with a reference signal index comprised in the first RLF report.

In one subembodiment of the embodiment, the configured TCI is associated with the first PCI.

In one embodiment, advantages of the above methods are that the base station can optimize the configuration of a TCI based on RLF reports, especially for a TCI associated with the first physical cell.

### Embodiment 5B

Embodiment 5B illustrates a flowchart of radio signal transmission according to one embodiment in the present application, as shown in FIG. 5. In FIG. 5B, U01A corresponds to a first node in the present application, N02A corresponds to a second node in the present application. It is particularly underlined that the order illustrated in the embodiment does not put constraints over sequences of signal transmissions and implementations and steps in F51 a are optional.

The first node U01A receives a first message in step S5101; transmits a third message in step S5102a; receives a fourth message in step S5103a; transmits a second message in step S5104a.

The second node N02A transmits a first message in step S5201a; receives a third message in step S5202a; transmits a fourth message in step S5203a; receives a second message in step S5204a.

In embodiment 5B, the first message is used to indicate a first radio link monitoring configuration, the first radio link monitoring configuration is used to indicate at least one reference signal index, each reference signal index in the at least one reference signal index indicates a reference signal resource; RLF is determined by measuring the reference signal resources indicated by at least partial reference signal indexes in at least one reference signal index; the second message comprises a first RLF report;
herein, the first RLF report comprises a first bitmap and a first reference signal index measurement result set; the first reference signal index measurement result set comprises K1 reference signal index(es), K1 being a positive integer; the first bitmap indicates whether any of the K1 reference signal index(es) comprised in the first reference signal index measurement result set belongs to the first radio link monitoring configuration; any reference signal index comprised in the first reference signal index measurement result set is associated with a first PCI;
the first RLF report comprises a second bitmap and a second reference signal index measurement result set; the second reference signal index measurement result set comprise K2 reference signal index(es), K2 being a positive integer; the second bitmap indicates whether any of the K2 reference signal index(es) comprised in the second reference signal index measurement result set belongs to the first radio link monitoring configuration; any reference signal index comprised in the second reference signal index measurement result set is associated with a second PCI.

In one embodiment, the second node N02A is a serving cell of the first node U01A.

In one embodiment, the second node N02A is a PCell of the first node U01A.

In one embodiment, the second node N02A is an SpCell of the first node U01A.

In one embodiment, the first message is transmitted by unicast.

In one embodiment, the first message is transmitted by broadcast or groupcast.

In one embodiment, the first PCI is associated with an SSB of the second node N02A.

In one embodiment, the first PCI is associated with an SS/PBCH of the second node N02A.

In one embodiment, the second PCI is not associated with an SSB of the second node N02A.

In one embodiment, the second PCI is not associated with an SS/PBCH of the second node N02A.

In one embodiment, the first PCI is QCL with at least one of SSBs of the second node N02A.

In one embodiment, the first PCI is QCL with at least one of SS/PBCHs of the second node N02A.

In one embodiment, the second PCI is not QCL with any of SSBs of the second node N02A.

In one embodiment, the second PCI is not QCL with any of SS/PBCHs of the second node N02A.

In one embodiment, the third message indicates that there is available RLF information.

In one subembodiment of the embodiment, the third message indicates that there is available RLF information by indicating that an rlf-InfoAvailable cell is true.

In one subembodiment of the embodiment, the third message indicates that there is available RLF information by carrying an rlf-InfoAvailable cell.

In one embodiment, the third message is an RRC message.

In one embodiment, the third information is used to indicate that a first operation is completed.

In one subembodiment of the embodiment, the third message comprises RRCSetupComplete.

In one subembodiment of the embodiment, the third message comprises RRCResumeComplete.

In one subembodiment of the embodiment, the third message comprises RRCReestablishmentComplete.

In one subembodiment of the above embodiment, the third message comprises an RRCReconfigurationComplete.

In one embodiment, the first RLF variable is VarRLF-Report.

In one embodiment, when the first node U01A detects RLF, the first node U01A saves RLF information in the first RLF variable.

In one embodiment, the first node U01A determines that the third message indicates having available RLF information based on a storage of available RLF information in a first RLF variable.

In one subembodiment of the embodiment, the available RLF information is any RLF information stored in the first RLF variable.

In one subembodiment of the embodiment, the available RLF information is any undeleted RLF information.

In one subembodiment of the embodiment, the available RLF information is any available RLF information.

In one subembodiment of the embodiment, the available RLF information is latest RLF information.

In one subembodiment of the embodiment, if the first RLF variable stores available RLF information, a third message indicates having available RLF information; if the first RLF variable does not store available RLF information, the third message does not indicate having available RLF information.

In one embodiment, the fourth message indicates requesting an RLF report.

In one subembodiment of the embodiment, the fourth message indicates that there is available RLF information by indicating that a rlf-ReportReq cell is true.

In one subembodiment of the embodiment, the fourth message indicates that there is available RLF information by carrying a rlf-ReportReq cell.

In one embodiment, the fourth message comprises UEInformationRequest.

In one embodiment, a fourth message is used to trigger the second message.

In one embodiment, any reference signal index indicated by the first radio link monitoring configuration is only associated with one of the first PCI and the second PCI.

In one subembodiment of the above embodiment, any reference signal index indicated by the first radio link monitoring configuration is only associated with the first PCI instead of the second PCI.

In one subembodiment of the above embodiment, any reference signal index indicated by the first radio link monitoring configuration is only associated with the second PCI instead of being associated with the first PCI.

In one embodiment, reference signal resources corresponding to any reference signal index associated with the second PCI comprised in the at least reference signal index indicated by the first radio link monitoring configuration only comprise a CSI-RS; an SSB transmitted by the second node N02A is only associated with the first PCI instead of being associated with the second PCI.

In one embodiment, reference signal resources corresponding to any reference signal index associated with the second PCI comprised in the at least one reference signal index indicated by the first radio link monitoring configuration only comprise an SSB; an SSB transmitted by the second node N02A is only associated with the first PCI instead of being associated with the second PCI.

In one embodiment, the second node N02A configures a TCI according to the first RLF report.

In one subembodiment of the embodiment, the behavior of configuring a TCI comprises: configuring a TCI through an RRC signaling.

In one subembodiment of the embodiment, the behavior of configuring a TCI comprises: configuring a new TCI through an RRC signaling.

In one subembodiment of the embodiment, the behavior of configuring a TCI comprises: activating a TCI through a MAC CE signaling.

In one subembodiment of the embodiment, the behavior of configuring a TCI comprises: activating a TCI other than a current TCI through a MAC CE signaling.

In one subembodiment of the embodiment, the behavior of configuring a TCI comprises: activating a TCI through a DCI.

In one subembodiment of the embodiment, the behavior of configuring a TCI comprises: activating a TCI other than a current TCI through a DCI.

In one subembodiment of the embodiment, the configured TCI is a TCI other than a TCI associated with a reference signal index comprised in the first RLF report.

In one subembodiment of the embodiment, the configured TCI is associated with the second PCI.

In one embodiment, advantages of the above methods are that the base station can optimize the configuration of a TCI based on RLF reports, especially for a TCI associated with the second physical cell.

### Embodiment 5C

Embodiment 5C illustrates a flowchart of radio signal transmission according to one embodiment in the present application, as shown in FIG. 5. In FIG. 5C, U01B corresponds to a first node in the present application, N02B corresponds to a second node in the present application. It is particularly underlined that the order illustrated in the embodiment does not put constraints over sequences of signal transmissions and implementations and steps in F51 b are optional.

The first node U01B receives a first message in step S5101b; transmits a third message in step S5102b; receives a fourth message in step S5103b; transmits a second message in step S5104b.

The second node N02B transmits a first message in step S5201b; receives a third message in step S5205b; transmits a fourth message in step S5203b; receives a second message in step S5204b.

In embodiment 5C, the first message is used to indicate a first reference signal index set; the first reference signal index set comprises at most L1 reference signal indexes, L1 being a positive integer greater than 1; any reference signal index in the first reference signal index set indicates a reference signal resource; the first node U01B assesses first-type radio link quality based on reference signal resources identified by at most L2 reference signal indexes in reference signal indexes indicated by the first reference signal index set, where L2 is a positive integer greater than 1;
herein, at least one reference signal index in the first reference signal index set is associated with a first PCI;
at least one of L1 or L2 depends on a first parameter, and the first parameter is related to whether there exists at least one reference signal index in the first reference signal index set being associated with a second PCI; whenever the evaluated first-type radio link quality is worse than a first threshold, a physical layer of the first node U01B reports a first-type indication to a higher layer of the first node U01B; as a response to the higher layer of the first node U01B continuously receiving Q1 the first-type indications, a first timer is started, Q1 being a positive integer; as a response to the first timer being expired, RLF is detected.

In one embodiment, the second node N02B is a serving cell of the first node U01B.

In one embodiment, the second node N02B is a PCell of the first node U01B.

In one embodiment, the second node N02B is an SpCell of the first node U01B.

In one embodiment, the second node N02B configures transmission resources associated with a first PCI and a second PCI to the first node U01B.

In one subembodiment of the above embodiment, the transmission resources are used to transmit data of user plane.

In one embodiment, the first message is transmitted by unicast.

In one embodiment, the first message is transmitted by broadcast or groupcast.

In one embodiment, the first PCI is associated with an SSB of the second node N02B.

In one embodiment, the first PCI is associated with an SS/PBCH of the second node N02B.

In one embodiment, the second PCI is not associated with an SSB of the second node N02B.

In one embodiment, the second PCI is not associated with an SS/PBCH of the second node N02B.

In one embodiment, the first PCI is QCL with at least one of SSBs of the second node N02B.

In one embodiment, the first PCI is QCL with at least one of SSs/PBCHs of the second node N02B.

In one embodiment, the second PCI is not QCL with any of SSBs of the second node N02B.

In one embodiment, the second PCI is not QCL with either of SSs/PBCHs of the second node N02B.

In one embodiment, the first node U01B detects RLF.

In one embodiment, as a response to the behavior of detecting RLF, the first node U01B generates a link observation record.

In one subembodiment of the above embodiment, the link observation record comprises information of link failure.

In one subembodiment of the above embodiment, the link observation record comprises the first radio link quality.

In one embodiment, the fourth message indicates requesting RLF information; the first node U01B stores information of RLF according to state variable; the fourth message is used to trigger a second message; the third message is used to indicate a completion of a first operation; the second message is used to indicate information of the RLF.

In one subembodiment of the embodiment, the state variable is a first link failure variable.

In one embodiment, the third message indicates that there is available RLF information.

In one subembodiment of the embodiment, the third message indicates that there is available RLF information by indicating that an rlf-InfoAvailable cell is true.

In one subembodiment of the embodiment, the third message indicates that there is available RLF information by carrying an rlf-InfoAvailable cell.

In one embodiment, the third message is an RRC message.

In one embodiment, the third information is used to indicate that the first operation is completed.

In one embodiment, the third information is used to indicate that the second operation is completed.

In one subembodiment of the embodiment, the third message comprises RRCSetupComplete.

In one subembodiment of the embodiment, the third message comprises RRCResumeComplete.

In one subembodiment of the embodiment, the third message comprises RRCReestablishmentComplete.

In one subembodiment of the above embodiment, the third message comprises RRCReconfigurationComplete.

In one subembodiment of the above embodiment, the second operation comprises one of RRC establishment, RRC continuation, RRC reconstruction or RRC reconfiguration.

In one embodiment, the first link failure variable is VarRLF-Report.

In one embodiment, when the first node U01B detects RLF, the first node U01B saves information about the RLF in the first link failure variable.

In one embodiment, the first node U01B determines that the third message indicates having available RLF information based on a storage of available RLF information in a first link failure variable.

In one subembodiment of the embodiment, the available RLF information is any RLF information stored in the first link failure variable.

In one subembodiment of the embodiment, the available RLF information is any undeleted RLF information.

In one subembodiment of the embodiment, the available RLF information is any available RLF information.

In one subembodiment of the embodiment, the available RLF information is latest RLF information.

In one subembodiment of the embodiment, if the first link failure variable stores available RLF information, the third message indicates having available RLF information; if the first link failure variable does not store available RLF information, the third message does not indicate having available RLF information.

In one embodiment, the fourth message indicates requesting an RLF report.

In one subembodiment of the embodiment, the fourth message indicates that there is available RLF information by indicating that a rlf-ReportReq cell is true.

In one subembodiment of the embodiment, the fourth message indicates that there is available RLF information by carrying a rlf-ReportReq cell.

In one embodiment, the fourth message comprises UEInformationRequest.

In one embodiment, the fourth message is used to trigger the second message.

In one embodiment, the second message comprises at least one of an RRC message, a MAC CE or UCI.

In one embodiment, the second message is used to indicate the link observation record.

In one embodiment, the second message comprises the link observation record.

In one embodiment, the second message comprises an rlf-report field, and the rlf-report field comprises the link observation record.

In one subembodiment of the embodiment, the second message comprises that a field within an rlf-report field comprises the link observation record.

In one subembodiment of the above embodiment, the second message comprises that a field within an rlf-report field indicates that link failure occurs in a cell identified by the first PCI.

In one subembodiment of the embodiment, the second message comprises that a bit within an rlf-report field indicates link failure occurring in a cell identified by the first PCI.

In one subembodiment of the embodiment, the second message comprises that a bit within an rlf-report field comprises the link observation record.

In one subembodiment of the embodiment, the second message comprises that a bit within an rlf-report field indicates that there exists the link observation record.

In one embodiment, reference signal resources identified by any reference signal index associated with the second PCI in the first reference signal index set only comprise a CSI-RS; an SSB transmitted by the second node N02B is only associated with the first PCI and not associated with the second PCI.

In one embodiment, there at least exists one reference signal index in the second reference signal index set not belonging to the first reference signal index set.

In one embodiment, reference signal resources corresponding to any reference signal index associated with the second PCI comprised in the at least reference signal index indicated by the first radio link monitoring configuration only comprise an SSB; an SSB transmitted by the second node N02B is only associated with the first PCI and not associated with the second PCI.

In one embodiment, the second node N02B configures a TCI according to the link observation record.

In one subembodiment of the embodiment, the behavior of configuring a TCI comprises: configuring a TCI through an RRC signaling.

In one subembodiment of the embodiment, the behavior of configuring a TCI comprises: configuring a new TCI through an RRC signaling.

In one subembodiment of the embodiment, the behavior of configuring a TCI comprises: activating a TCI through a MAC CE signaling.

In one subembodiment of the embodiment, the behavior of configuring a TCI comprises: activating a TCI other than a current TCI through a MAC CE signaling.

In one subembodiment of the embodiment, the behavior of configuring a TCI comprises: activating a TCI through a DCI.

In one subembodiment of the embodiment, the behavior of configuring a TCI comprises: activating a TCI other than a current TCI through a DCI.

In one subembodiment of the embodiment, the configured TCI is a TCI other than a TCI associated with a reference signal index comprised in the first RLF report.

In one subembodiment of the embodiment, the configured TCI is associated with the first PCI.

In one embodiment, advantages of the above methods are that the base station can optimize the configuration of a TCI based on an RLF report, especially for a TCI associated with a first physical cell.

### Embodiment 6A

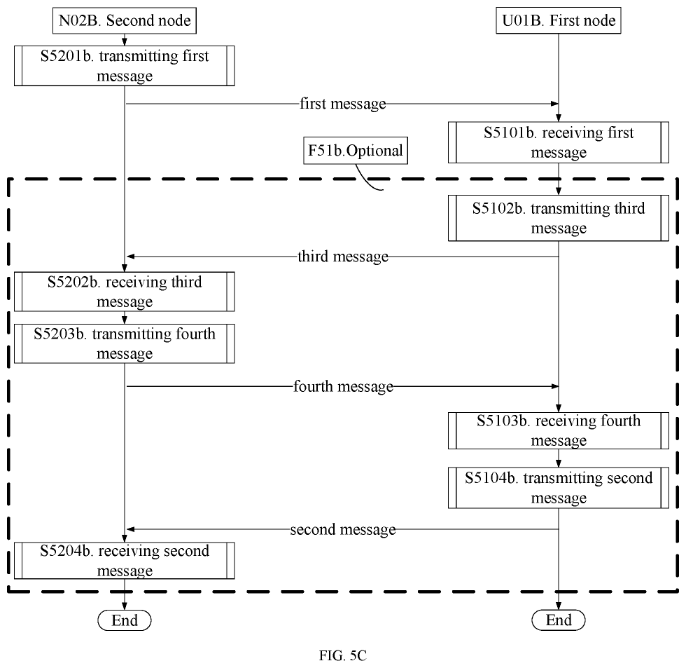

Embodiment 6A illustrates a schematic diagram of a first bitmap indicating whether a reference signal index belongs to the first radio link monitoring configuration according to one embodiment of the present application, as shown in FIG. 6A.

In one embodiment, a serving cell of the first node indicates the first radio link monitoring configuration.

In one subembodiment of the embodiment, the first radio link monitoring configuration comprises RadioLinkMonitoringConfig.

In one subembodiment of the embodiment, the first radio link monitoring configuration comprises the first reference signal index set.

In one subembodiment of the embodiment, the first message comprises the first radio link monitoring configuration.

In one embodiment, the behavior of transmitting a link observation record comprises transmitting the first bitmap, and the first bitmap is used to indicate whether a reference signal index in the link observation record belongs to the first radio link monitoring configuration.

In one embodiment, the first reference signal index belongs to the link observation record.

In one embodiment, the first reference signal index is any reference signal index comprised in the link observation record.

In one embodiment, the first reference signal index belongs to a reference signal index comprised in the link observation record.

In one embodiment, the link observation record comprises K1 reference signal index(es).

In one subembodiment of the above embodiment, the K1 reference signal index(es) comprised in the link observation record belongs (belong) to the second reference signal index set.

In one subembodiment of the above embodiment, at least one of the K1 reference signal index(es) comprised in the link observation record does not belong to the second reference signal index set.

In one subembodiment of the above embodiment, the K1 reference signal index(es) comprised in the link observation record belongs (belong) to the first reference signal index set.

In one subembodiment of the above embodiment, at least one of the K1 reference signal index(es) comprised in the link observation record does not belong to the first reference signal index set.

In one subembodiment of the above embodiment, the link observation records comprise K1 measurement result(s), and the K1 measurement result(s) corresponds (respectively correspond) to the K1 reference signal index(es).

In one subembodiment of the above embodiment, the link observation records comprise K1 measurement result(s), and the K1 measurement result(s) is(are) measurement result(s) on reference signal resources identified by the K1 reference signal index(es).

In one subembodiment of the above embodiment, the link observation records comprise K1 measurement result(s), and the K1 measurement result(s) is(are) assessment result(s) on reference signal resources identified by the K1 reference signal index(es).

In one embodiment, the first bitmap in FIG. 6A comprises n bits, namely b₀, b₁, b₂, . . . , bᵢ, bᵢ₊₁, bₙ₋₁.

In one subembodiment of the above embodiment, the n bits of the first bitmap may be arranged in row similar to that of the FIG. 6A, or may be arranged in other arrangements, such as columns, or need not be arranged at all.

In one subembodiment of the above embodiment, n is a positive integer.

In one subembodiment of the above embodiment, n is one of 64 or 96.

In one subembodiment of the above embodiment, n is one of 128 or 192.

In one subembodiment of the above embodiment, b is any bit in a first bitmap in FIG. 6A, i being any integer between 0 and n−1, and i can be equal to 0 or n−1; an index value of the first reference signal index is i.

In one subembodiment of the above embodiment, a value of any bit, bᵢ, in a first bitmap in FIG. 6A is 0, indicating that a reference signal index with an index value of i in a reference signal index comprised in the link observation record does not belong to the first radio link monitoring configuration; a value of any bit, bᵢ, in a first bitmap in FIG. 6A is 1, indicating that a reference signal index with an index value of i in a reference signal index comprised in the link observation record belongs to the first radio link monitoring configuration.

In one subembodiment of the above embodiment, a value of any bit, bᵢ, in a first bitmap in FIG. 6A is 1, indicating that a reference signal index with an index value of i in a reference signal index comprised in the link observation record does not belong to the first radio link monitoring configuration; a value of any bit, bᵢ, in a first bitmap in FIG. 6A is 0, indicating that a reference signal index with an index value of i in a reference signal index comprised in the link observation record belongs to the first radio link monitoring configuration.

In one subembodiment of the above embodiment, a value of any bit, bᵢ, in a first bitmap in FIG. 6A is 0, indicating that a reference signal index with an index value of i in a reference signal index comprised in the second reference signal index set does not belong to the first radio link monitoring configuration; a value of any bit, bᵢ, in a first bitmap in FIG. 6A is 1, indicating that a reference signal index with an index value of i in a reference signal index comprised in the second reference signal index set belongs to the first radio link monitoring configuration.

In one subembodiment of the above embodiment, a value of any bit, bᵢ, in a first bitmap in FIG. 6A is 1, indicating that a reference signal index with an index value of i in a reference signal index comprised in the second reference signal index set does not belong to the first radio link monitoring configuration; a value of any bit, bᵢ, in a first bitmap in FIG. 6A is 0, indicating that a reference signal index with an index value of i in a reference signal index comprised in the second reference signal index set belongs to the first radio link monitoring configuration.

In one embodiment, advantages of the above method comprise: the link observation record may report richer content, for example comprising measurement results on multiple reference signal resources, these reference signal resources may or may not belong exclusively to reference signal resources identified by the reference signal index in the radio link monitoring configuration; this is beneficial for the base station to assess link observation records, assess whether a reference signal index configured by radio link monitoring configuration is reasonable, and thus optimizing the network.

### Embodiment 6B

Embodiment 6B illustrates a schematic diagram of a bitmap indicating whether a reference signal index belonging to the first radio link monitoring configuration according to one embodiment of the present application, as shown in FIG. 6B.

In one embodiment, a bitmap in FIG. 6B is the first bitmap in the present application.

In one embodiment, a bitmap in FIG. 6B is the second bitmap in the present application.

In one embodiment, a bitmap in FIG. 6B is the third bitmap in the present application.

In one embodiment, a reference signal index in FIG. 6B is applicable to any reference signal index in the K1 reference signal index(es) comprised in the first reference signal index measurement result set in the present application.

In one embodiment, a reference signal index in FIG. 6B is applicable to any reference signal index in the K2 reference signal index(es) comprised in the second reference signal index measurement result set in the present application.

In one embodiment, a reference signal index in FIG. 6B is applicable to any reference signal index in the K3 reference signal index(es) comprised in the third reference signal index measurement result set in the present application.

In one embodiment, a bitmap in FIG. 6B is the first bitmap in the present application, a bitmap in FIG. 6B indicates whether any of the K1 reference signal index(es) comprised in the first reference signal index measurement result set belongs to the first radio link monitoring configuration.

In one embodiment, a bitmap in FIG. 6B is the second bitmap in the present application, a bitmap in FIG. 6B indicates whether any of the K2 reference signal index(es) comprised in the second reference signal index measurement result set belongs to the first radio link monitoring configuration.

In one embodiment, a bitmap in FIG. 6B is the third bitmap in the present application, a bitmap in FIG. 6B indicates whether any of the K3 reference signal index(es) comprised in the third reference signal index measurement result set belongs to the first radio link monitoring configuration.

In one embodiment, the bitmap in FIG. 6B comprises n bits, namely b₀, b₁, b₂, . . . , bᵢ, bᵢ₊₁, bₙ₋₁.

In one subembodiment of the above embodiment, the n bits of the bitmap may be arranged in rows similar to that of the FIG. 6B, or may be arranged in other arrangements, such as columns, or need not be arranged at all.

In one subembodiment of the above embodiment, n is a positive integer.

In one subembodiment of the above embodiment, n is one of 64 or 96.

In one subembodiment of the above embodiment, n is one of 128 or 192.

In one subembodiment of the above embodiment, a value of any bit, bᵢ, in the bitmap in FIG. 6B is 0, indicating that a reference signal index with index value i among the K1 reference signal indexes comprised in the first reference signal index measurement result set does not belong to the first radio link monitoring configuration; a value of any bit, bᵢ, in the bitmap in FIG. 6B is 1, indicating that a reference signal index with index value i among the K1 reference signal indexes comprised in the first reference signal index measurement result set belongs to the first radio link monitoring configuration; a bitmap in FIG. 6B is the first bitmap.

In one subembodiment of the above embodiment, a value of any bit, bᵢ, in the bitmap in FIG. 6B is 1, indicating that a reference signal index with index value i among the K1 reference signal indexes comprised in the first reference signal index measurement result set does not belong to the first radio link monitoring configuration; a value of any bit, bᵢ, in the bitmap in FIG. 6B is 0, indicating that a reference signal index with index value i among the K0 reference signal indexes comprised in the first reference signal index measurement result set belongs to the first radio link monitoring configuration; a bitmap in FIG. 6B is the first bitmap.

In one subembodiment of the above embodiment, a value of any bit, bᵢ, in the bitmap in FIG. 6B is 0, indicating that a reference signal index with index value i among the K2 reference signal index(es) comprised in the second reference signal index measurement result set does not belong to the first radio link monitoring configuration; a value of any bit, bᵢ, in the bitmap in FIG. 6B is 1, indicating that a reference signal index with index value i among the K2 reference signal index(es) comprised in the second reference signal index measurement result set belongs to the first radio link monitoring configuration; a bitmap in FIG. 6B is the second bitmap.

In one subembodiment of the above embodiment, a value of any bit, bᵢ, in the bitmap in FIG. 6B is 1, indicating that a reference signal index with index value i among the K2 reference signal index(es) comprised in the second reference signal index measurement result set does not belong to the first radio link monitoring configuration; a value of any bit, bᵢ, in the bitmap in FIG. 6B is 0, indicating that a reference signal index with index value i among the K2 reference signal index(es) comprised in the second reference signal index measurement result set belongs to the first radio link monitoring configuration; a bitmap in FIG. 6B is the first bitmap.

In one subembodiment of the above embodiment, a value of any bit, bᵢ, in the bitmap in FIG. 6B is 0, indicating that a reference signal index with index value i among the K3 reference signal index(es) comprised in the third reference signal index measurement result set does not belong to the first radio link monitoring configuration; a value of any bit, bᵢ, in the bitmap in FIG. 6B is 1, indicating that a reference signal index with index value i among the K3 reference signal index(es) comprised in the third reference signal index measurement result set belongs to the first radio link monitoring configuration; a bitmap in FIG. 6B is the third bitmap.

In one subembodiment of the above embodiment, a value of any bit, bᵢ, in the bitmap in FIG. 6B is 1, indicating that a reference signal index with index value i among the K3 reference signal index(es) comprised in the third reference signal index measurement result set does not belong to the first radio link monitoring configuration; a value of any bit, bᵢ, in the bitmap in FIG. 6B is 0, indicating that a reference signal index with index value i among the K3 reference signal index(es) comprised in the third reference signal index measurement result set belongs to the first radio link monitoring configuration; a bitmap in FIG. 6B is the first bitmap.

In one subembodiment of the above embodiment, i is any integer between 0 and n−1.

In one embodiment, the meaning of the phrase of belonging to the first radio link monitoring configuration comprises: belonging to the at least one reference signal index indicated by the first radio link monitoring configuration.

In one subembodiment of the embodiment, the meaning of not belonging to the first radio link monitoring configuration comprises: not belonging to the at least one reference signal index indicated by the first radio link monitoring configuration.

In one embodiment, the meaning of the phrase of belonging to the first radio link monitoring configuration comprises: being one of the at least one reference signal index indicated by the first radio link monitoring configuration.

In one subembodiment of the embodiment, the meaning of not belonging to the first radio link monitoring configuration comprises: not being any reference signal index in the at least one reference signal index indicated by the first radio link monitoring configuration.

### Embodiment 6C

Embodiment 6C illustrates a schematic diagram of a reference signal index identifying reference signal resources according to one embodiment of the present application, as shown in FIG. 6C.

In one embodiment, a reference signal index in FIG. 6C is any reference signal index in the first reference signal index set.

In one embodiment, reference signal resources in FIG. 6C are reference signal resources identified by a reference signal index in the first reference signal index set.

In one embodiment, reference signal resources identified by a reference signal index in the first reference signal index set is reference signal resources in FIG. 6C.

In one embodiment, reference signal resources in FIG. 6C are an SSB.

In one embodiment, reference signal resources in FIG. 6C are resources occupied by an SS/PBCH.

In one embodiment, reference signal resources in FIG. 6C are CSI-RS resources.

In one embodiment, reference signal resources in FIG. 6C are NZP-CSI-RS-Resource.

In one embodiment, reference signal resources in FIG. 6C are resources indicated by NZP-CSI-RS-Re source.

In one embodiment, reference signal resources in FIG. 6C are resources indicated by CSI-RS-ResourceMapping of NZP-CSI-RS-Resource.

In one embodiment, reference signal resources in FIG. 6C are NZP-CSI-RS-ResourceSet.

In one embodiment, any reference signal index comprised in the first reference signal index set is an index of an SSB.

In one embodiment, any reference signal index comprised in the first reference signal index set is an index of a csi-rs.

In one embodiment, any reference signal index comprised in the first reference signal index set is ZP-CSI-RS-ResourceSetId.

In one embodiment, any reference signal index comprised in the first reference signal index set is CSI-ResourceConfigId.

In one embodiment, any reference signal index comprised in the first reference signal index set is CSI-SSB-ResourceSetId.

In one embodiment, any reference signal index comprised in the first reference signal index set is CSI-IM-Re source Send.

In one embodiment, there exists a one-to-one corresponding relation between a reference signal index in the FIG. 6C and the reference signal resource.

In one embodiment, a serving cell of the first node is configured with reference signal resources in FIG. 6C and a reference signal index corresponding to the reference signal resource.

In one embodiment, a serving cell of the first node is configured with a reference signal index in FIG. 6C and reference signal resources identified by the reference signal index.

In one embodiment, a serving cell of the first node is configured with any reference signal index in the first reference signal index set and reference signal resources identified by the any reference signal index in the first reference signal index set.

In one embodiment, reference signal resources in FIG. 6C comprise time-domain resources.

In one embodiment, reference signal resources in FIG. 6C comprise frequency-domain resources.

In one embodiment, reference signal resources in FIG. 6C comprise spatial-domain resources.

### Embodiment 7A

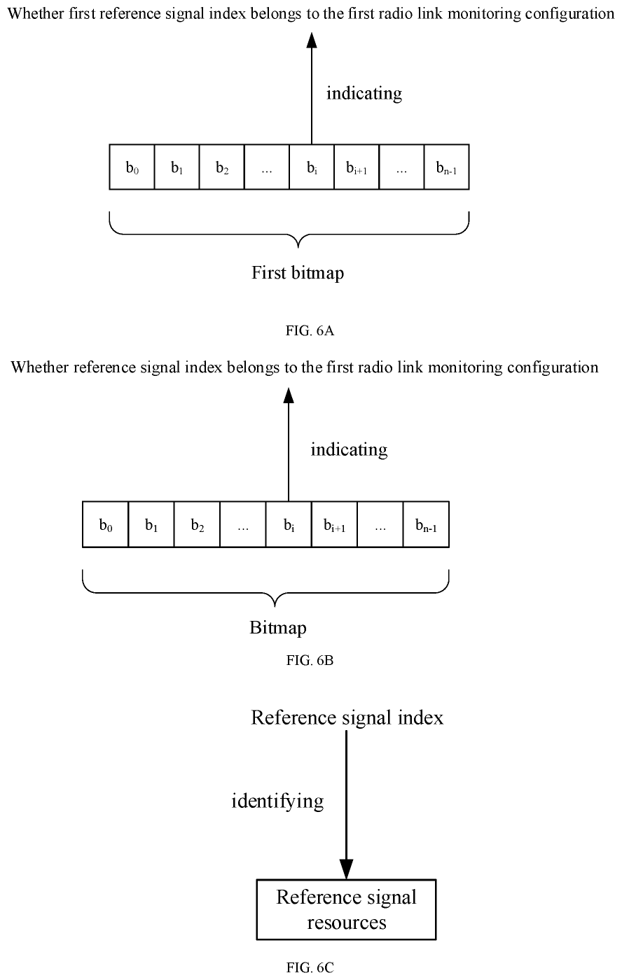

Embodiment 7A illustrates a schematic diagram of a first link failure variable according to one embodiment of the present application, as shown in FIG. 7A.

In one embodiment, as a response to the behavior of detecting RLF, the first node stores link failure information in a first link failure variable;
herein, the first RLF report comprises the link failure information stored in the first link failure variable.

In one embodiment, the behavior of detecting RLF comprises, the first node storing link failure information in the first link failure variable;
herein, the first RLF report comprises the link failure information stored in the first link failure variable.

In one embodiment, the first node transmits the first RLF report to the network.

In one embodiment, the first node generates the first RLF report according to the first link failure variable.

In one embodiment, the first RLF report comprises an Rlf-Report-r16 sub-item.

In one subembodiment of the embodiment, the Rlf-Report-r16 sub-item comprises the link failure information.

In one embodiment, the first RLF report comprises a Plmn-IdentityList-r16 sub-item.

In one subembodiment of the embodiment, the Plmn-IdentityList-r16 sub-item comprises not exceeding 16 PLMN-Identities.

In one embodiment, the first node sets a value of rlf-Report in the first link failure variable as an rlf-Report field in the second message.

In one embodiment, the first node sets a value of an Rlf-Report-r16 sub-item in the first link failure variable as an rlf-Report field in the second message.

In one embodiment, the first node sets an rlf-Report field in the second message according to a value of rlf-Report in the first link failure variable.

In one embodiment, an rlf-Report field of the second message comprises the first RLF report.

In one embodiment, an rlf-Report field of the second message is the first RLF report.

In one embodiment, the link observation record is stored in an Rlf-Report-r16 sub-item of the first link failure report.

In one embodiment, the link observation record is stored in an xxx-Report sub-item of the first link failure report.

In one subembodiment of the embodiment, “xxx” in the xxx Report sub-item is a temporary name, and “xxx” can also be named with other names.

In one subembodiment of the embodiment, the xxx-Report sub-item can also be appended with a version number, such as named xxx Report-r17 or xxx Report-r18.

In one embodiment, the first link failure variable is used to generate a second message.

In one subembodiment of the embodiment, a first field of the second message is set as the “xxx-Report” of the first link failure variable.

In one subembodiment of the embodiment, a first field in the second message comprises at least partial information in the “xxx-Report” in the first link failure variable.

In one subembodiment of the embodiment, a first field in the second message indicates whether the link observation record is saved in the first link failure variable.

In one subembodiment of the embodiment, a first field in the second message indicates whether the first link variable comprises the xxx-Report sub-item.

In one subembodiment of the embodiment, a first field in the second message indicates the first PCI, which identifies that there exists a link observation record associated with the first PCI.

In one subembodiment of the embodiment, a first field in the second message indicates that the first condition set is satisfied.

In one subembodiment of the embodiment, a first field in the second message indicates that the first condition set is satisfied.

In one subembodiment of the embodiment, a first field in the second message indicates that the higher layer of the first node continuously receives at least Q2 second-type indication(s).

In one embodiment, the first field of the second message indicates the link observation record.

In one embodiment, the behavior of transmitting a link observation record comprises that the transmitted second message comprises the first field.

### Embodiment 7B

Embodiment 7B illustrates a schematic diagram of a first RLF variable according to one embodiment of the present application, as shown in FIG. 7B.

In one embodiment, as a response to the behavior of determining RLF, the first node stores link failure information in a first radio link failure variable;
herein, the first RLF report comprises the link failure information stored in the first RLF variable.

In one embodiment, the first node generates the first RLF report according to the first RLF variable.

In one embodiment, the first RLF report comprises an Rlf-Report-r16 sub-item.

In one subembodiment of the embodiment, the Rlf-Report-r16 sub-item comprises the link failure information.

In one embodiment, the first RLF report comprises a Plmn-IdentityList-r16 sub-item.

In one subembodiment of the embodiment, the Plmn-IdentityList-r16 sub-item comprises not exceeding 16 PLMN-Identities.

In one embodiment, the first node sets a value of rlf-Report in the first RLF variable as an rlf-Report field in the second message.

In one embodiment, the first node sets a value of an Rlf-Report-r16 sub-item in the first RLF variable as an rlf-Report field in the second message.

In one embodiment, the first node sets an rlf-Report field in the second message according to a value of rlf-Report in the first RLF variable.

In one embodiment, an rlf-Report field of the second message comprises the first RLF report.

In one embodiment, an rlf-Report field of the second message is the first RLF report.

### Embodiment 7C

Embodiment 7C illustrates a schematic diagram of a first parameter, L1 and L2 according to one embodiment of the present application, as shown in FIG. 7C.

In one embodiment, FIG. 7C illustrates a mapping relation between the first parameter and L1.

In one embodiment, FIG. 7C illustrates a mapping relation between the first parameter and L2.

In one embodiment, a value range of the first parameter is 4, 8 and 64.

In one subembodiment of the above embodiment, Y1 is equal to 4.

In one subembodiment of the above embodiment, Y2 is equal to 8.

In one subembodiment of the above embodiment, Y3 is equal to 64.

In one embodiment, a value range of the L1 is 2, 6 and 8.

In one subembodiment of the above embodiment, A1 is equal to 2.

In one subembodiment of the above embodiment, A2 is equal to 6.

In one subembodiment of the above embodiment, A3 is equal to 8.

In one embodiment, a value range of the L2 is 2, 4 and 8.

In one subembodiment of the above embodiment, B1 is equal to 2.

In one subembodiment of the above embodiment, B2 is equal to 4.

In one subembodiment of the above embodiment, B3 is equal to 8.

In one embodiment, when there does not exist a reference signal index in the first reference signal index set being associated with the second PCI, any reference signal index in the first reference signal index set is associated with a PCI other than the second PCI.

In one embodiment, when there does not exist a reference signal index in the first reference signal index set being associated with the second PCI, any reference signal index in the first reference signal index set is associated with the first PCI.

In one embodiment, when there exists at least one reference signal index in the first reference signal index set being associated with the second PCI, there exists a first mapping relation between the first parameter and the L1;

when there does not exist a reference signal index in the first reference signal index set being associated with the second PCI, there exists a second mapping relation between the first parameter and the L1;
the first mapping relation is different from the second mapping relation.

In one embodiment, a mapping relation between the first parameter and L1 shown in FIG. 7C is the first mapping relation.

In one embodiment, a mapping relation between the first parameter and L2 shown in FIG. 7C is the second mapping relation.

In one embodiment, a value of L1 obtained through the first parameter and the first mapping relation is not greater than a value of L1 obtained through the first parameter and the second mapping relation.

In one embodiment, a value of L2 obtained through the first parameter and the third mapping relation is not greater than a value of L2 obtained through the first parameter and the fourth mapping relation.

In one embodiment, when there does not exist a reference signal index in the first reference signal index set being associated with the second PCI and value Y1 of the first parameter is equal to 4, value A1 of the L1 is equal to 2;
when there exists at least one reference signal index in the first reference signal index set being associated with the second PCI and value Y1 of the first parameter is equal to 4, value A1 of the L1 is greater than 2;

In one subembodiment of the embodiment, when there exists at least one reference signal index in the first reference signal index set being associated with the second PCI and value Y1 of the first parameter is equal to 4, value A1 of the L1 is equal to 3.

In one subembodiment of the embodiment, when there exists at least one reference signal index in the first reference signal index set being associated with the second PCI and value Y1 of the first parameter is equal to 4, value A1 of the L1 is equal to 4.

In one subembodiment of the embodiment, when there exists at least one reference signal index in the first reference signal index set being associated with the second PCI and value Y1 of the first parameter is equal to 4, value A1 of the L1 is equal to 6.

In one embodiment, when there does not exist a reference signal index in the first reference signal index set being associated with the second PCI and value Y2 of the first parameter is equal to 8, value A2 of the L1 is equal to 6;

when there exists at least one reference signal index in the first reference signal index set being associated with the second PCI and value Y2 of the first parameter is equal to 8, value A2 of the L1 is greater than 6;

In one subembodiment of the embodiment, when there exists at least one reference signal index in the first reference signal index set being associated with the second PCI and value Y2 of the first parameter is equal to 8, value A2 of the L1 is equal to 7.

In one subembodiment of the embodiment, when there exists at least one reference signal index in the first reference signal index set being associated with the second PCI and value Y2 of the first parameter is equal to 8, value A2 of the L1 is equal to 8.

In one subembodiment of the embodiment, when there exists at least one reference signal index in the first reference signal index set being associated with the second PCI and value Y2 of the first parameter is equal to 8, value A2 of the L1 is equal to 10.

In one embodiment, when there exists at least one reference signal index in the first reference signal index set being associated with the second PCI and the first parameter is equal to 16, value A2 of the L1 is greater than 6.

In one subembodiment of the embodiment, when there exists at least one reference signal index in the first reference signal index set being associated with the second PCI and the first parameter is equal to 16, a value of the L1 is equal to 7.

In one subembodiment of the embodiment, when there exists at least one reference signal index in the first reference signal index set being associated with the second PCI and the first parameter is equal to 16, a value of the L1 is equal to 8.

In one subembodiment of the embodiment, when there exists at least one reference signal index in the first reference signal index set being associated with the second PCI and the first parameter is equal to 16, a value of the L1 is equal to 10.

In one embodiment, when there does not exist a reference signal index in the first reference signal index set being associated with the second PCI and value Y3 of the first parameter is equal to 64, value A3 of the L1 is equal to 8;
when there exists at least one reference signal index in the first reference signal index set being associated with the second PCI and value Y3 of the first parameter is equal to 64, value A3 of the L1 is greater than or equal to 8.

In one subembodiment of the embodiment, when there exists at least one reference signal index in the first reference signal index set being associated with the second PCI and value Y3 of the first parameter is equal to 64, value A3 of the L1 is equal to 8.

In one subembodiment of the embodiment, when there exists at least one reference signal index in the first reference signal index set being associated with the second PCI and value Y3 of the first parameter is equal to 64, value A3 of the L1 is equal to 9.

In one subembodiment of the embodiment, when there exists at least one reference signal index in the first reference signal index set being associated with the second PCI and value Y3 of the first parameter is equal to 64, value A3 of the L1 is equal to 10.

In one subembodiment of the embodiment, when there exists at least one reference signal index in the first reference signal index set being associated with the second PCI and value Y3 of the first parameter is equal to 64, value A3 of the L1 is equal to 12.

In one subembodiment of the embodiment, when there exists at least one reference signal index in the first reference signal index set being associated with the second PCI and value Y3 of the first parameter is equal to 64, value A3 of the L1 is equal to 16.

In one embodiment, when there exists at least one reference signal index in the first reference signal index set being associated with the second PCI, there exists a third mapping relation between the first parameter and the L2;
when there does not exist a reference signal index in the first reference signal index set being associated with the second PCI, there exists a fourth mapping relation between the first parameter and the L2;
the third mapping relation is different from the fourth mapping relation.

In one embodiment, a mapping relation between the first parameter and L1 shown in FIG. 7C is the third mapping relation.

In one embodiment, a mapping relation between the first parameter and L2 shown in FIG. 7C is the fourth mapping relation.

In one embodiment, when there does not exist a reference signal index in the first reference signal index set being associated with the second PCI and value Y1 of the first parameter is equal to 4, value B1 of the L2 is equal to 2;
when there exists at least one reference signal index in the first reference signal index set being associated with the second PCI and value Y1 of the first parameter is equal to 4, value B1 of the L2 is greater than 2.

In one subembodiment of the embodiment, when there exists at least one reference signal index in the first reference signal index set being associated with the second PCI and value Y1 of the first parameter is equal to 4, value B1 of the L2 is equal to 3.

In one subembodiment of the embodiment, when there exists at least one reference signal index in the first reference signal index set being associated with the second PCI and value Y1 of the first parameter is equal to 4, value B1 of the L2 is equal to 4.

In one subembodiment of the embodiment, when there exists at least one reference signal index in the first reference signal index set being associated with the second PCI and value Y1 of the first parameter is equal to 4, value B1 of the L2 is equal to 6.

In one embodiment, when there does not exist a reference signal index in the first reference signal index set being associated with the second PCI and value Y2 of the first parameter is equal to 8, value B2 of the L2 is equal to 4;
when there exists at least one reference signal index in the first reference signal index set being associated with the second PCI and value Y2 of the first parameter is equal to 8, value B2 of the L2 is greater than 4.

In one subembodiment of the embodiment, when there exists at least one reference signal index in the first reference signal index set being associated with the second PCI and value Y2 of the first parameter is equal to 8, value B2 of the L2 is equal to 5.

In one subembodiment of the embodiment, when there exists at least one reference signal index in the first reference signal index set being associated with the second PCI and value Y2 of the first parameter is equal to 8, value B2 of the L2 is equal to 6.

In one subembodiment of the embodiment, when there exists at least one reference signal index in the first reference signal index set being associated with the second PCI and value Y2 of the first parameter is equal to 8, value B2 of the L2 is equal to 8.

In one embodiment, when there exists at least one reference signal index in the first reference signal index set being associated with the second PCI and the first parameter is equal to 16, value B2 of the L2 is greater than 4.

In one subembodiment of the embodiment, when there exists at least one reference signal index in the first reference signal index set being associated with the second PCI and the first parameter is equal to 16, a value of the L2 is equal to 5.

In one subembodiment of the embodiment, when there exists at least one reference signal index in the first reference signal index set being associated with the second PCI and the first parameter is equal to 16, a value of the L2 is equal to 6.

In one subembodiment of the embodiment, when there exists at least one reference signal index in the first reference signal index set being associated with the second PCI and the first parameter is equal to 16, a value of the L2 is equal to 8.

In one embodiment, when there does not exist a reference signal index in the first reference signal index set being associated with the second PCI and value Y3 of the first parameter is equal to 64, value B3 of the L2 is equal to 8;
when there exists at least one reference signal index in the first reference signal index set being associated with the second PCI and value Y3 of the first parameter is equal to 64, value B3 of the L2 is greater than or equal to 8.

In one subembodiment of the embodiment, when there exists at least one reference signal index in the first reference signal index set being associated with the second PCI and value Y3 of the first parameter is equal to 64, value B3 of the L2 is equal to 8.

In one subembodiment of the embodiment, when there exists at least one reference signal index in the first reference signal index set being associated with the second PCI and value Y3 of the first parameter is equal to 64, value B3 of the L2 is equal to 9.

In one subembodiment of the embodiment, when there exists at least one reference signal index in the first reference signal index set being associated with the second PCI and value Y3 of the first parameter is equal to 64, value B3 of the L2 is equal to 10.

In one subembodiment of the embodiment, when there exists at least one reference signal index in the first reference signal index set being associated with the second PCI and value Y3 of the first parameter is equal to 64, value B3 of the L2 is equal to 12.

In one subembodiment of the embodiment, when there exists at least one reference signal index in the first reference signal index set being associated with the second PCI and value Y3 of the first parameter is equal to 64, value B3 of the L2 is equal to 16.

In one embodiment, advantages of the above approach are that i.e., the complexity of the UE hardware can be controlled and it can also be ensured that multiple TRP or PCI associated reference signal indexes can all be evaluated.

In one embodiment, advantages of the above approach are that it is possible to control the complexity of the UE hardware and to accurately assess the quality of radio link.

In one embodiment, a maximum number of SSB indexes of a first cell is less than 64.

In one embodiment, the first cell is identified by the first PCI, and the first PCI is configured by physCellId of ServingCellConfigCommon received by the first node.

In one embodiment, the first reference signal index set comprises at least one reference signal index associated with the second PCI; the first reference signal index set comprises at least one reference signal index associated with the first PCI.

In one embodiment, the first message is used to indicate, a number of reference signal index(es) associated with the first PCI in the at most L2 reference signal index(es) in the first reference signal index set.

In one subembodiment of the embodiment, a number of reference signal indexes associated with the first PCI in the at most L2 reference signal indexes in the first reference signal index set is equal to 2.

In one embodiment, the first reference signal index set comprises at least one reference signal index associated with the second PCI; the first reference signal index set comprises at least one reference signal index associated with the first PCI;
a difference value between a number of reference signal index(es) associated with the first PCI and a number of reference signal index(es) associated with the second PCI among at most L2 reference signal index(es) is not greater than 1.

In one subembodiment of the embodiment, a number of reference signal index(es) associated with the first PCI and a number of reference signal index(es) associated with the second PCI among the at most L2 reference signal index(es) are equal.

In one subembodiment of the embodiment, a difference value between a number of reference signal index(es) associated with the first PCI and a number of reference signal index(es) associated with the second PCI among the at most L2 reference signal index(es) is 1.

In one embodiment, a value of the first parameter satisfies:

Lmax=X(min(i+d,2))

herein, Lmax is the first parameter; X (i) is a maximum number of SSB indexes in a first cell, where i is a non-negative integer less than 3; min ( ) is an operation taking the minimum value; a configurable range of a maximum number of SSB indexes in the first cell at least comprises: X (0)=4, X (1)=8, X (2)=64;
when there does not exist a reference signal index in the first reference signal index set being associated with the second PCI, d is equal to 0;
when there exists at least one reference signal index in the first reference signal index set being associated with the second PCI, d is equal to 1.

In one subembodiment of the above embodiment, the X (0) is equal to the Y1; the X(1) is equal to the Y2; the X(2) is equal to the Y3.

In one subembodiment of the above embodiment, A1 is equal to 2; A2 is equal to 6; A3 is equal to 8.

In one subembodiment of the above embodiment, B1 is equal to 2; B2 is equal to 6; B3 is equal to 8.

In one embodiment, advantages of the above method are that the mapping relation of the first parameter to the L1 and the L2 respectively, for the two cases of the presence of at least one reference signal index in the first reference signal index set being associated to a second PCI and the absence of reference signal indexes in the first reference signal index set being associated to the second PCI, can be supported by only one table.

In one embodiment, a value of Z is equal to or satisfies a sum of a maximum number of SSB indexes in the first cell and a second parameter.

In one subembodiment of the embodiment, the second parameter is a positive integer, and a serving cell of the first node indicates the second parameter.

In one subembodiment of the embodiment, the second parameter is a maximum value of a number of SSB index(es) of the second cell.

In one subembodiment of the embodiment, the second parameter is a maximum value of a number of SSB index(es) of an active BWP of the second cell.

In one subembodiment of the embodiment, when the Z is greater than 4 but less than 8, the first parameter is equal to 4.

In one subembodiment of the embodiment, when the Z is greater than 4 but less than 8, the first parameter is equal to 8.

In one subembodiment of the embodiment, when the Z is greater than 5 but less than 8, the first parameter is equal to 8.

In one subembodiment of the embodiment, when the Z is greater than 8 but less than 64, the first parameter is equal to 8.

In one subembodiment of the embodiment, when the Z is greater than 8 but less than 64, the first parameter is equal to 64.

In one subembodiment of the embodiment, when the Z is greater than 8 but less than 16, the first parameter is equal to 8.

In one subembodiment of the embodiment, when the Z is greater than 32 but less than 64, the first parameter is equal to 64.

### Embodiment 8A

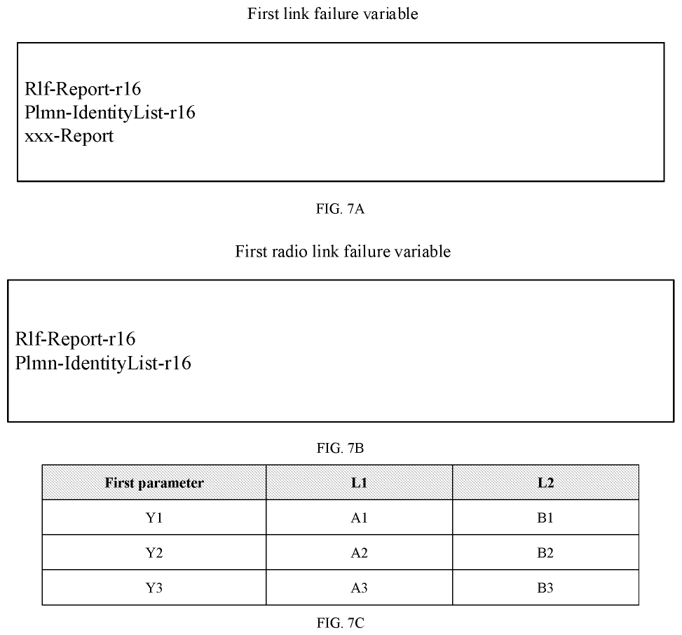

Embodiment 8A illustrates a schematic diagram of a second message being used to indicate a link observation record according to one embodiment of the present application, as shown in FIG. 8A.

In one embodiment, the second message comprises the link observation record.

In one embodiment, the second message is a bit in a UCI.

In one embodiment, the second message is a bit in a MAC CE.

In one embodiment, the link observation record comprises or only comprises that the higher layer of the first node continuously receives the Q2 second-type indication(s).

In one embodiment, the link observation record comprises or only comprises a number of the second-type indication(s) continuously received by the higher layer of the first node.

In one embodiment, the link observation record comprises or only comprises that failure occurs in a cell identified by the first PCI.

In one subembodiment of the above embodiment, failure occurred in a cell identified by the first PCI is link failure.

In one subembodiment of the above embodiment, failure occurred in a cell identified by the first PCI is failure not occurred or a radio link not detected.

In one embodiment, the link observation record comprises or only comprises a measurement result for reference signal resources identified by at least one reference signal index in the second reference signal index set.

In one embodiment, the link observation record comprises or only comprises the second-type radio link quality.

In one embodiment, the link observation record comprises or only comprises available measurement results on reference signal resources identified by all reference signal indexes configured by measObjNR associated with the first PCI of the first node.

In one embodiment, the link observation record comprises or only comprises measurement results on reference signal resources identified by all reference signal indexes configured by measObjNR associated with the first PCI of the first node.

In one embodiment, the second message comprises all available measurement results on reference signal resources identified by all reference signal indexes configured by measObjNR associated with the first PCI of the first node comprised in the link observation record.

In one embodiment, the second message comprises best n2 measurement result(s) in available measurement results on reference signal resources identified by all reference signal indexes configured by measObjNR associated with the first PCI of the first node comprised in the link observation record, where n2 is a positive integer.

In one embodiment, the available measurement result is a latest measurement result.

In one embodiment, the available measurement result is a completed measurement result.

In one embodiment, the available measurement result is a measurement configuration complying with measurement configuration.

In one embodiment, the second message comprises the second-type radio link quality.

In one embodiment, the second message comprises an evaluation result of the second-type radio link quality.

In one embodiment, the second message comprises a measurement result for reference signal resources identified by at least one reference signal index in the second reference signal index set.

In one embodiment, the second message comprises all measurement results of reference signal resources identified by a reference signal index in the second reference signal index set.

In one embodiment, the second message comprises best n3 measurement result(s) in measurement results of reference signal resources identified by a reference signal index in the second reference signal index set, n3 being a positive integer.

In one embodiment, the second message indicates the first PCI to indicate the link observation record.

In one embodiment, the second message indicates the first PCI to indicate the link observation record, and the link observation record is associated with the first PCI.

In one subembodiment of the embodiment, the link observation record comprises a measurement result of reference signal resources identified by a reference signal index comprised in the second reference signal index set, and any reference signal index in the second reference signal index set is associated with the first PCI.

In one embodiment, the second message indicates that all conditions in the first condition set are satisfied.

In one subembodiment of the embodiment, the second message indicates that all conditions in the first condition set being met comprise that the link observation record is generated or stored.

In one embodiment, the second message indicates that the first link failure variable comprises a link observation record.

In one embodiment, the second message indicates that the first link failure variable comprises an available link observation record.

In one embodiment, the second message indicates that the first link failure variable stores a link observation record.

In one embodiment, the second message comprises measResultLastServCell-r16, and the measResultLastServCell-r16 is used to indicate the link observation record.

In one embodiment, the second message comprises measResultLastServCell-r16, and a field other than the measResultLastServCell-r16 is used to indicate the link observation record.

### Embodiment 8B

Embodiment 8B illustrates a schematic diagram of a second measurement result according to one embodiment of the present application, as shown in FIG. 8B.

In one embodiment, the second measurement result comprises a measurement result of a neighboring cell.

In one embodiment, the second measurement result comprises a measurement result of a reference signal of a neighboring cell.

In one embodiment, the second measurement result comprises a measurement result of reference signal resources of a neighboring cell.

In one embodiment, the second measurement result is measResultNeighCells.

In one embodiment, the second measurement result comprises measurement results of m+1 cells.

In one subembodiment of the above embodiment, m is a positive integer, or m is equal to 0.

In one subembodiment of the embodiment, m is not greater than 7.

In one subembodiment of the embodiment, m is not greater than 9.

In one subembodiment of the embodiment, m is not greater than 19.

In one subembodiment of the embodiment, m is not greater than 63.

In one subembodiment of the embodiment, measurement results of m+1 cells comprised in the second measurement result are RSRP of an SS/PBCH block.

In one subembodiment of the embodiment, measurement results of m+1 cells comprised in the second measurement result are measurement results of an SSB.

In one subembodiment of the embodiment, measurement results of m+1 cells comprised in the second measurement result are measurement results of a CSI-RS.

In one subembodiment of the embodiment, measurement results of m+1 cells comprised in the second measurement result are measurement results of a reference signal.

In one subembodiment of the embodiment, measurement results of m+1 cells comprised in the second measurement result re measurement results of reference signal resources.

In one subembodiment of the embodiment, measurement results of the m+1 cells comprised in the second measurement result are L₀, L₁, L₂, . . . , Lₘ respectively.

In one subembodiment of the embodiment, measurement results of the m+1 cells comprised in the second measurement result are L₀, L₁, L₂, . . . , Lₘ respectively, where the L₀ corresponds to a measurement result of cell a₀; L₁ corresponds to a measurement result of cell a₁; L₂ corresponds to a measurement result of cell a₂; L_{M} corresponds to a measurement result of cell a_{M}; the Lᵢ corresponds to a measurement result of cell aᵢ, where i is any integer between [0, m].

In one subembodiment of the embodiment, if RSRP of an SS/PBCH block in cell aₚ is greater than RSRP of an S/PBCH block of cell a_{q}, then p is less than q, where p is any integer between [1, m] and q is any integer between [1, m] that is not equal to p.

In one subembodiment of the embodiment, L₀ comprises the second reference signal index measurement result set.

In one subembodiment of the embodiment, RSRP of an SS/PBCH block comprised in the L₀ is not greater than RSRP of an SS/PBCH block of the L₁.

In one subembodiment of the embodiment, RSRP of an SS/PBCH block of a cell identified by the second PCI comprised in the L₀ is not greater than RSRP of an SS/PBCH block of a cell comprised in the L₁.

In one subembodiment of the embodiment, a cell a₀ is a cell identified by the second PCI.

### Embodiment 8C

Embodiment 8C illustrates a schematic diagram of at least one of L1 or L2 depending on a first parameter according to one embodiment of the present application, as shown in FIG. 8C.

In one embodiment, the phrase that at least one of the L1 or the L2 depends on a first parameter comprises: the first parameter is used to determine the L1.

In one subembodiment of the embodiment, by the method given in embodiment 7, L1 can be uniquely determined by the first parameter.

In one embodiment, the phrase that at least one of the L1 or the L2 depends on a first parameter comprises: the first parameter is used to determine the L2.

In one subembodiment of the embodiment, by the method given in embodiment 7, L2 can be uniquely determined by the first parameter.

In one embodiment, the phrase that at least one of the L1 or the L2 depends on a first parameter comprises: the first parameter is used to determine the L1 and the L2.

In one embodiment, the phrase that at least one of the L1 or the L2 depends on a first parameter comprises: by looking up a table, the first parameter is used to determine the L1 and the L2.

In one embodiment, the phrase that at least one of the L1 or the L2 depends on a first parameter comprises: a mapping relation in embodiment 7 exists between L1 and the first parameter.

In one embodiment, the phrase that at least one of the L1 or the L2 depends on a first parameter comprises: a mapping relation in embodiment 7 exists between L2 and the first parameter.

In one embodiment, the phrase that at least one of the L1 or the L2 depends on a first parameter comprises: when the first parameter is determined, at least one of L1 or L2 is determined.

In one embodiment, the phrase that at least one of the L1 or the L2 depends on a first parameter comprises: when there exists at least one reference signal index in the first reference signal index set being associated with the second PCI, the L1 and the L2 can be obtained by looking up table 1 through the first parameter; when there does not exist a reference signal index in the first reference signal index set being associated with the second PCI, the L1 and the L2 can be obtained by looking up table 2 through the first parameter; the table 1 and table 2 are different.

In one subembodiment of the above embodiment, the table 1 is a table shown in FIG. 7.

In one subembodiment of the above embodiment, the table 2 is a table shown in FIG. 7.

In one subembodiment of the above embodiment, parameters in the table 1 and the table 2 are not exactly the same.

### Embodiment 9

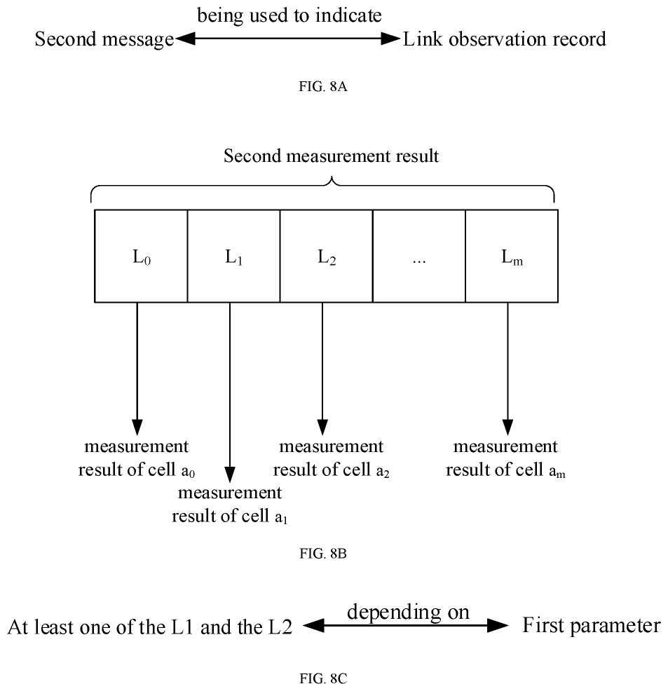

Embodiment 9 illustrates a schematic diagram of a second measurement result according to one embodiment of the present application, as shown in FIG. 9.

In one embodiment, the second measurement result comprises a measurement result of a neighboring cell.

In one embodiment, the second measurement result comprises a measurement result of a reference signal of a neighboring cell.

In one embodiment, the second measurement result comprises a measurement result of reference signal resources of a neighboring cell.

In one embodiment, the second measurement result is measResultNeighCells.

In one embodiment, the second measurement result comprises a second result list, and the second result list comprises measurement results of m+1 cells.

In one subembodiment of the above embodiment, m is a positive integer, or m is equal to 0.

In one subembodiment of the embodiment, m is not greater than 7.

In one subembodiment of the embodiment, m is not greater than 9.

In one subembodiment of the embodiment, m is not greater than 19.

In one subembodiment of the embodiment, m is not greater than 63.

In one subembodiment of the embodiment, measurement results of m+1 cells comprised in the second result list are RSRP of an SS/PBCH block.

In one subembodiment of the embodiment, measurement results of m+1 cells comprised in the second result list are a measurement result of an SSB.

In one subembodiment of the embodiment, measurement results of m+1 cells comprised in the second result list are a measurement result of a CSI-RS.

In one subembodiment of the embodiment, measurement results of m+1 cells comprised in the second result list are a measurement result of a reference signal.

In one subembodiment of the embodiment, measurement results of m+1 cells comprised in the second result list are a measurement result of reference signal resources.

In one subembodiment of the embodiment, measurement results of the m+1 cells comprised in the second result list are L₀, L₁, L₂, . . . , Lₘ respectively.

In one subembodiment of the embodiment, measurement results of the m+1 cells comprised in the second result list are L₀, L₁, L₂, . . . , Lₘ respectively, where the L₀ corresponds to a measurement result of cell a₀. L₁ corresponds to a measurement result of cell a₁; L₂ corresponds to a measurement result of cell a₂; L_{M} corresponds to a measurement result of cell a_{M}; the Lᵢ corresponds to a measurement result of cell aᵢ, where i is any integer between [0, m].

In one subembodiment of the embodiment, if RSRP of an SS/PBCH block in cell aₚ is greater than RSRP of an S/PBCH block in cell a_{q}, then p is less than q, where p is any integer between [0, m] and q is any integer between [0, m] that is not equal to p.

In one subembodiment of the embodiment, the second result list does not comprise the second reference signal index measurement result set.

In one subembodiment of the embodiment, RSRP of an SS/PBCH block comprised in the L₀ is greater than RSRP of an SS/PBCH block of the L₁.

In one subembodiment of the embodiment, RSRP of an SS/PBCH block of a cell identified by the second PCI comprised in the L₀ is greater than RSRP of an SS/PBCH block of a cell comprised in the L₁.

In one subembodiment of the embodiment, a cell a₀ is a cell other than a cell identified by the second PCI.

In one subembodiment of the above embodiment, a cell identified by the second PCI is not a cell aᵢ, where i is any integer between [0, m].

### Embodiment 10

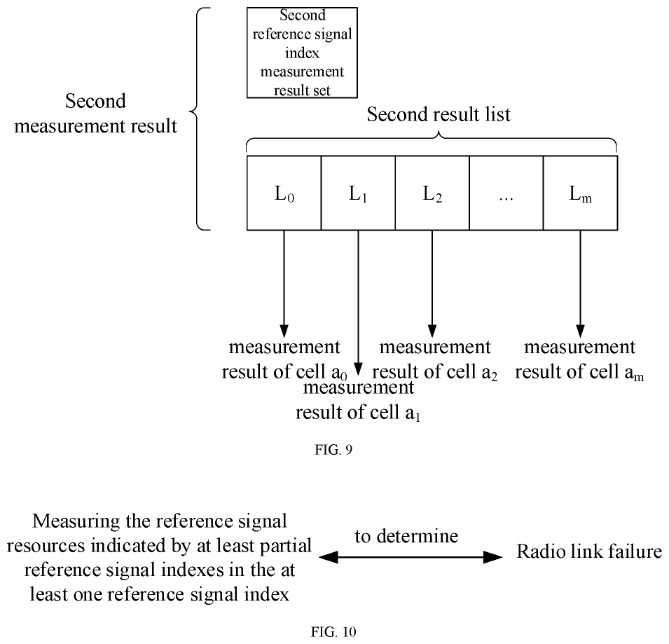

Embodiment 10 illustrates a schematic diagram of measuring the reference signal resources indicated by at least partial reference signal indexes in the at least one reference signal index to determine RLF according to one embodiment of the present application, as shown in FIG. 10.

In one embodiment, the meaning of the phrase of measuring the reference signal resources indicated by at least partial signal indexes in the at least one reference signal index comprises: when a serving cell of the first node is configured with multiple downlink BWPs (bandwidth parts), the first node performs radio link monitoring (RLM) on an activated BWP adopting reference signal resources corresponding to at least partial reference signal indexes indicated by the first radio link monitoring configuration.

In one subembodiment of the embodiment, the RadioLinkMonitoringRS is used to indicate the reference signal resources indicated by at least partial reference signal indexes in at least one reference signal index.

In one subembodiment of the embodiment, the first node measures the reference signal resources indicated by all reference signal indexes in the at least one reference signal index.

In one subembodiment of the embodiment, the first node measures the reference signal resources indicated by all reference signal indexes belonging to a same BWP in the at least one reference signal index.

In one subembodiment of the embodiment, the first node measures the reference signal resources indicated by all reference signal indexes belonging to a same cell in the at least one reference signal index.

In one subembodiment of the embodiment, the first node measures the reference signal resources indicated by all reference signal indexes associated with a same PCI in the at least one reference signal index.

In one embodiment, the meaning of the phrase of measuring the reference signal resources indicated by at least partial signal indexes in the at least one reference signal index comprises: when RadioLinkMonitoringRS is not provided on an activated BWP, the first node executes RLM adopting reference signal resources that belong to reference signal resources provided by or associated with an activated TCI state in CORESETs receiving a PDCCH on the activated BWP in reference signal resources corresponding to at least partial reference signal indexes indicated by the first radio link monitoring configuration.

In one subembodiment of the embodiment, the first radio link monitoring configuration comprises reference signal resources provided by or associated with an activate TCI state in the CORESETs.

In one embodiment, the meaning of the phrase of measuring the reference signal resources indicated by at least partial signal indexes in the at least one reference signal index comprises: in non-DRX mode operation, a physical layer of the first node assesses radio link quality each indication period, assesses a threshold (Qₒᵤₜ and Qᵢₙ) configured violating rlmInSyncOutOfSyncThreshold in a past time period, and the first node determines that an indication period is a maximum value between a shortest periodic radio link monitoring resource and 10 ms.

In one subembodiment of the above embodiment, a serving cell of the first node indicates the rlmInSyncOutOfSyncThreshold.

In one subembodiment of the above embodiment, the first node determines the rlmInSyncOutOfSyncThreshold according to internal algorithm.

In one subembodiment of the above embodiment, the first node determines the Qₒᵤₜ and Qᵢₙ based on internal algorithm.

In one subembodiment of the above embodiment, a serving cell of the first node indicates the Qout and Qin.

In one subembodiment of the embodiment, a serving cell of the first node indicates the indication period.

In one embodiment, the meaning of the phrase of measuring the reference signal resources indicated by at least partial signal indexes in the at least one reference signal index comprises: in Discontinuous Reception (DRX) mode operation, a physical layer of the first node assesses radio connection quality each indication period, assesses a threshold (Qₒᵤₜ and Qᵢₙ) configured violating rlmInSyncOutOfSyncThreshold in a past time cycle, and the first node determines that an indication cycle is a maximum value between a shortest periodic radio link monitoring resource and a DRX cycle.

In one subembodiment of the above embodiment, a serving cell of the first node indicates the rlmInSyncOutOfSyncThreshold.

In one subembodiment of the above embodiment, the first node determines the rlmInSyncOutOfSyncThreshold according to internal algorithm.

In one subembodiment of the above embodiment, the first node determines the Qₒᵤₜ and Qᵢₙ based on internal algorithm.

In one subembodiment of the above embodiment, a serving cell of the first node indicates the Qₒᵤₜ and Qᵢₙ.

In one subembodiment of the embodiment, a serving cell of the first node indicates the indication period.

In one embodiment, the meaning of the phrase of measuring the reference signal resources indicated by at least partial signal indexes in the at least one reference signal index to determine RLF comprises: when radio link quality of all reference signal resources used for radio link monitoring is worse than Qₒᵤₜ threshold, a physical layer of the first node indicates “out-of-sync” to a higher layer in those frames in which radio link quality is assessed; when radio link quality of any reference signal resource in reference signal resources used for radio link monitoring is better than a Qᵢₙ threshold, a physical layer of the first node indicates “in-sync” to a higher layer in those frames in which radio link quality is assessed.

In one subembodiment of the embodiment, the first node measures reference signal resources used for radio link monitoring to obtain the radio link quality.

In one subembodiment of the embodiment, when a number of “out of sync” indicated to a higher layer reaches a first threshold, where the first threshold is configured by a serving cell of the first node, the first node starts the first timer, for example, the first timer is T310, and an expiration of the first timer determines RLF.

In one subembodiment of the embodiment, the first radio link monitoring configuration indicates at least partial reference signal resources in the reference signal resources used for radio link monitoring.

In one subembodiment of the embodiment, the first radio link monitoring configuration indicates all reference signal resources in the reference signal resources used for radio link monitoring.

In one subembodiment of the embodiment, the first radio link monitoring configuration indicates a reference signal index of reference signal resources in reference signal resources used for radio link monitoring.

In one subembodiment of the above embodiment, the first node determines the Qₒᵤₜ and Qᵢₙ based on internal algorithm.

In one subembodiment of the above embodiment, a serving cell of the first node indicates the Qₒᵤₜ and Qᵢₙ.

In one embodiment, the meaning of the phrase of measuring the reference signal resources indicated by at least partial signal indexes in the at least one reference signal index to determine RLF comprises: when radio link quality of all reference signal resources used for radio link monitoring is worse than Qₒᵤₜ threshold, a physical layer of the first node indicates “out-of-sync” to a higher layer in those frames in which radio link quality is assessed; when radio link quality of any reference signal resource in reference signal resources used for radio link monitoring is better than a Qᵢₙ threshold, a physical layer of the first node indicates “in-sync” to a higher layer in those frames in which radio link quality is assessed.

In one subembodiment of the embodiment, the first node measures reference signal resources used for radio link monitoring to obtain the radio link quality.

In one subembodiment of the embodiment, when a number of continuous “out of sync” indicated to a higher layer reaches a first threshold, where the first threshold is configured by a serving cell of the first node, the first node starts the first timer, for example, if the first timer is T310, an expiration of the first timer determines the RLF.

In one subembodiment of the embodiment, when a number of continuous “out-of-sync” indicated to a higher layer reaches a first threshold, where the first threshold is configured by a serving cell of the first node, the first node starts the first timer, for example, the first timer is T310, and an expiration of the first timer determines the RLF; when continuous “in-sync” received by a higher layer reaches a second threshold, where the second threshold is configured by a serving cell of the first node, the continuous “out-of-sync” will be counted again.

In one subembodiment of the embodiment, the first radio link monitoring configuration indicates at least partial reference signal resources in the reference signal resources used for radio link monitoring.

In one subembodiment of the embodiment, the first radio link monitoring configuration indicates all reference signal resources in the reference signal resources used for radio link monitoring.

In one subembodiment of the embodiment, the first radio link monitoring configuration indicates a reference signal index of reference signal resources in reference signal resources used for radio link monitoring.

In one subembodiment of the above embodiment, an expiration of the first timer triggers the RLF.

### Embodiment 11

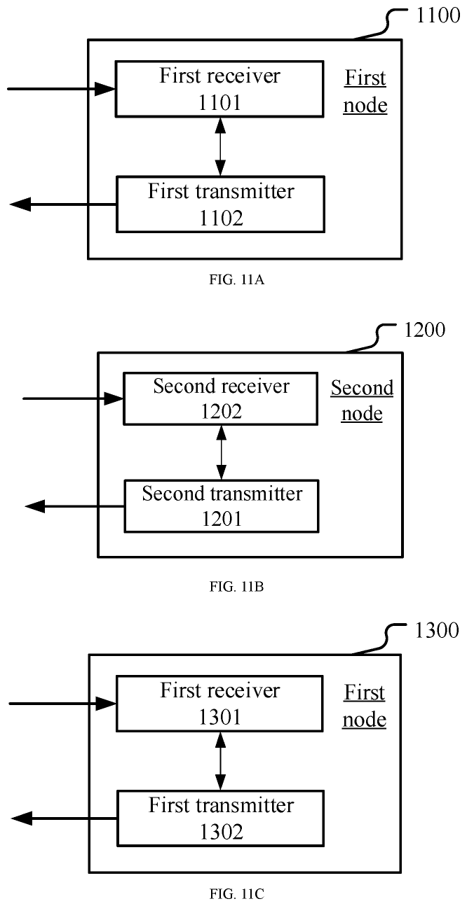

Embodiment 11 illustrates a structure block diagram of a processor in a first node according to one embodiment of the present application, as shown in FIG. 11. In FIG. 11, a processor 1100 in a first node comprises a first receiver 1101 and a first transmitter 1102. In Embodiment 11,
the first receiver 1101 receives a first message, the first message is used to indicate a first reference signal index set and a second reference signal index set; the first reference signal index set and the second reference signal index set each at least comprise one reference signal index; any reference signal index in the first reference signal index set indicates a reference signal resource; any reference signal index in the second reference signal index set indicates a reference signal resource; at least one reference signal index in the first reference signal index set is associated with a first PCI, and at least one reference signal index in the first reference signal index set is associated with a second PCI; any reference signal index in the second reference signal index set is associated with the first PCI;
the first receiver 1101 assesses first-type radio link quality according to at least partial reference signal resources indicated by the first reference signal index set; whenever the evaluated first-type radio link quality is worse than a first threshold, a physical layer of the first node 1100 reports a first-type indication to a higher layer of the first node 1100; as a response to the higher layer of the first node 1100 continuously receiving Q1 the first-type indications, starts a first timer, Q1 being a positive integer; as a response to the first timer being expired, detects RLF;
the first receiver 1101 assesses second-type radio link quality according to at least partial reference signal resources indicated by the second reference signal index; whenever the evaluated second-type radio link quality is worse than a second threshold, a physical layer of the first node 1100 reports a second-type indication to a higher layer of the first node 1100;
as a response to all conditions in a first condition set being satisfied, executing a first operation;
herein, the first condition set comprises the higher layer of the first node 1100 continuously receiving Q2 second-type indication(s); the executing a first operation does not comprise detecting RLF; the first operation comprises generating a link observation record, or the first operation comprises transmitting a link observation record.

In one embodiment, at least partial reference signal indexes in the second reference signal index set belong to the first reference signal index set.

In one embodiment, the first condition set comprises an expiration of the second timer, and the higher layer of the first node 1100 continuously receiving the Q2 second-type indication(s) is used to trigger starting the second timer.

In one embodiment, the first receiver 1101 assesses third-type radio link quality according to at least partial reference signal resources indicated by the second reference signal index set; whenever the evaluated third-type radio link quality is better than a third threshold, a physical layer of the first node 1100 reports a third-type indication to a higher layer of the first node 1100;
the meaning of the phrase of “continuously receiving Q2 the second-type indication(s)” is not receiving the third-type indication in the procedure of continuously receiving the Q2 second-type indication(s).

In one embodiment, the behavior of transmitting a link observation record comprises transmitting a second message, and the second message is used to indicate the link observation record; whether a transmission of the second message and the second condition set being satisfied occur in a same RRC connection procedure is related to a configuration method of the second reference signal index set.

In one embodiment, the behavior of transmitting a link observation record comprises transmitting a second message, and the second message indicates the link observation record through indicating a first identity; herein, the first identity is associated with the first PCI.

In one embodiment, the behavior of executing a first operation comprises storing the link observation record in a first link failure variable;
the first receiver 1101 detects RLF, and stores information of the RLF in the first link failure variable;
the behavior of storing information of the RLF in the first link failure variable comprises: maintaining the link observation record stored in the first link failure variable; clearing information other than the link observation record stored in the first link failure variable.

In one embodiment, the behavior of executing a first operation comprises storing the link observation record in a second link failure variable; the second link failure variable is different from a first link failure variable; the first link failure variable is used to store information about RLF;
the second link failure variable is used to generate a second message; the behavior of transmitting a link observation record comprises transmitting the second message.

In one embodiment, the first transmitter 1102 transmits a third message, and the third message indicates having an available link observation record;
the first receiver 1101 receives a fourth message, and the fourth message indicates requesting a link observation record;
herein, the first node 1100 stores an available link observation record based on a state variable; the fourth message is used to trigger a second message; the third message is used to indicate a completion of a second operation;
the behavior of transmitting a link observation record comprises transmitting a second message, and the second message is used to indicate the link observation record.

In one embodiment, the first node is a UE.

In one embodiment, the first node is a terminal that supports large delay differences.

In one embodiment, the first node is a terminal that supports NTN.

In one embodiment, the first node is an aircraft.

In one embodiment, the first node is a vehicle terminal.

In one embodiment, the first node is a relay.

In one embodiment, the first node is a vessel.

In one embodiment, the first node is an IoT terminal.

In one embodiment, the first node is an IIoT terminal.

In one embodiment, the first node is a device that supports transmission with low-latency and high-reliability.

In one embodiment, the first node is a sidelink communication node.

In one embodiment, the first receiver 1101 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1102 comprises at least one of the antenna 452, the transmitter 454, the transmitting processor 468, the multi-antenna transmitting processor 457, the controller/processor 459, the memory 460 or the data source 467 in Embodiment 4.

### Embodiment 12

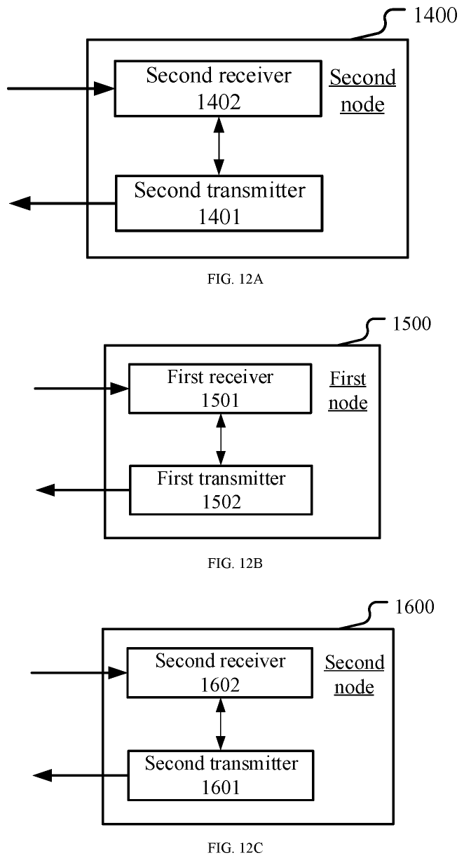

Embodiment 12 illustrates a structure block diagram of a processor in a second node according to one embodiment of the present application, as shown in FIG. 12. In FIG. 12, a processor 1200 in a second node comprises a second transmitter 1201 and a second receiver 1202. In Embodiment 12,
the second transmitter transmits a first message, the first message is used to indicate a first reference signal index set and a second reference signal index set; the first reference signal index set and the second reference signal index set each at least comprise one reference signal index; any reference signal index in the first reference signal index set indicates a reference signal resource; any reference signal index in the second reference signal index set indicates a reference signal resource; at least one reference signal index in the first reference signal index set is associated with a first PCI, and at least one reference signal index in the first reference signal index set is associated with a second PCI; any reference signal index in the second reference signal index set is associated with the first PCI;
a receiver of the first message assesses first-type radio link quality according to at least partial reference signal resources indicated by the first reference signal index set; whenever the evaluated first-type radio link quality is worse than a first threshold, a physical layer of a receiver of the first message reports a first-type indication to a higher layer of a receiver of the first message; as a response to the higher layer of a receiver of the first message continuously receiving Q1 the first-type indications, starts a first timer, Q1 being a positive integer; as a response to the first timer being expired, detects RLF;
a receiver of the first message assesses second-type radio link quality according to at least partial reference signal resources indicated by the second reference signal index; whenever the evaluated second-type radio link quality is worse than a second threshold, a physical layer of a receiver of the first message reports a second-type indication to a higher layer of a receiver of the first message;
a receiver of the first message, as a response to all conditions in a first condition set being satisfied, executes a first operation;
herein, the first condition set comprises the higher layer of the receiver of the first message continuously receiving Q2 second-type indication(s); the executing a first operation does not comprise detecting RLF; the first operation comprises generating a link observation record, or the first operation comprises transmitting a link observation record.

In one embodiment, at least partial reference signal indexes in the second reference signal index set belong to the first reference signal index set.

In one embodiment, the behavior of executing a first operation comprises storing the link observation record in a second link failure variable; the second link failure variable is different from a first link failure variable; the first link failure variable is used to store information about RLF;
the second link failure variable is used to generate a second message;
the behavior of transmitting a link observation record comprises transmitting the second message.

In one embodiment, the second receiver 1202 receives a second message, and the second message is used to indicate the link observation record.

In one embodiment, the second receiver 1201 receives a third message, and the third message indicates having available link observation record;
the second transmitter 1201 transmits a fourth message, and the fourth message indicates requesting a link observation record;
herein, a transmitter of the third message stores an available link observation record based on a state variable;
the fourth message is used to trigger a second message; the third message is used to indicate a completion of a second operation; the behavior of transmitting a link observation record comprises transmitting a second message, and the second message is used to indicate the link observation record.

In one embodiment, the second node is a satellite.

In one embodiment, the second node is a base station.

In one embodiment, the second node is a relay.

In one embodiment, the second node is an access point.

In one embodiment, the second node is a node supporting multicast.

In one embodiment, the second transmitter 1201 comprises at least one of the antenna 420, the transmitter 418, the transmitting processor 416, the multi-antenna transmitting processor 471, the controller/processor 475 or the memory 476 in Embodiment 4.

In one embodiment, the second receiver 1202 comprises at least one of the antenna 420, the receiver 418, the receiving processor 470, the multi-antenna receiving processor 472, the controller/processor 475 or the memory 476 in Embodiment 4.

### Embodiment 13

Embodiment 13 illustrates a structure block diagram of a processor in a first node according to one embodiment of the present application, as shown in FIG. 13. In FIG. 13, a processor 1300 of a first node comprises a first receiver 1301 and a first transmitter 1302. In Embodiment 13,
the first receiver 1301 receives a first message, the first message is used to indicate a first radio link monitoring configuration, the first radio link monitoring configuration is used to indicate at least one reference signal index, each reference signal index in the at least one reference signal index indicates a reference signal resource; the first receiver measures the reference signal resources indicated by at least partial reference signal indexes in the at least one reference signal index to determine RLF;
the first transmitter 1302 transmits a second message, and the second message comprises a first RLF report;
herein, the first RLF report comprises a first bitmap and a first reference signal index measurement result set; the first reference signal index measurement result set comprises K1 reference signal index(es), K1 being a positive integer; the first bitmap indicates whether any of the K1 reference signal index(es) comprised in the first reference signal index measurement result set belongs to the first radio link monitoring configuration; any reference signal index comprised in the first reference signal index measurement result set is associated with a first PCI;
the first RLF report comprises a second bitmap and a second reference signal index measurement result set; the second reference signal index measurement result set comprise K2 reference signal index(es), K2 being a positive integer; the second bitmap indicates whether any of the K2 reference signal index(es) comprised in the second reference signal index measurement result set belongs to the first radio link monitoring configuration; any reference signal index comprised in the second reference signal index measurement result set is associated with a second PCI.

In one embodiment, the first transmitter 1302 transmits a third message, and the third message indicates having available RLF information;
the first receiver 1301 receives a fourth message, and the fourth message indicates requesting an RLF report;
herein, the third node 1300 determines that the third message indicates having available RLF information based on a storage of available RLF information in a first RLF variable; the fourth message is used to trigger the second message; the third message is used to indicate a completion of a first operation.

In one embodiment, the at least one reference signal index indicated by the first radio link monitoring configuration comprises a reference signal index associated with the first PCI and a reference signal index associated with the second PCI.

In one embodiment, the first RLF report implicitly indicates the first PCI and explicitly comprises the second PCI.

In one embodiment, the first RLF report comprises a first measurement result, and the first measurement result comprises a measurement result of a primary cell of the first node 1300 based on an available reference signal measurement result until the RLF is detected;
the first measurement result comprises the first bitmap and the first reference signal index measurement result set; the first measurement result comprises the second bitmap and the second reference signal index measurement result set.

In one embodiment, the first RLF report comprises a first measurement result and a second measurement result, and the first measurement result comprises a measurement result of a primary cell of the first node 1300 based on an available reference signal measurement result until the RLF is detected; the second measurement result comprises an available measurement result of a measurement object configured by a cell other than a primary cell of the first node 1300;
the first measurement result comprises the first bitmap and the first reference signal index measurement result set; the second measurement result comprises the second bitmap and the second reference signal index measurement result set.

In one embodiment, measurement results of cells other than a cell corresponding to the second PCI comprised in the second measurement result are ordered such that a highest measurement result is listed first in the second measurement result, locations of the second bitmap and the second reference signal index measurement result set in the second measurement result is unrelated to a size of a measurement result of a cell corresponding to the second PCI.

In one embodiment, the first RLF report comprises a first measurement result and a second measurement result, and the first measurement result comprises a measurement result of a primary cell of the first node 1300 based on an available reference signal measurement result until the RLF is detected; the second measurement result comprises an available measurement result of a measurement object configured by a cell other than a primary cell of the first node 1300;
the first measurement result comprises the first bitmap and the first reference signal index measurement result set; whether the second bitmap and the second reference signal index measurement result set are comprised by the first measurement result or are comprised by the second measurement result set is related to a type of a reference signal index comprised by the second reference signal index measurement result set; the type of the reference signal index is one of SSB-index or CSI-RS-index.

In one embodiment, the first RLF report comprises a first measurement result, a second measurement result and a third measurement result, and the first measurement result comprises a measurement result of a primary cell of the first node 1300 based on an available reference signal measurement result until the RLF is detected; the second measurement result comprises an available measurement result of a measurement object configured by a cell other than a primary cell of the first node 1300 and a cell identified by the first PCI and a cell identified by the second PCI;
the first measurement result comprises the first bitmap and the first reference signal index measurement result set; the third measurement result comprises the second bitmap and the second reference signal index measurement result set.

In one embodiment, the first RLF report comprises a third bitmap and a third reference signal index measurement result set; the third reference signal index measurement result set comprises K3 reference signal index(es), and the K3 is a positive integer; the third bitmap indicates whether any of the K3 reference signal index(es) comprised in the third reference signal index measurement result set belongs to the first radio link monitoring configuration; any reference signal index comprised in the third reference signal index measurement result set is associated with a second PCI.

In one embodiment, the first node is a UE.

In one embodiment, the first node is a terminal that supports large delay differences.

In one embodiment, the first node is a terminal that supports NTN.

In one embodiment, the first node is an aircraft.

In one embodiment, the first node is a vehicle terminal.

In one embodiment, the first node is a relay.

In one embodiment, the first node is a vessel.

In one embodiment, the first node is an IoT terminal.

In one embodiment, the first node is an IIoT terminal.

In one embodiment, the first node is a device that supports transmission with low-latency and high-reliability.

In one embodiment, the first node is a sidelink communication node.

In one embodiment, the first receiver 1301 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1302 comprises at least one of the antenna 452, the transmitter 454, the transmitting processor 468, the multi-antenna transmitting processor 457, the controller/processor 459, the memory 460 or the data source 467 in Embodiment 4.

### Embodiment 12

Embodiment 12 illustrates a structure block diagram of a processor in a second node according to one embodiment of the present application, as shown in FIG. 12. In FIG. 12, a processor 1200 in a second node comprises a second transmitter 1201 and a second receiver 1202. In Embodiment 12,
the second transmitter 1201 transmits a first message, the first message is used to indicate a first radio link monitoring configuration, the first radio link monitoring configuration is used to indicate at least one reference signal index, each reference signal index in the at least one reference signal index indicates a reference signal resource;
a receiver of the first message measures the reference signal resources indicated by at least partial reference signal indexes in the at least one reference signal index to determine RLF;
the second receiver 1202 receives a second message, and the second message comprises a first RLF report;
herein, the first RLF report comprises a first bitmap and a first reference signal index measurement result set; the first reference signal index measurement result set comprises K1 reference signal index(es), K1 being a positive integer; the first bitmap indicates whether any of the K1 reference signal index(es) comprised in the first reference signal index measurement result set belongs to the first radio link monitoring configuration; any reference signal index comprised in the first reference signal index measurement result set is associated with a first PCI;
the first RLF report comprises a second bitmap and a second reference signal index measurement result set;
the second reference signal index measurement result set comprise K2 reference signal index(es), K2 being a positive integer; the second bitmap indicates whether any of the K2 reference signal index(es) comprised in the second reference signal index measurement result set belongs to the first radio link monitoring configuration; any reference signal index comprised in the second reference signal index measurement result set is associated with a second PCI.

In one embodiment, the second receiver 1201 receives a third message, and the third message indicates having available RLF information;
the second transmitter 1201 transmits a fourth message, the fourth message indicates requesting an RLF report;
herein, a transmitter of the third message determines that the third message indicates having available RLF information based on a storage of available RLF information in a first RLF variable; the fourth message is used to trigger the second message; the third message is used to indicate a completion of a first operation.

In one embodiment, the at least one reference signal index indicated by the first radio link monitoring configuration comprises a reference signal index associated with the first PCI and a reference signal index associated with the second PCI.

In one embodiment, the first RLF report implicitly indicates the first PCI and explicitly comprises the second PCI.

In one embodiment, a reference signal index comprised in the at least one reference signal index indicated by the first radio link monitoring configuration is only associated with one of the first PCI and the second PCI.

In one embodiment, any reference signal index indicated by the first radio link monitoring configuration is only associated with one of the first PCI and the second PCI.

In one embodiment, reference signal resources corresponding to any reference signal index associated with the second PCI comprised in the at least reference signal index indicated by the first radio link monitoring configuration only comprise a CSI-RS; an SSB transmitted by a transmitter of the first radio link monitoring configuration is only associated with the first PCI instead of the second PCI.

In one embodiment, the second node 1200 configures a TCI according to the first RLF report.

In one embodiment, the second node is a satellite.

In one embodiment, the second node is a base station.

In one embodiment, the second node is a relay.

In one embodiment, the second node is an access point.

In one embodiment, the second node is a node supporting multicast.

In one embodiment, the second transmitter 1201 comprises at least one of the antenna 420, the transmitter 418, the transmitting processor 416, the multi-antenna transmitting processor 471, the controller/processor 475 or the memory 476 in Embodiment 4.

In one embodiment, the second receiver 1202 comprises at least one of the antenna 420, the receiver 418, the receiving processor 470, the multi-antenna receiving processor 472, the controller/processor 475 or the memory 476 in Embodiment 4.

### Embodiment 15

Embodiment 15 illustrates a structure block diagram of a processor in a first node according to one embodiment of the present application, as shown in FIG. 15. In FIG. 15, a processor 1500 in a first node comprises a first receiver 1501 and a first transmitter 1502. In Embodiment 15,
the first receiver 1501 receives a first message, and the first message is used to indicate a first reference signal index set; the first reference signal index set comprises at most L1 reference signal indexes, L1 being a positive integer greater than 1; any reference signal index in the first reference signal index set indicates a reference signal resource;
the first receiver 1501 assesses first-type radio link quality based on reference signal resources identified by at most L2 reference signal indexes in reference signal indexes indicated by the first reference signal index set, where L2 is a positive integer greater than 1;
herein, at least one reference signal index in the first reference signal index set is associated with a first PCI; at least one of L1 or L2 depends on a first parameter, and the first parameter is related to whether there exists at least one reference signal index in the first reference signal index set being associated with a second PCI; whenever the evaluated first-type radio link quality is worse than a first threshold, a physical layer of the first node 1500 reports a first-type indication to a higher layer of the first node 1500; as a response to the higher layer of the first node 1500 continuously receiving Q1 the first-type indications, a first timer is started, Q1 being a positive integer; as a response to the first timer being expired, RLF is detected.

In one embodiment, the first parameter is a greater one of a maximum number of SSB indexes in a first cell and a maximum number of SSB indexes in a second cell; a PCI of the second cell is the second PCI.

In one embodiment, the first parameter is a sum of a maximum number of SSB indexes in a first cell and a maximum number of SSB indexes in a second cell; a PCI of the second cell is the second PCI.

In one embodiment, the first message is used to indicate a first offset, and the first offset is a positive integer; the first offset and a maximum number of SSB indexes of a first cell are used together to determine the first parameter;
there exists at least one reference signal index in the first reference signal index set being associated with the second PCI.

In one embodiment, when there exists at least one reference signal index in the first reference signal index set being associated with the second PCI, there exists a first mapping relation between the first parameter and the L1;
when there does not exist a reference signal index in the first reference signal index set being associated with the second PCI, there exists a second mapping relation between the first parameter and the L1;
the first mapping relation is different from the second mapping relation.

In one embodiment, when there exists at least one reference signal index in the first reference signal index set being associated with the second PCI, there exists a third mapping relation between the first parameter and the L2;
when there does not exist a reference signal index in the first reference signal index set being associated with the second PCI, there exists a fourth mapping relation between the first parameter and the L2;
the third mapping relation is different from the fourth mapping relation.

In one embodiment, when there does not exist a reference signal index in the first reference signal index set being associated with the second PCI, a minimum value of the value range of the L2 is a first value; when there exists at least one reference signal index in the first reference signal index set being associated with the second PCI, and a minimum value of a value range of the L2 is a second value; the second value is greater than the first value.

In one embodiment, a value of the first parameter satisfies:

Lmax=X(min(i+d,2))
herein, Lmax is the first parameter; X (i) is a maximum number of SSB indexes in a first cell, where i is a non-negative integer less than 3; min ( ) is an operation taking the minimum value; a configurable range of a maximum number of SSB indexes in the first cell at least comprises: X (0)=4, X (1)=8, X (2)=64;
when there does not exist a reference signal index in the first reference signal index set being associated with the second PCI, d is equal to 0;
when there exists at least one reference signal index in the first reference signal index set being associated with the second PCI, d is equal to 1.

In one embodiment, the first node 1500 is accessed not using a shared spectrum channel.

In one embodiment, the first node 1500 is accessed using a shared spectrum channel.

In one embodiment, when there does not exist a reference signal index in the first reference signal index set being associated with the second PCI, and when a maximum number of SSB indexes in a first cell is equal to 4, the L2 is equal to 2;
when there exists at least one reference signal index in the first reference signal index set being associated with the second PCI, and when a maximum number of SSB indexes in a first cell is equal to 4, the L2 is greater than 2.

In one embodiment, when there does not exist a reference signal index in the first reference signal index set being associated with the second PCI, and when a maximum number of SSB indexes in a first cell is equal to 4, the L1 is equal to 2;
when there exists at least one reference signal index in the first reference signal index set being associated with the second PCI, and when a maximum number of SSB indexes in a first cell is equal to 4, the L1 is greater than 2.

In one embodiment, when there does not exist a reference signal index in the first reference signal index set being associated with the second PCI, and when a maximum number of SSB indexes in a first cell is equal to 8, the L2 is equal to 4;
when there exists at least one reference signal index in the first reference signal index set being associated with the second PCI, and when a maximum number of SSB indexes in a first cell is equal to 8, the L1 is greater than 4.

In one embodiment, a maximum number of SSB indexes in a first cell is less than 64, and the first cell is identified by the first PCI, and the first PCI is configured by a physCellId of the ServingCellConfigCommon received by the first node 1500.

In one embodiment, the first reference signal index set comprises at least one reference signal index associated with the second PCI; the first reference signal index set comprises at least one reference signal index associated with the first PCI;
the first message is used to indicate a number of reference signal index(es) associated with the first PCI among the at most L2 reference signal index(es).

In one embodiment, the first reference signal index set comprises at least one reference signal index associated with the second PCI; the first reference signal index set comprises at least one reference signal index associated with the first PCI;
a difference value between a number of reference signal index(es) associated with the first PCI and a number of reference signal index(es) associated with the second PCI among at most L2 reference signal index(es) is not greater than 1.

In one embodiment, the first node is a UE.

In one embodiment, the first node is a terminal that supports large delay differences.

In one embodiment, the first node is a terminal that supports NTN.

In one embodiment, the first node is an aircraft.

In one embodiment, the first node is a vehicle terminal.

In one embodiment, the first node is a relay.

In one embodiment, the first node is a vessel.

In one embodiment, the first node is an IoT terminal.

In one embodiment, the first node is an IIoT terminal.

In one embodiment, the first node is a device that supports transmission with low-latency and high-reliability.

In one embodiment, the first node is a sidelink communication node.

In one embodiment, the first receiver 1501 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1502 comprises at least one of the antenna 452, the transmitter 454, the transmitting processor 468, the multi-antenna transmitting processor 457, the controller/processor 459, the memory 460 or the data source 467 in Embodiment 4.

### Embodiment 16

Embodiment 16 illustrates a structure block diagram of a processor in a second node according to one embodiment of the present application, as shown in FIG. 16. In FIG. 16, a processor 1600 in a second node comprises a second transmitter 1601 and a second receiver 1602. In Embodiment 16,
the second transmitter 1601 transmits a first message, and the first message is used to indicate the first reference signal index set; the first reference signal index set comprises at most L1 reference signal indexes, L1 being a positive integer greater than 1; any reference signal index in the first reference signal index set indicates a reference signal resource;
a receiver of the first message assesses first-type radio link quality based on reference signal resources identified by at most L2 reference signal indexes in reference signal indexes indicated by the first reference signal index set, where L2 is a positive integer greater than 1;
herein, at least one reference signal index in the first reference signal index set is associated with a first PCI; at least one of L1 or L2 depends on a first parameter, and the first parameter is related to whether there exists at least one reference signal index in the first reference signal index set being associated with a second PCI; whenever the evaluated first-type radio link quality is worse than a first threshold, a physical layer of a receiver of the first message reports a first-type indication to a higher layer of a receiver of the first message; as a response to the higher layer of a receiver of the first message continuously receiving Q1 the first-type indications, starting a first timer, Q1 being a positive integer; as a response to the first timer being expired, detecting RLF.

In one embodiment, the first parameter is a greater one of a maximum number of SSB indexes in a first cell and a maximum number of SSB indexes in a second cell; a PCI of the second cell is the second PCI.

In one embodiment, the first parameter is a sum of a maximum number of SSB indexes in a first cell and a maximum number of SSB indexes in a second cell; a PCI of the second cell is the second PCI.

In one embodiment, the first message is used to indicate a first offset, and the first offset is a positive integer; the first offset and a maximum number of SSB indexes of a first cell are used together to determine the first parameter;
there exists at least one reference signal index in the first reference signal index set being associated with the second PCI.

In one embodiment, a value of the first parameter satisfies:

Lmax=X(min(i+d,2))
herein, Lmax is the first parameter; X (i) is a maximum number of SSB indexes in a first cell, where i is a non-negative integer less than 3; min ( ) is an operation taking the minimum value; a configurable range of a maximum number of SSB indexes in the first cell at least comprises: X (0)=4, X (1)=8, X (2)=64;
when there does not exist a reference signal index in the first reference signal index set being associated with the second PCI, d is equal to 0;
when there exists at least one reference signal index in the first reference signal index set being associated with the second PCI, d is equal to 1.

In one embodiment, the first reference signal index set comprises at least one reference signal index associated with the second PCI; the first reference signal index set comprises at least one reference signal index associated with the first PCI;
the first message is used to indicate a number of reference signal index(es) associated with the first PCI among the at most L2 reference signal index(es).

In one embodiment, the second transmitter 1602 transmits a first signaling, the first signaling comprises ServingCellConfigCommon, and a physCellId field of the ServingCellConfigCommon indicates the first PCI; the first PCI is used to identify a first cell.

In one embodiment, the first signaling is RRCReconfiguration.

In one embodiment, the second node is a satellite.

In one embodiment, the second node is a base station.

In one embodiment, the second node is a relay.

In one embodiment, the second node is an access point.

In one embodiment, the second node is a node supporting multicast.

In one embodiment, the second transmitter 1601 comprises at least one of the antenna 420, the transmitter 418, the transmitting processor 416, the multi-antenna transmitting processor 471, the controller/processor 475 or the memory 476 in Embodiment 4.

In one embodiment, the second receiver 1602 comprises at least one of the antenna 420, the receiver 418, the receiving processor 470, the multi-antenna receiving processor 472, the controller/processor 475 or the memory 476 in Embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, RFID terminals, NB-IOT terminals, Machine Type Communication (MTC) terminals, enhanced MTC (eMTC) terminals, data cards, low-cost mobile phones, low-cost tablet computers, satellite communication equipment, vessel communication equipment, NTN UEs, etc. The base station or system device in the present application includes but is not limited to macro-cellular base stations, micro-cellular base stations, home base stations, relay base station, gNB (NR node B), Transmitter Receiver Point (TRP), NTN base stations, satellite equipment, flight platform equipment and other radio communication equipment.

This application can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first message, the first message being used to indicate a first reference signal index set and a second reference signal index set; the first reference signal index set and the second reference signal index set each at least comprising one reference signal index; any reference signal index in the first reference signal index set indicating a reference signal resource; any reference signal index in the second reference signal index set indicating a reference signal resource; at least one reference signal index in the first reference signal index set being associated with a first Physical Cell Identifier (PCI), and at least one reference signal index in the first reference signal index set being associated with a second PCI; any reference signal index in the second reference signal index set being associated with the first PCI;
the first receiver, assessing first-type radio link quality according to at least partial reference signal resources indicated by the first reference signal index set; whenever the evaluated first-type radio link quality is worse than a first threshold, a physical layer of the first node reporting a first-type indication to a higher layer of the first node; as a response to the higher layer of the first node continuously receiving Q1 first-type indication(s), starting the first timer, Q1 being a positive integer; as a response to the first timer being expired, detecting Radio Link Failure (RLF);
the first receiver, assessing second-type radio link quality according to at least partial reference signal resources indicated by the second reference signal index; whenever the evaluated second-type radio link quality is worse than a second threshold, a physical layer of the first node reporting a second-type indication to a higher layer of the first node; and
as a response to all conditions in a first condition set being satisfied, executing a first operation;
wherein the first condition set comprises the higher layer of the first node continuously receiving Q2 second-type indication(s); the executing a first operation does not comprise detecting RLF; the first operation comprises generating a link observation record, or the first operation comprises transmitting a link observation record.

2. The first node according to claim 1, wherein
the first condition set comprises an expiration of the second timer, and the higher layer of the first node continuously receiving the Q2 second-type indication(s) is used to trigger starting the second timer.

3. The first node according to claim 1, comprising:
the first receiver, assessing third-type radio link quality according to at least partial reference signal resources indicated by the second reference signal index; whenever the evaluated third-type radio link quality is better than a third threshold, a physical layer of the first node reporting a third-type indication to a higher layer of the first node;
the meaning of the phrase of “continuously receiving Q2 the second-type indication(s)” is not receiving the third-type indication in the procedure of continuously receiving the Q2 second-type indication(s).

4. The first node according to claim 2, comprising:
the first receiver, assessing third-type radio link quality according to at least partial reference signal resources indicated by the second reference signal index; whenever the evaluated third-type radio link quality is better than a third threshold, a physical layer of the first node reporting a third-type indication to a higher layer of the first node;
the meaning of the phrase of “continuously receiving Q2 the second-type indication(s)” is not receiving the third-type indication in the procedure of continuously receiving the Q2 second-type indication(s).

5. The first node according to claim 1, wherein
the behavior of transmitting a link observation record comprises transmitting a second message, and the second message is used to indicate the link observation record; whether a transmission of the second message and the second condition set being satisfied occur in a same Radio Resource Control (RRC) connection procedure is related to a configuration method of the second reference signal index set.

6. The first node according to claim 2, wherein
the behavior of transmitting a link observation record comprises transmitting a second message, and the second message is used to indicate the link observation record; whether a transmission of the second message and the second condition set being satisfied occur in a same RRC connection procedure is related to a configuration method of the second reference signal index set.

7. The first node according to claim 4, wherein
the behavior of transmitting a link observation record comprises transmitting a second message, and the second message is used to indicate the link observation record; whether a transmission of the second message and the second condition set being satisfied occur in a same RRC connection procedure is related to a configuration method of the second reference signal index set.

8. The first node according to claim 1, wherein
the behavior of transmitting a link observation record comprises transmitting a second message, and the second message indicates the link observation record through indicating a first identity;
wherein the first identity is associated with the first PCI.

9. The first node according to claim 2, wherein
the behavior of transmitting a link observation record comprises transmitting a second message, and the second message indicates the link observation record through indicating a first identity;
wherein the first identity is associated with the first PCI.

10. The first node according to claim 3, wherein
the behavior of transmitting a link observation record comprises transmitting a second message, and the second message indicates the link observation record through indicating a first identity;
wherein the first identity is associated with the first PCI.

11. The first node according to claim 5, wherein
the behavior of transmitting a link observation record comprises transmitting a second message, and the second message indicates the link observation record through indicating a first identity;
wherein the first identity is associated with the first PCI.

12. The first node according to claim 1, comprising:
the first receiver detecting RLF; storing information of the RLF in the first link failure variable; and
the behavior of storing information of the RLF in the first link failure variable comprises: maintaining the link observation record stored in the first link failure variable; clearing information other than the link observation record stored in the first link failure variable; the behavior of executing a first operation comprising storing the link observation record in a first link failure variable.

13. The first node according to claim 4, comprising:
the first receiver detecting RLF; storing information of the RLF in the first link failure variable; and
the behavior of storing information of the RLF in the first link failure variable comprises: maintaining the link observation record stored in the first link failure variable; clearing information other than the link observation record stored in the first link failure variable; the behavior of executing a first operation comprising storing the link observation record in a first link failure variable.

14. The first node according to claim 5, comprising:
the first receiver detecting RLF; storing information of the RLF in the first link failure variable; and
the behavior of storing information of the RLF in the first link failure variable comprises: maintaining the link observation record stored in the first link failure variable; clearing information other than the link observation record stored in the first link failure variable; the behavior of executing a first operation comprising storing the link observation record in a first link failure variable.

15. The first node according to claim 1, wherein
the behavior of executing a first operation comprises storing the link observation record in a second link failure variable; the second link failure variable is different from a first link failure variable; the first link failure variable is used to store information about RLF;
the second link failure variable is used to generate a second message;
the behavior of transmitting a link observation record comprises transmitting the second message.

16. The first node according to claim 2, wherein
the behavior of executing a first operation comprises storing the link observation record in a second link failure variable; the second link failure variable is different from a first link failure variable; the first link failure variable is used to store information about RLF;
the second link failure variable is used to generate a second message;
the behavior of transmitting a link observation record comprises transmitting the second message.

17. The first node according to claim 4, wherein
the behavior of executing a first operation comprises storing the link observation record in a second link failure variable; the second link failure variable is different from a first link failure variable; the first link failure variable is used to store information about RLF;
the second link failure variable is used to generate a second message;
the behavior of transmitting a link observation record comprises transmitting the second message.

18. The first node according to claim 5, wherein
the behavior of executing a first operation comprises storing the link observation record in a second link failure variable; the second link failure variable is different from a first link failure variable; the first link failure variable is used to store information about RLF;
the second link failure variable is used to generate a second message;
the behavior of transmitting a link observation record comprises transmitting the second message.

19. The first node according to claim 1, comprising:
a first transmitter, transmitting a third message, the third message indicating having an available link observation record; and
the first receiver, receiving a fourth message, and the fourth message indicating requesting a link observation record;
wherein the first node stores an available link observation record based on a state variable; the fourth message is used to trigger a second message; the third message is used to indicate a completion of a first operation; the behavior of transmitting a link observation record comprises transmitting a second message, and the second message is used to indicate the link observation record.

20. A method in a first node for wireless communications, comprising:
receiving a first message, the first message being used to indicate a first reference signal index set and a second reference signal index set; the first reference signal index set and the second reference signal index set each at least comprising one reference signal index; any reference signal index in the first reference signal index set indicating a reference signal resource; any reference signal index in the second reference signal index set indicating a reference signal resource; at least one reference signal index in the first reference signal index set being associated with a first PCI, and at least one reference signal index in the first reference signal index set being associated with a second PCI; any reference signal index in the second reference signal index set being associated with the first PCI;
assessing first-type radio link quality according to at least partial reference signal resources indicated by the first reference signal index set; whenever the evaluated first-type radio link quality is worse than a first threshold, a physical layer of the first node reporting a first-type indication to a higher layer of the first node; as a response to the higher layer of the first node continuously receiving Q1 first-type indication(s), starting the first timer, Q1 being a positive integer; as a response to the first timer being expired, detecting RLF;
assessing second-type radio link quality according to at least partial reference signal resources indicated by the second reference signal index; whenever the evaluated second-type radio link quality is worse than a second threshold, a physical layer of the first node reporting a second-type indication to a higher layer of the first node; and
as a response to all conditions in a first condition set being satisfied, executing a first operation;
wherein the first condition set comprises the higher layer of the first node continuously receiving Q2 second-type indication(s); the executing a first operation does not comprise detecting RLF; the first operation comprises generating a link observation record, or the first operation comprises transmitting a link observation record.
